(19) United States
(12) Patent Application Publication
(10) Pub. No.: US 2024/0257049 A1
(43) Pub. Date: Aug. 1, 2024

(54) METHODS AND SYSTEMS EMPLOYING LOAD CELLS IN SHELVING ARRANGEMENTS

(71) Applicant: SHEKEL SCALES (2008) LTD., Beit Keshet (IL)

(72) Inventors: Michael TRAKHIMOVICH, Gan Ner (IL); Guy MOSHE, Be'er Ganim (IL); Evyatar YADAI, Be'er Sheva (IL)

(21) Appl. No.: 18/438,527

(22) Filed: Feb. 12, 2024

Related U.S. Application Data
(63) Continuation-in-part of application No. 17/098,565, filed on Nov. 16, 2020, now Pat. No. 11,946,795.
Application No. 17/098,565 is a continuation-in-part of application No. PCT/IB2019/054082, filed on May 16, 2019.
(63) Continuation-in-part of application No. 17/113,072, filed on Dec. 6, 2020, now Pat. No. 11,971,293.
Application No. 17/113,072 is a continuation-in-part of application No. PCT/IB2019/054746, filed on Jun. 6, 2019.
(63) Continuation-in-part of application No. 17/134,713, filed on Dec. 28, 2020, now Pat. No. 11,933,661.
Application No. 17/134,713 is a continuation-in-part of application No. PCT/IB2019/055488, filed on Jun. 28, 2019.

(30) Foreign Application Priority Data
May 16, 2018 (GB) GB1807918.6
Jun. 6, 2018 (GB) GB1809332.8
Jun. 28, 2018 (GB) 1810672.4
Sep. 6, 2018 (GB) 1814504.5
Dec. 24, 2018 (WO) PCT/IB2018/060588
May 16, 2019 (WO) PCT/IB2019/054082
Jun. 6, 2019 (WO) PCT/IB2019/054746

(51) Int. Cl. G06Q 10/087; G01G 19/52; G01G 21/22; G01G 21/23

(52) U.S. Cl. CPC G06Q 10/087; G01G 19/52; G01G 21/22; G01G 21/23

(57) ABSTRACT

Non-homogeneous products on a shelf are tracked using weighing assemblies jointly operable to measure the weight of the shelf and of the products. Weight measurement data is monitored and transmitted as streams of weight measurement data points. Responsively to a change in the values of the data, a set of weight-event parameters is determined including a product identification and an action taken with respect to the product. The determining includes aggregating, across all of the streams, changes in the weight measurement data corresponding to a specific time, mapping a change in weight distribution on the shelf, using the aggregated changes in weight measurement data, and assigning a set of weight-event parameters for resolving the mapped change in weight distribution. The product identification is based at least in part on per-product weight data retrieved from a product database.

### CROSS-REFERENCE TO RELATED APPLICATIONS

This application is a continuation-in-part of U.S. patent application Ser. No. 17/098,565, filed on Nov. 16, 2020, and published as US Patent Application Publication No. 2021/0131857; of U.S. patent application Ser. No. 17/113,072, filed on Dec. 6, 2020, and published as US Patent Application No. 2021/0148750; and of U.S. patent application Ser. No. 17/134,713, filed on Dec. 28, 2020, and published as US Patent Application No. 2021/0148751.

This application claims priority from the following patent applications: Great Britain Patent Application No. 1807918.6, filed on May 16, 2018; Great Britain Patent Application No. 1809332.8, filed on Jun. 6, 2018; Great Britain Patent Application No. 1810672.4, filed on Jun. 28, 2018; Great Britain Patent Application No. 1814504.5, filed on Sep. 6, 2018; and International Application No. PCT/IB2018/060588, filed on Dec. 24, 2018, International Application No. PCT/IB2019/054082, filed on May 16, 2019, and International Application No. PCT/IB2019/054746, filed on Jun. 6, 2019, all of which applications are incorporated by reference for all purposes as if fully set forth herein.

### FIELD OF THE INVENTION

The present invention relates to weighing devices and assemblies, including weighing devices and assemblies for shelves on which non-homogeneous assortments of products can be arranged, and methods for their use in tracking the weights, locations and identifications of products added to and removed from shelves.

### BACKGROUND

Load cells are employed extensively in weighing scales because of their accuracy in measuring weights, and they are often deployed in industrial and commercial applications to perform reliable weight measurements.

Unattended or autonomous retail and inventory management are areas that can benefit from the use of load cells. Technical solutions have been suggested for intelligent shelving that would track the weight of products on a shelf, including changes in the weight resulting from the addition of products or the removal of products. Examples of shelving arrangements include connected shelving bays and standalone shelving arrangements. Connected shelving bays use a familiar type of shelving unit common in supermarkets and other retail stores. Standalone shelving arrangements are usually not connected to other shelving units and are often used in smaller retail environments such as, for example, kiosks, convenience stores, public areas of shopping malls, or shops in public venues such as train stations or airports. Either type of shelving arrangement can be suitable for practicing the embodiments disclosed herein.

An example of such a suggested solution is a shelf segment assembly with load cells attached to the underside so that when the shelf segment is placed atop an existing ‘regular’ shelf, weights of the products on the shelf can be tracked. Such solutions are lacking in terms of immobilizing and stabilizing the intelligent shelves, integrating with existing shelving systems such as, for example, so-called ‘gondola’ shelving units, and providing solutions for large-scale arrangements of shelving units such as those in large supermarkets or department stores. Such solutions are lacking in terms of being able to disambiguate unique products in diverse collections of products, instead dedicating each small shelf or shelf insert to a single product or stock-keeping unit (SKU). Additionally, such solutions could benefit from the introduction of very accurate and small-size load cell assemblies.

Planar load cells suitable for use in or in conjunction with the present invention have been described in co-pending application Great Britain Patent Application No. 1814504.5. Other suitable planar load cell designs have been disclosed, including in U.S. Pat. Nos. 5,510,581, 6,230,571 and 7,679,009, the teachings of all of which are incorporated herewith by reference in their entireties.

### SUMMARY

Embodiments relate to weighing assemblies that include shelf brackets, to weighing-enabled shelving arrangements, and methods for their assembly and use.

In embodiments, a weighing assembly includes first and second planar load cell assemblies, the first planar load cell assembly comprising at least a first load cell arrangement disposed on a first metal load cell body, the second planar load cell assembly comprising at least a second load cell arrangement disposed on a second metal load cell body; each of the first and second metal load cell bodies having a primary axis, a central longitudinal axis, and a transverse axis disposed transversely with respect to the primary and central longitudinal axes, a broad dimension of the first and second load cell bodies being disposed perpendicular to the primary axis, each of the first and second load cell arrangements including: a first contiguous cutout window passing through the broad dimension and formed by a first pair of cutout lines disposed generally parallel to the central longitudinal axis, and connected by a first cutout base; a second contiguous cutout window passing through the broad dimension and formed by a second pair of cutout lines disposed generally parallel to the central longitudinal axis, and connected by a second cutout base, wherein the second contiguous cutout window is transversely bounded by the first contiguous cutout window; a pair of measuring beams disposed along opposite edges of the load cell body and generally parallel to the central longitudinal axis, each of the measuring beams longitudinally defined by a respective cutout line of the first pair of cutout lines; a first flexure arrangement having a first pair of flexure beams, disposed along opposite sides of the central longitudinal axis, and generally parallel thereto, the first pair of flexure beams longitudinally disposed between the first pair of cutout lines and the second pair of cutout lines, and mechanically connected by a first flexure base; a loading element, longitudinally defined by an innermost pair of cutout lines, comprising a receiving element and extending from an innermost flexure base, the transverse axis passing through the loading element; and at least one strain gage, fixedly attached to a surface of a measuring beam of the measuring beams; and first and second shelf brackets, the first shelf bracket attached to the first metal load cell body at an anchored end thereof, and the second shelf bracket attached to the second metal load cell body at an anchored end thereof.

In some embodiments, the weighing assembly can additionally comprise a shelf frame joining the first and second shelf brackets so as to form, in combination therewith, a rigid shelf frame.

In some embodiments, the weighing assembly can additionally comprise (vii) a third contiguous cutout window passing through the broad dimension and formed by a third pair of cutout lines disposed parallel to the central longitudinal axis, and connected by a third cutout base; and (viii) a second flexure arrangement having a second pair of flexure beams, disposed along opposite sides of the central longitudinal axis, and parallel thereto, the second pair of flexure beams longitudinally disposed between the second pair of cutout lines and the third pair of cutout lines, and mechanically connected by a second flexure base, wherein the loading element is longitudinally defined by the third pair of cutout lines, and extending from the second flexure base.

In some embodiments, the weighing assembly can additionally comprise a plurality of protruding elements, wherein, in an assembled configuration, each one of the plurality of protruding elements is vertically aligned with a corresponding receiving element.

In some embodiments, the weighing assembly can additionally comprise a shelf installed upon an upward-facing surface of the rigid shelf frame.

In some embodiments, the weighing assembly can further comprise an upright having a securing arrangement for securing one of the first and second shelf brackets thereto. In some such embodiments, it can be that (i) each one of the first and second shelf brackets includes at least one bracket hook and (ii) wherein the securing arrangement of each one of the pair of uprights is adapted to receive the at least one bracket hook.

In some embodiments, at least one of the first and second load cell assemblies comprises a double ended load cell.

In some embodiments, the at least one strain-sensing gage being associated with a processing unit configured to receive strain signals therefrom, and to produce a weight indication based on the strain signals.

In some embodiments, the weighing assembly can additionally comprise a communications arrangement for sending information about the weight indication to a computing device. In some such embodiments, the weighing assembly can additionally comprise the computing device, and the computing device can include a software module for determining, based on the information, that a product has been added to or removed from a shelf. In some such embodiments, the product can be a member of a group of products characterized by a plurality of SKU-identifiers, and the determining by the software module additionally can include determining the SKU-identifier of the product that has been added or removed from the shelf. In some such embodiments, the result of the determining by the software module is further used to perform at least one of a retail sales transaction and an inventory adjustment in a computerized inventory system. In some embodiments, the product is a member of a group of non-homogeneous products, and the determining by the software module can additionally include identifying the product that has been added or removed from the shelf. In some such embodiments, the group of non-homogeneous products can be characterized by a plurality of SKU-identifiers, and/or the identifying can include identifying a SKU-identifier.

In embodiments, a shelving arrangement, which has at least one load cell assembly, comprises: (a) a shelving unit including (i) a back panel and (ii) at least one upright associated with the back panel; (b) a weighing assembly comprising first and second planar load cell assemblies, each planar load cell assembly including: (i) a load cell body having a free end and an anchored portion, the load body including a spring element and at least one receiving element adapted, in an operative mode, to receive a vertical load, the receiving element having an unloaded disposition and a loaded disposition in which the free end is depressed with respect to the free end in the unloaded disposition, and (ii) at least one strain-sensing gage, bonded to the spring element, the strain-sensing gage adapted to measure a strain in the spring element, in the loaded disposition; and the shelving arrangement additionally comprises (c) first and second load cell bases each including a respective shelf bracket, where a respective one of the first and second load cell bases is attached to each the load cell body at an anchored end thereof, each shelf bracket including at least one attachment member, the upright having a securing arrangement for securing each shelf bracket thereto using the at least one attachment member. In some embodiments, the shelving arrangement can additionally comprise a communications arrangement for sending information about the weight indication to a computing device.

A method is disclosed herein for tracking inventory of products displayed on shelving comprising weighing assemblies; the method comprises: (a) storing products characterized by a plurality of SKU-identifiers on a shelf comprising a weighing assembly, the weighing assembly comprising first and second shelf brackets and first and second load cell assemblies, each including (i) a planar load cell body having a free end and an anchored portion, the load cell body including a spring element and at least one receiving element, (ii) a strain-sensing gage, bonded to the spring element, the strain-sensing gage adapted to measure a strain in the spring element, in the loaded disposition, and (iii) a load cell base including a respective one of the first and second shelf brackets; (b) tracking the weight of the products on the shelf, using the first and second load cell assemblies; (c) in response to a change in weight of the products on the shelf, sending information about the weight of the products from the load cell assembly to a computing device; and (d) in response to receiving the information about the weight of the products: (i) determining, by the computing device, that a product has been added to or removed from the shelf, and (ii) in response to the determining that a product has been added to or removed from the shelf, further determining an SKU-identifier of the product added or removed.

In some embodiments, the method can additionally comprise the step of recording a change in an inventory management system.

In some embodiments, the method can additionally comprise the step of completing a retail sales transaction, using the result of the determining and of the further determining.

In embodiments, a weighing assembly that includes a shelf bracket comprises a receiving bracket adapted to receive a shelf; a load cell assembly including (i) a load cell body having a free end and an anchored portion, the load cell body including a spring element and at least one receiving element, and (ii) a strain-sensing gage, bonded to the spring element, the strain-sensing gage adapted to measure a strain in the spring element; in the loaded disposition; and a load cell base including the shelf bracket. In an assembled configuration, the load cell base is attached to the load cell body at the anchored portion thereof, and in the assembled configuration, the at least one receiving element is adapted to receive a vertical load from the receiving bracket, the receiving element has an unloaded disposition and a loaded disposition in which the at least one receiving element receives the vertical load, wherein in the loaded position, the free end attains a depressed position with respect to the free end in the unloaded disposition.

In some embodiments, the weighing assembly can additionally comprise at least one protruding element, wherein, in the assembled configuration, the at least one protruding element is disposed on the receiving bracket and is vertically aligned with the at least one receiving element.

In some embodiments, the weighing assembly can additionally comprise at least one protruding element, wherein, in the assembled configuration, the at least one protruding element is disposed on the receiving element and is vertically aligned with the at least one protruding-element receptacle in the receiving bracket.

In some embodiments, the weighing assembly can additionally comprise the shelf, wherein, in the assembled configuration, the shelf is disposed atop the receiving bracket such that the receiving bracket bears an entire weight of the shelf, and in some embodiments of the weighing assembly the receiving bracket can include an elongated horizontal member and a plurality of vertical members, at least some of the plurality of vertical members being disposed so as to limit or inhibit a movement of the shelf. In such embodiments, the shelf bracket has a proximal end and a distal end, the distal end being adapted for attachment in a shelving unit, the shelf has a front longitudinal edge and a rear longitudinal edge, the direction of front to rear being the same as the direction from the proximal end to the distal end, and the shelf can be disposed so that the rear longitudinal edge of the shelf is over a portion of the shelf bracket that is between a load cell body and the distal end of the shelf bracket. In such embodiments, the shelf bracket has a proximal end and a distal end, the distal end being adapted for attachment in a shelving unit, the shelf has a front longitudinal edge and a rear longitudinal edge, the direction of front to rear being the same as the direction from the proximal end to the distal end, and the shelf can be disposed so that the proximal end of the shelf bracket is under a portion of the shelf that is between the front and rear longitudinal edges of the shelf.

In some embodiments, the weighing assembly can further comprise an upright having a securing arrangement for securing the shelf bracket thereto; in some embodiments, the weighing assembly of the embodiments, wherein the shelf bracket includes at least one bracket hook or fastener. In such embodiments, the securing arrangement of the upright can be adapted to receive the at least one bracket hook or fastener.

In some embodiments, the weighing assembly can further comprise a back panel of a shelving unit, wherein the shelf bracket further includes a stabilization member secured to, or against, the back panel. The weighing assembly can additionally comprise a connecting element passing through the back panel so as to join the stabilization member to a bracket-stabilization element disposed on an opposite side of the back panel. The bracket-stabilization element disposed on the opposite side of the back panel can comprise a corresponding receptacle for receiving the connecting element passing through the back panel. The bracket-stabilization element disposed on the opposite side of the back panel can be a respective stabilization member of another shelf bracket.

In some embodiments, the weighing assembly can comprise a or the shelf, an or the upright, and a or the back panel, so as to form a portion of a or the shelving unit, such that a volume of space above the shelf is unenclosed by walls on at least two sides. The volume of space above the shelf can be unenclosed by walls on three sides.

In some embodiments, the shelving unit can include a second weighing assembly, and can either include a second upright or be concatenated with at least a second shelving unit that includes a second upright. The weighing assembly can be adapted to support a first end of the shelf and be secured to the upright, the second weighing assembly being adapted to support the second end of the shelf and be secured to the second upright.

In some embodiments, the load cell assembly can comprise a planar load cell. In some embodiments, the load cell assembly can comprise a double ended load cell. In some embodiments, the load cell assembly comprises a load cell having a flexural member. The flexural member can be an integral portion of the load cell body.

In some embodiments, the strain-sensing gage can be associated with a processing unit configured to receive strain signals therefrom, and to produce a weight indication based on the strain signals. The weighing assembly can additionally comprise a communications arrangement for sending information about the weight indication to a computing device. The weighing assembly can additionally comprise the computing device, and the computing device can include a software module for determining, based on the information, that a product has been added to or removed from a shelf. The product can be a member of a group of products characterized by a plurality of SKU-identifiers, and the determining by the software module can additionally include determining the SKU-identifier of the product that has been added or removed from the shelf. The result of the determining by the software module can be further used to perform at least one of a retail sales transaction and an inventory adjustment in a computerized inventory system.

In embodiments, a weighing assembly that includes a shelf bracket comprises (a) a planar load cell assembly comprising at least one load cell arrangement disposed on a metal load cell body, the load cell body having a primary axis, a central longitudinal axis, and a transverse axis disposed transversely with respect to the primary and central longitudinal axes, a broad dimension of the load cell body being disposed along the primary axis, the load cell body having rectangular faces, each the load cell arrangement including (i) a first contiguous cutout window passing through the broad dimension and formed by a first pair of cutout lines disposed parallel to the central longitudinal axis, and connected by a first cutout base; (ii) a second contiguous cutout window passing through the broad dimension and formed by a second pair of cutout lines disposed parallel to the central longitudinal axis, and connected by a second cutout base; and (iii) a third contiguous cutout window passing through the broad dimension and formed by a third pair of cutout lines disposed parallel to the central longitudinal axis, and connected by a third cutout base, wherein the second contiguous cutout window is transversely bounded by the first contiguous cutout window, and the third contiguous cutout window is transversely bounded by the second contiguous cutout window, and wherein the second cutout base is disposed diametrically opposite both the first cutout base and the third cutout base. Each load cell arrangement additionally includes (iv) a pair of measuring beams, disposed along opposite edges of the load cell body, and parallel to the central longitudinal axis, each of the measuring beams longitudinally defined by a respective cutout line of the first pair of cutout lines; (v) a first flexure arrangement having a first pair of flexure beams, disposed along opposite sides of the central longitudinal axis, and parallel thereto, the first pair of flexure beams longitudinally disposed between the first pair of cutout lines and the second pair of cutout lines, and mechanically connected by a first flexure base; (vi) a second flexure arrangement having a second pair of flexure beams, disposed along opposite sides of the central longitudinal axis, and parallel thereto, the second pair of flexure beams longitudinally disposed between the second pair of cutout lines and the third pair of cutout lines, and mechanically connected by a second flexure base; (vii) a loading element, longitudinally defined by the third pair of cutout lines, and extending from the second flexure base, the transverse axis passing through the loading element; and (viii) at least one strain gage, fixedly attached to a surface of a measuring beam of the measuring beams. The weighing assembly that includes a shelf bracket additionally comprises a load cell base including the shelf bracket, the load cell base attached to the load cell body at an anchored end thereof.

In some embodiments, the weighing assembly can additionally comprise a receiving bracket adapted to receive a shelf. The weighing assembly can additionally comprise at least one protruding element, wherein, in an assembled configuration, the at least one protruding element is disposed on the receiving bracket and vertically aligned with the at least one receiving element. In some embodiments, the weighing assembly can additionally comprise at least one protruding element, wherein, in an assembled configuration, the at least one protruding element is disposed on the receiving element and vertically aligned with the at least one protruding-element receptacle in the receiving bracket. In some embodiments, the weighing assembly can additionally comprise a shelf, wherein, in the assembled configuration, the shelf is disposed atop the receiving bracket such that the receiving bracket bears an entire weight of the shelf. The receiving bracket can include an elongated horizontal member and a plurality of vertical members, at least some of the plurality of vertical members being disposed so as to limit or inhibit a movement of the shelf. In some embodiments, the shelf bracket has a proximal end and a distal end, the distal end being adapted for attachment in a shelving unit, the shelf has a front longitudinal edge and a rear longitudinal edge, the direction of front to rear being the same as the direction from the proximal end to the distal end, and the shelf can be disposed so that the proximal end of the shelf bracket is under a portion of the shelf that is between the front and rear longitudinal edges of the shelf.

In some embodiments, the weighing assembly can further comprise an upright having a securing arrangement for securing the shelf bracket thereto. The shelf bracket can include at least one bracket hook and the securing arrangement of the upright is adapted to receive the at least one bracket hook.

In some embodiments, the weighing assembly can further comprise a back panel of a shelving unit, wherein the shelf bracket further includes a stabilization member secured to, or against, the back panel, and a connecting element passing through the back panel so as to join the stabilization member to a bracket-stabilization element disposed on an opposite side of the back panel. In some embodiments, the volume of space above the shelf can be unenclosed by walls on three sides.

In some embodiments, the shelving unit can include a second weighing assembly, and can either include a second upright or be concatenated with at least a second shelving unit that includes a second upright. The weighing assembly can be adapted to support a first end of the shelf and be secured to the upright, with the second weighing assembly being adapted to support the second end of the shelf and be secured to the second upright.

In some embodiments, the load cell assembly can comprise a double ended load cell.

In some embodiments, the strain-sensing gage can be associated with a processing unit configured to receive strain signals therefrom, and to produce a weight indication based on the strain signals. The weighing assembly can additionally comprise a communications arrangement for sending information about the weight indication to a computing device.

In embodiments, a shelving arrangement having at least one load cell assembly comprises (a) a shelving unit including a back panel and at least one upright associated with the back panel; and (b) at least one load cell assembly, each load cell assembly including (i) a load cell body having a free end and an anchored portion, the load body including a spring element and at least one receiving element adapted, in an operative mode, to receive a vertical load, the receiving element having an unloaded disposition and a loaded disposition in which the free end is depressed with respect to the free end in the unloaded disposition, and (ii) at least one strain-sensing gage, bonded to the spring element, the strain-sensing gage adapted to measure a strain in the spring element, in the loaded disposition. The shelving arrangement having at least one load cell assembly also comprises a load cell base including a shelf bracket, the load cell base attached to the load cell body at an anchored end thereof, the shelf bracket including at least one attachment member. The upright has a securing arrangement for securing the shelf bracket thereto the at least one attachment member, and the shelf bracket includes a stabilization member secured to, or against, the back panel of a shelving unit by being joined, using a connecting element passing through the back panel, to a bracket-stabilization element disposed on a second side of the back panel.

In some embodiments, the shelving arrangement can additionally comprise a receiving bracket adapted to receive a shelf. The shelving arrangement can additionally comprise at least one protruding element protruding element disposed on the receiving bracket and vertically aligned with the at least one receiving element. The shelving arrangement can additionally comprise at least one protruding element disposed on the receiving element and vertically aligned with the at least one protruding-element receptacle in the receiving bracket. The shelving arrangement can additionally comprise a shelf, wherein, in an assembled configuration, the shelf is disposed atop the receiving bracket such that the receiving bracket bears an entire weight of the shelf. The receiving bracket can include an elongated horizontal member and a plurality of vertical members, at least some of the plurality of vertical members being disposed so as to limit or inhibit a movement of the shelf.

In some embodiments, the load cell assembly can comprise a double ended load cell.

In some embodiments, the strain-sensing gage can be associated with a processing unit configured to receive strain signals therefrom, and to produce a weight indication based on the strain signals. The shelving arrangement can additionally comprise a communications arrangement for sending information about the weight indication to a computing device.

In embodiments, a weighing assembly including a shelf bracket comprises a receiving bracket adapted to receive a shelf, and a load cell assembly including (i) a load cell body having a free end and an anchored portion, the load body including a spring element and at least one receiving element adapted to receive a vertical load from the receiving bracket, the receiving element having an unloaded disposition and a loaded disposition in which the free end is depressed with respect to the free end in the unloaded disposition; and (ii) a strain-sensing gage, bonded to the spring element, the strain-sensing gage adapted to measure a strain in the spring element, in the loaded disposition. The weighing assembly including a shelf bracket also comprises a load cell base including the shelf bracket, the load cell base attached to the load cell body at the anchored portion thereof.

In embodiments, a method is disclosed for of tracking inventory of products displayed on shelving comprising weighing assemblies, the method comprising (a) storing products characterized by a plurality of SKU-identifiers on a shelf comprising a weighing assembly, the weighing assembly comprising a load cell assembly including (i) a planar load cell body having a free end and an anchored portion, the load cell body including a spring element and at least one receiving element, (ii) a strain-sensing gage, bonded to the spring element, the strain-sensing gage adapted to measure a strain in the spring element, in the loaded disposition, and (iii) a load cell base including the shelf bracket; (b) tracking the weight of the products on the shelf, using the load cell assembly; (c) in response to a change in weight of the products on the shelf, sending information about the weight of the products from the load cell assembly to a computing device; and (d) in response to receiving the information about the weight of the products, (i) determining, by the computing device, that a product has been added to or removed from the shelf, and (ii) in response to the determining that a product has been added to or removed from the shelf, further determining an SKU-identifier of the product added or removed.

In some embodiments, the method can additionally comprise the step of recording a change in an inventory management system. In some embodiments, the method can additionally comprise the step of completing a retail sales transaction, using the result of the determining and of the further determining. In some embodiments, the first and second load cell assemblies include, or consist of, planar load cell assemblies as described herein.

A method is disclosed, according to embodiments, for tracking inventory of products displayed on a shelf. The method comprises: (a) tracking weight of products stored on the shelf, the products characterized by a plurality of SKU-identifiers, the shelf comprising a plurality of weighing assemblies, each weighing assembly comprising (i) a respective shelf bracket, and (ii) a respective load cell assembly fixedly attached to a horizontal member of the respective shelf bracket so as to mediate between the horizontal member and the shelf, the respective load cell assembly comprising: (A) a load cell body having a free end and an anchored portion, the load cell body including a spring element and at least one receiving element, and (B) a strain-sensing gage, bonded to the spring element, the strain-sensing gage adapted to measure a strain in the spring element, wherein the load cell base is attached to the load cell body at the anchored portion thereof; (b) in response to a change in weight of the products on the shelf, sending information about the weight of the products from at least one weighing assembly of the plurality of weighing assemblies to a computing device; and (c) in response to receiving the information about the weight of the products: (i) determining, by the computing device, that a product has been added to or removed from the shelf, and (ii) in response to the determining that a product has been added to or removed from the shelf, further determining an SKU-identifier of the product added or removed.

In some embodiments, the method can additionally comprise the step of recording a change in an inventory management system.

In some embodiments, the method can additionally comprise the step of completing a retail sales transaction, using the result of the determining and of the further determining.

A method is disclosed herein for tracking non-homogeneous products on a shelf by using a plurality of weighing assemblies that are jointly operable to measure the combined weight of the shelf and of the products arranged thereupon, wherein the method comprises: (a) monitoring weight measurement data corresponding to the weight of the shelf and the products arranged thereupon, the weight measurement data measured by the plurality of weighing assemblies and transmitted therefrom as respective streams of weight measurement data points; (b) responsively to a change over time in the values of the weight measurement data, determining a set of weight-event parameters of a weight event, the set of weight-event parameters comprising a product identification and an action taken with respect to the product, the determining comprising: (i) aggregating, across all of the streams, changes in the weight measurement data corresponding to a specific time, (ii) mapping a change in weight distribution on the shelf, using the aggregated changes in weight measurement data, and (iii) assigning a set of weight-event parameters for resolving the mapped change in weight distribution, using product-weight data retrieved from a product database; and (c) performing at least one of: (i) recording information about the results of the selecting in a non-transient, computer-readable medium, and (ii) displaying information about the results of the selecting on a display device.

In some embodiments, each of the weighing assemblies comprises: (a) at least one load cell arrangement disposed on a single metal load cell body, the load cell body having a primary axis, a central longitudinal axis, and a transverse axis disposed transversely with respect to the primary and central longitudinal axes, a broad dimension of the load cell body being disposed perpendicular to the primary axis, each the load cell arrangement including: (i) a first contiguous cutout window passing through the broad dimension and formed by a first pair of cutout lines disposed generally parallel to the central longitudinal axis, and connected by a first cutout base; (ii) a second contiguous cutout window passing through the broad dimension and formed by a second pair of cutout lines disposed generally parallel to the central longitudinal axis, and connected by a second cutout base, wherein the second contiguous cutout window is transversely bounded by the first contiguous cutout window; (iii) a pair of measuring beams disposed along opposite edges of the load cell body and generally parallel to the central longitudinal axis, each of the measuring beams longitudinally defined by a respective cutout line of the first pair of cutout lines; (iv) a first flexure arrangement having a first pair of flexure beams, disposed along opposite sides of the central longitudinal axis, and generally parallel thereto, the first pair of flexure beams longitudinally disposed between the first pair of cutout lines and the second pair of cutout lines, and mechanically connected by a first flexure base; (v) a loading element, longitudinally defined by an innermost pair of cutout lines, comprising a receiving element and extending from an innermost flexure base, the transverse axis passing through the loading element; and (vi) at least one strain gage, fixedly attached to a surface of a measuring beam of the measuring beams.

In some embodiments, the assigning comprises: (i) identifying at least one candidate set of weight-event parameters for resolving the mapped change in weight distribution, using product-weight data retrieved from a product database, (ii) assigning an event likeliness score to each candidate set of weight-event parameters, and (iii) selecting the set of candidate weight-event parameters having the highest event likeliness score.

In some embodiments, the determining can use product positioning data from a product positioning plan in at least the identifying.

In some embodiments, the determining can include calculating a probability in at least the assigning. In some such embodiments, the probability can be calculated using a probability distribution function. In some such embodiments, a parameter of the probability distribution function can be derived using a machine learning algorithm applied to historical weight data for a product.

In some embodiments, the assigned set of weight-event parameters includes exactly one product and one action.

In some embodiments, the assigned set of weight-event parameters can include at least one of (i) two or more products and (ii) two or more actions.

In some embodiments, the action taken with respect to the product is selected from the group consisting of removing the product from the shelf, adding the product to the shelf, and moving the product from one position on the shelf to another.

According to embodiments of the present invention, a weighing assembly for weighing a shelf comprises: (a) a shelf bracket comprising a horizontal member configured to support the shelf in an x-z plane that is parallel to a floor, and a first vertical member in a y-z plane orthogonal to the x-z plane, and (b) a load cell assembly fixedly attached to the horizontal member so as to mediate between the horizontal member and the shelf, the load cell assembly comprising: (i) a load cell body having a free end and an anchored portion, the load cell body including a spring element and at least one receiving element, and (ii) a strain-sensing gage, bonded to the spring element, the strain-sensing gage adapted to measure a strain in the spring element, wherein, in an assembled configuration, (i) the load cell body is attached to the horizontal member at the anchored portion of the load cell body, and (ii) the at least one receiving element is adapted to receive a vertical load from the shelf, the receiving element has (A) an unloaded disposition, and (B) a loaded disposition in which the at least one receiving element receives the vertical load, wherein in the loaded disposition, the free end attains a depressed position with respect to the free end in the unloaded disposition.

In some embodiments, (i) the load cell body can have a primary axis, a central longitudinal axis, and a transverse axis disposed transversely with respect to the primary and central longitudinal axes, a broad dimension of the load cell body being disposed perpendicular to the primary axis, and/or (ii) the load cell body includes: (A) a first contiguous cutout window passing through the broad dimension and formed by a first pair of cutout lines disposed generally parallel to the central longitudinal axis, and connected by a first cutout base, (B) a second contiguous cutout window passing through the broad dimension and formed by a second pair of cutout lines disposed generally parallel to the central longitudinal axis, and connected by a second cutout base, the second contiguous cutout window being transversely bounded by the first contiguous cutout window, (C) a pair of measuring beams disposed along opposite edges of the load cell body and generally parallel to the central longitudinal axis, each of the measuring beams longitudinally defined by a respective cutout line of the first pair of cutout lines, (D) a first flexure arrangement having a first pair of flexure beams, disposed along opposite sides of the central longitudinal axis, and generally parallel thereto, the first pair of flexure beams longitudinally disposed between the first pair of cutout lines and the second pair of cutout lines, and mechanically connected by a first flexure base, and/or (E) a loading element, longitudinally defined by an innermost pair of cutout lines, comprising a receiving element and extending from an innermost flexure base, the transverse axis passing through the loading element.

In embodiments, the primary axis, central longitudinal axis, and transverse axis, as well as the broad dimension of the load cell body, can be on, or parallel to, the x-z axis. In some embodiments, the load cell body can additionally include: (F) a third contiguous cutout window passing through the broad dimension and formed by a third pair of cutout lines disposed parallel to the central longitudinal axis, and connected by a third cutout base, and/or (G) a second flexure arrangement having a second pair of flexure beams, disposed along opposite sides of the central longitudinal axis, and parallel thereto, the second pair of flexure beams longitudinally disposed between the second pair of cutout lines and the third pair of cutout lines, and mechanically connected by a second flexure base, wherein the loading element is longitudinally defined by the third pair of cutout lines, and extending from the second flexure base.

In some embodiments, the load cell assembly can comprise a double ended load cell.

In some embodiments, the at least one strain-sensing gage can be associated with a processing unit configured to receive strain signals therefrom, and to produce a weight indication based on the strain signals.

According to embodiments, a shelving arrangement can comprise (a) a back panel; (b) first and second uprights associated with the back panel; (c) first and second weighing assemblies according to any of the embodiments disclosed hereinabove, adapted for being removably mounted to respective first and second uprights, wherein (i) each of the weighing assemblies comprises a respective second vertical member in an x-y plane that is parallel to the back panel and orthogonal to both the x-z plane and the y-z plane, and (ii) the first and second weighing assemblies are mirror images of each other relative to respective first vertical members; and/or a shelf disposed to be in at least indirect contact with both respective load cell assemblies of the first and second weighing assemblies.

In some embodiments, the shelving arrangement can additionally comprise first and second connecting elements passing through the back panel so as to join respective vertical members to corresponding bracket-stabilization elements disposed on a reverse side of the back panel. In some such embodiments, the bracket-stabilization element can be disposed on the opposite side of the back panel is a respective stabilization member of another shelf bracket.

In some embodiments, the shelving arrangement can comprise a communications arrangement for sending information about the weight indication to a computing device. In some such embodiments, the shelving arrangement can additionally comprise the computing device, wherein the computing device includes a software module for determining, based on the information, that a product has been added to or removed from a shelf. In some such embodiments, the product cam be a member of a group of products characterized by a plurality of SKU-identifiers, and the determining by the software module additionally includes determining the SKU-identifier of the product that has been added or removed from the shelf. In some such embodiments, the result of the determining by the software module can be further used to perform at least one of a retail sales transaction and an inventory adjustment in a computerized inventory system.

According to embodiments, a weighing-assembly unit can comprise: (a) first and second weighing assemblies according to any of the embodiments disclosed hereinabove; and/or (b) a shelf frame or at least one beam member joining respective shelf brackets of the first and second weighing assemblies so as to form, in combination therewith, a rigid shelf frame.

In some embodiments, the weighing-assembly unit can additionally comprise a shelf installed upon an upward-facing surface of the rigid shelf frame, the shelf disposed to be in at least indirect contact with the respective load cell assemblies of the first and second weighing assemblies.

According to embodiments, a shelving arrangement can comprise: (a) a back panel; (b) a first and second uprights associated with the back panel; and/or (c) the weighing-assembly unit.

A method is disclosed, according to embodiments, for tracking inventory of products on a shelf. The method comprises: (a) tracking weight of products stored on the shelf, the products characterized by a plurality of SKU-identifiers, the shelf comprising a plurality of weighing assemblies, each weighing assembly comprising (i) a respective shelf bracket, and (ii) a respective load cell assembly fixedly attached to a horizontal member of the respective shelf bracket so as to mediate between the horizontal member and the shelf, the respective load cell assembly comprising: (A) a load cell body having a free end and an anchored portion, the load cell body including a spring element and at least one receiving element, and (B) a strain-sensing gage, bonded to the spring element, the strain-sensing gage adapted to measure a strain in the spring element, wherein the load cell base is attached to the load cell body at the anchored portion thereof; (b) in response to a change in weight of the products on the shelf, sending information about the weight of the products from at least one weighing assembly of the plurality of weighing assemblies to a computing device; and (c) in response to receiving the information about the weight of the products: (i) determining, by the computing device, that a product has been added to or removed from the shelf, and (ii) in response to the determining that a product has been added to or removed from the shelf, further determining an SKU-identifier of the product added or removed.

A method is disclosed, according to embodiments, for tracking inventory of products on a shelf. The method comprises: (a) tracking weight of non-homogeneous products stored on the shelf, the shelf comprising a plurality of weighing assemblies, each weighing assembly comprising (i) a respective shelf bracket, and (ii) a respective load cell assembly fixedly attached to a horizontal member of the respective shelf bracket so as to mediate between the horizontal member and the shelf, the respective load cell assembly comprising: (A) a load cell body having a free end and an anchored portion, the load cell body including a spring element and at least one receiving element, and (B) a strain-sensing gage, bonded to the spring element, the strain-sensing gage adapted to measure a strain in the spring element, wherein the load cell base is attached to the load cell body at the anchored portion thereof; (b) in response to a change in weight of the products on the shelf, sending information about the weight of the products from at least one weighing assembly of the plurality of weighing assemblies to a computing device; and (c) in response to receiving the information about the weight of the products: (i) determining, by the computing device, that a product has been added to or removed from the shelf, and (ii) in response to the determining that a product has been added to or removed from the shelf, identifying the product added or removed.

In some embodiments, it can be that the products are characterized by a plurality of SKU-identifiers, and/or that the identifying includes determining an SKU-identifier.

In some embodiments, the method can additionally comprise the step of recording a change in an inventory management system.

In some embodiments, the method can additionally comprise the step of completing a retail sales transaction, using the result of the determining and of the further determining.

Embodiments of the present invention relate to shelving units and shelf assemblies having weighing capabilities.

According to embodiments, a shelf assembly for tracking the weight of non-homogeneous products stored thereupon in a refrigerator comprises: (a) a weighing base comprising: (i) opposing load-cell bases detachedly attachable to respective left and right internal walls of the refrigerator, (ii) a shelf frame or at least one beam member joining respective opposing load-cell bases so as to form, in combination therewith, a rigid shelf frame, the rigid shelf frame being open to a vertical airflow over at least 25% of its horizontal surface area; (b) a shelf open to a vertical airflow over at least 50% of its horizontal surface area; and (c) a plurality of load cell assemblies fixedly attached to each of respective opposing load-cell bases so as to mediate between the load-cell bases and the shelf, each load cell assembly comprising: (i) a load cell body having a free end and an anchored portion, the load cell body including a spring element and at least one receiving element, and (ii) a strain-sensing gage, bonded to the spring element, the strain-sensing gage adapted to measure a strain in the spring element, wherein, in an assembled configuration, (i) the load cell body is attached to the horizontal member at the anchored portion of the load cell body, and (ii) the at least one receiving element is adapted to receive a vertical load from the shelf, the receiving element has (A) an unloaded disposition, and (B) a loaded disposition in which the at least one receiving element receives the vertical load, wherein in the loaded disposition, the free end attains a depressed position with respect to the free end in the unloaded disposition.

In some embodiments, the load cell body can have a primary axis, a central longitudinal axis, and a transverse axis disposed transversely with respect to the primary and central longitudinal axes, a broad dimension of the load cell body being disposed perpendicular to the primary axis, and the load cell body can include: (A) a first contiguous cutout window passing through the broad dimension and formed by a first pair of cutout lines disposed generally parallel to the central longitudinal axis, and connected by a first cutout base, (B) a second contiguous cutout window passing through the broad dimension and formed by a second pair of cutout lines disposed generally parallel to the central longitudinal axis, and connected by a second cutout base, the second contiguous cutout window being transversely bounded by the first contiguous cutout window, (C) a pair of measuring beams disposed along opposite edges of the load cell body and generally parallel to the central longitudinal axis, each of the measuring beams longitudinally defined by a respective cutout line of the first pair of cutout lines, (D) a first flexure arrangement having a first pair of flexure beams, disposed along opposite sides of the central longitudinal axis, and generally parallel thereto, the first pair of flexure beams longitudinally disposed between the first pair of cutout lines and the second pair of cutout lines, and mechanically connected by a first flexure base, and (E) a loading element, longitudinally defined by an innermost pair of cutout lines, comprising a receiving element and extending from an innermost flexure base, the transverse axis passing through the loading element. In some such embodiments, the load cell body can additionally include: (F) a third contiguous cutout window passing through the broad dimension and formed by a third pair of cutout lines disposed parallel to the central longitudinal axis, and connected by a third cutout base, and (G) a second flexure arrangement having a second pair of flexure beams, disposed along opposite sides of the central longitudinal axis, and parallel thereto, the second pair of flexure beams longitudinally disposed between the second pair of cutout lines and the third pair of cutout lines, and mechanically connected by a second flexure base, wherein the loading element can longitudinally defined by the third pair of cutout lines, and extending from the second flexure base.

In some embodiments, the at least one strain-sensing gage can be associated with a processing unit configured to receive strain signals therefrom, and to produce a weight indication based on the strain signals. In some such embodiments, the shelf assembly can comprise a communications arrangement for sending information about the weight indication to a computing device, wherein the computing device includes a software module for determining, based on the information, that a product has been added to or removed from a shelf. In some such embodiments, the product can be a member of a group of non-homogeneous products, and/or the determining by the software module can additionally include identifying the product that has been added or removed from the shelf. In some such embodiments, the group of non-homogeneous products can be characterized by a plurality of SKU-identifiers, and the identifying includes identifying a SKU-identifier. In some embodiments, the computing device can includes a software module for performing, based on the result of the determining, at least one of a retail sales transaction and an inventory adjustment in a computerized inventory system.

In some embodiments, it can be that (i) the shelf comprises a wire-grid shelf, (ii) the pluralities of load-cell assemblies are arranged to form opposing pairs of load-cell assemblies, and (iii) the wire-grid shelf includes a plurality of left-to-right wires disposed such that each opposing pair of the opposing pairs of load-cell assemblies is in contact with at least one respective left-to-right wire.

In some embodiments, the shelf can comprise an upwardly extending rim member on at least one of the four sides of the shelf, the rim member being sized and/or disposed so as to prevent a product borne by the shelf to transfer any of its weight load directly to a wall or door of the shelving unit by leaning thereupon.

In some embodiments, the rigid shelf frame can be open to a vertical airflow over at least 40% of its horizontal surface area.

A display refrigerator can comprise a plurality of shelf assemblies according to the foregoing embodiments and the computing device according to the foregoing embodiments. In some embodiments, the refrigerator can additionally comprise a retail transaction apparatus.

A method is disclosed, according to embodiments, of tracking inventory of non-homogeneous products in a refrigerator. The method comprises: (a) tracking weight of non-homogeneous products stored on a shelf assembly disposed in the refrigerator, the shelf assembly comprising (i) opposing load-cell bases detachedly attached to respective left and right internal walls of the refrigerator, (ii) a shelf frame or at least one beam member joining respective the opposing load-cell bases so as to form, in combination therewith, a rigid shelf frame, the rigid shelf frame being open to a vertical airflow over at least 25% of its horizontal surface area, (iii) a shelf open to a vertical airflow over at least 50% of its horizontal surface area, and (iv) a plurality of load cell assemblies fixedly attached to each of respective the opposing load-cell bases so as to mediate between the load-cell bases and the wire-grid shelf, each load cell assembly comprising: (A) a load cell body having a free end and an anchored portion, the load cell body including a spring element and at least one receiving element, and (B) a strain-sensing gage, bonded to the spring element, the strain-sensing gage adapted to measure a strain in the spring element; (b) in response to a change in weight of the products on the shelf assembly, sending information about the weight of the products from at least one weighing assembly of the plurality of weighing assemblies to a computing device; and (c) in response to receiving the information about the weight of the products: (i) determining, by the computing device, that a product has been added to or removed from the shelf assembly, and (ii) in response to the determining that a product has been added to or removed from the shelf assembly, identifying the product added or removed.

In some embodiments, the products can be characterized by a plurality of SKU-identifiers, and the identifying can include determining an SKU-identifier.

In some embodiments, the method can additionally comprise the step of recording a change in an inventory management system.

In some embodiments, the method can additionally comprise the step of completing a retail sales transaction, using the result of the determining and of the further determining.

In some embodiments, it can be that (i) the shelf comprises a wire-grid shelf, (ii) the pluralities of load-cell assemblies are arranged to form opposing pairs of load-cell assemblies, and (iii) the wire-grid shelf includes a plurality of left-to-right wires disposed such that each opposing pair of the opposing pairs of load-cell assemblies is in contact with at least one respective left-to-right wire.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 is a perspective view of a double-sided gondola-type shelving arrangement comprising three shelving units, according to embodiments of the present invention.

FIGS. 2 and 3A are respectively assembled and exploded perspective views of a weighing assembly attached to an upright of a gondola-type shelving unit also comprising a back panel, according to embodiments of the present invention.

FIGS. 3B and 3C are respective close-up views of two elements of the weighing assembly of FIGS. 2 and 3A, according to embodiments of the present invention.

FIGS. 4A and 4B are respectively top and side schematic views of a planar load cell assembly, according to embodiments of the present invention.

FIG. 5 is a side view of a weighing assembly including a shelf bracket secured to an upright, and a detail of the attachment of a stabilization member of the shelf bracket through the back panel of a shelving unit to a stabilization element, according to embodiments of the present invention.

FIG. 6 is an elevation view of the stabilization member of the shelf bracket of FIG. 5, showing a plurality of connection elements, according to embodiments of the present invention.

FIG. 7 is a top view of the assembly of FIG. 5, according to embodiments of the present invention.

FIG. 8 is a top view of two weighing assemblies including respective shelf brackets, both secured to an upright and attached to each other through the back panel of a shelving unit, according to embodiments of the present invention.

FIG. 9 is a top view of two left-right pairs of weighing assemblies including respective shelf brackets, all secured to respective uprights and attached to corresponding weighing assemblies of the other pairs through the back panel of a shelving unit, according to embodiments of the present invention.

FIG. 10 is a top view of two weighing assemblies including respective shelf brackets as in FIG. 8, employing double-ended planar load cell assemblies, according to embodiments of the present invention.

FIGS. 11A and 11B are respectively exploded and assembled perspective views of a weighing assembly including a receiving bracket for a shelf, according to embodiments of the present invention.

FIGS. 12A, 12B and 12C are additional views of the assembled weighing assembly including a receiving bracket of FIG. 11B, respectively two elevation views (‘side’ and ‘front’), and a top view, according to embodiments of the present invention.

FIGS. 13 and 14A are respectively exploded and assembled perspective views of a weighing assembly including a shelf and a receiving bracket therefor, according to embodiments of the present invention.

FIG. 14B is an elevation view of the weighing assembly including a shelf and a receiving bracket therefor of FIG. 14A, according to embodiments of the present invention.

FIGS. 15A and 15B are respectively perspective and exploded perspective views of a weighing assembly including two shelf brackets, according to embodiments of the present invention.

FIG. 16 is a schematic drawing of the double-sided gondola-type shelving arrangement comprising three shelving units of FIG. 1, showing non-homogeneous products on a shelf and communications connection to a computing device, according to embodiments of the present invention.

FIG. 17 shows a flowchart of a method for tracking non-homogeneous products on a shelf, according to embodiments of the present invention.

FIGS. 18 and 19 are block diagrams of respective multi-unit shelving arrangements, each in communication with a computing device and at least one of a retail sales transaction system and an inventory tracking system, according to embodiments of the present invention.

FIG. 20 shows a flowchart of a method for using weighing assemblies in a shelving arrangement to perform retail transactions and/or inventory management, according to embodiments of the present invention.

FIG. 21 is a perspective view of a prior art double-sided gondola-type shelving arrangement comprising three shelving units.

FIG. 22A is a schematic perspective view of a weighing-enabled shelving unit and system, showing a detail of an attachment element, according to embodiments of the present invention.

FIG. 22B is a schematic perspective view of an attachment component, according to embodiments of the present invention.

FIG. 22C schematically illustrates the attachment component of FIG. 22B engaged with an attachment element of a shelving unit, according to embodiments of the present invention.

FIG. 22D is a schematic perspective view of a refrigerator, according to embodiments of the present invention.

FIGS. 23A and 23B are respectively top and side schematic views of a planar load cell assembly, according to embodiments of the present invention.

FIGS. 24A and 24B are respective assembled and exploded perspective views of a shelving unit, according to embodiments of the present invention.

FIG. 24C shows a detail of the weighing base of the shelf assembly of FIG. 24B, according to embodiments of the present invention.

FIG. 24D shows a shelf tray having peripheral and dividing walls, according to embodiments of the present invention.

FIG. 25A shows a top-perspective schematic view of a shelf assembly, according to embodiments of the present invention.

FIG. 25B shows a weighing base of the shelf assembly of FIG. 25A, according to embodiments of the present invention.

FIG. 25C shows a bottom-perspective schematic view of the shelf assembly of FIG. 25A, according to embodiments of the present invention.

FIG. 26A is a perspective view of a load cell installation assembly, according to embodiments of the present invention.

FIG. 26B is a perspective view of a prior art shim element;

FIG. 26C shows a protruding element and receiving element according to the prior art;

FIG. 26D is a perspective view of a load cell assembly, according to embodiments of the present invention.

FIG. 27 is a schematic perspective view of a shelf assembly, according to embodiments of the present invention.

FIG. 28 shows a flowchart of a method for tracking non-homogeneous products on a shelf, according to embodiments of the present invention;

FIGS. 29A and 29B are block diagrams of various shelving units in communication with a computing device and at least one of a retail sales transaction system and an inventory tracking system, according to embodiments of the present invention.

FIG. 30 shows a flowchart of a method for using weighing-enabled shelving units to perform retail transactions and/or inventory management, according to embodiments of the present invention.

FIG. 31A is a schematic perspective view of a shelf with a diverse plurality of products arranged thereupon, according to embodiments of the present invention.

FIG. 31B is a schematic perspective view of a shelf and products of FIG. 31A, the shelf being in contact with a shelf base comprising a plurality of weighing assemblies, according to embodiments of the present invention.

FIG. 32 is a schematic perspective view of a bracket assembly for a shelving bay, comprising a plurality of weighing assemblies, according to embodiments of the present invention.

FIGS. 33A and 33B are respectively top and side schematic views of a planar load cell assembly, according to embodiments of the present invention.

FIGS. 34A and 34B are respectively perspective and exploded perspective views of a weighing assembly including two shelf brackets, according to embodiments of the present invention.

FIGS. 35A and 35B are respective assembled and exploded perspective views of a shelving unit, according to embodiments of the present invention.

FIG. 35C shows a top-perspective schematic view of a shelf assembly, according to embodiments of the present invention.

FIG. 35D shows a weighing base of the shelf assembly of FIG. 35C, according to embodiments of the present invention.

FIG. 35E shows a bottom-perspective schematic view of the shelf assembly of FIG. 35C, according to embodiments of the present invention.

FIG. 36 shows a block diagram of a system for tracking non-homogeneous products on a shelf and tracking and mapping the weights of the products, according to embodiments of the present invention.

FIG. 37 shows a flowchart of a first method for tracking non-homogeneous products on a shelf, according to embodiments of the present invention.

FIG. 38 shows a flowchart of a second method for tracking non-homogeneous products on a shelf, according to embodiments of the present invention.

FIG. 39 shows a flowchart of method for mapping the weight distribution of a non-homogeneous plurality of products on a shelf, according to embodiments of the present invention.

FIGS. 40 and 41 are respective schematic illustrations of two different embodiments of a first mapping rule that applies a mathematical function for weight distribution, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements. Subscripted reference numbers (e.g., 10₁) or letter-modified reference numbers (e.g., 100a) are used to designate multiple separate appearances of elements in a single drawing, e.g. 10₁ is a single appearance (out of a plurality of appearances) of element 10, and 100a is a single appearance (out of a plurality of appearances) of element 100.

As used herein, the term “SKU” means stock-keeping unit. The use of SKU-identifiers is a standard means of identifying unique products across industries. Unique products can be, for example, products defined by unique combinations of physical characteristics, e.g., weight (whether nominal or average), volume, dimensions, etc. and/or non-physical characteristics, e.g., brand or packaging design. It can be that two products can be similar in physical characteristics but have different SKU-identifiers; in some embodiments they can be considered as ‘non-homogeneous’ and in other embodiments they may not. In an example, a particular brand of cookies may offer products with a number of different SKU-identifiers: a first SKU for the brand's large package of large chocolate cookies, a second SKU for the brand's small package of the same large chocolate cookies, and a third SKU for the brand's large package of small chocolate cookies, and so on. The term “non-homogeneous”, as applied herein to a group of products, means that the products in the group do not all share the same SKU-identifier, but should not be understood to imply that each product in a group has a unique SKU-identifier. For example, a group of non-homogeneous products might include: (a) 10 large packages of large chocolate cookies bearing a first brand and having a first SKU-identifier, and (b) 2 large packages of small chocolate cookies from a second brand and having a second SKU-identifier, or, without limitation any combination of products having, in combination, two or more SKU-identifiers. A group of products having, in combination, two or more SKU-identifiers can be considered ‘non-homogeneous’ with respect to one another.

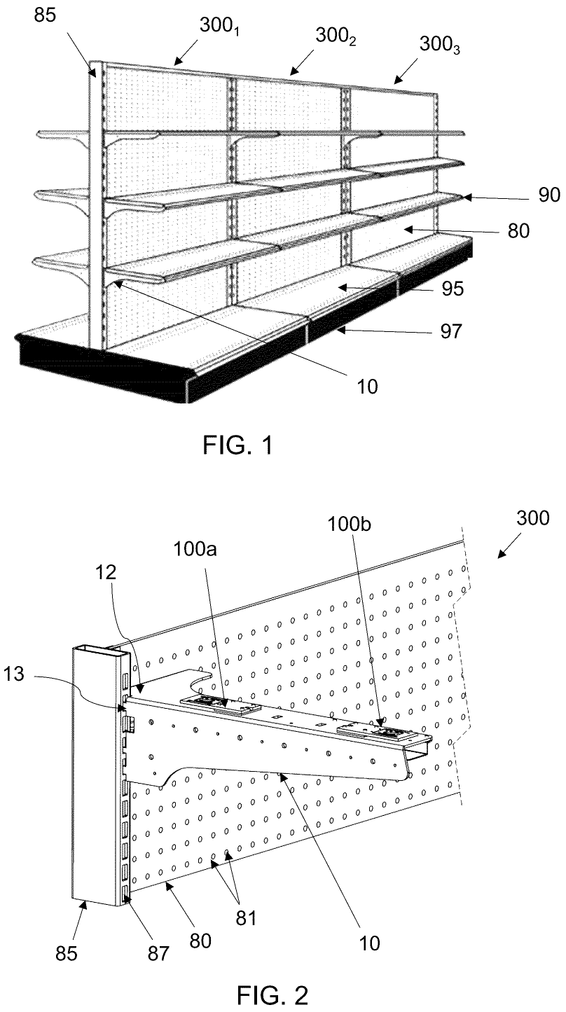

Referring now to FIG. 1, a concatenated assembly of three gondola-type shelving units 300 (300₁, 300₂, 300₃) is illustrated. This is a familiar type of shelving unit common in supermarkets and other retail stores. Each shelving unit 300 (also called a shelving bay) comprises an upright 85, usually a back panel 80, and one or more shelves 90. According to the embodiment illustrated in FIG. 1, each shelf is supported by a weighing assembly 10, which includes a shelf bracket (detail not shown in FIG. 1). The weighing assembly 10 is equipped with weight-measuring devices (not shown in FIG. 1) that allow the measuring of the weight of the shelf 90 and of any products placed thereupon once the shelving unit is deployed in a retail or inventory storage environment. A shelving unit 300 can also include a base shelf 95 mounted on a base unit 97. Although not shown in FIG. 1, a base-unit weighing assembly can also be interposed between the base unit 97 and the base shelf 95 so as to have the same weighing function as do the ‘hanging’ shelves 90 and their respective weighing assemblies 10.

FIG. 2 provides a closer view (in perspective) of a weighing assembly 10 according to various embodiments—shown in FIG. 2 without the shelf (e.g., shelf 90) which it supports. The weighing assembly 10 is attached to an upright 85 of a gondola-type shelving unit 300 (only portions of one upright 85 and the back panel 80 are shown in FIG. 2). The weighing assembly 10 includes a shelf bracket 12 and two load cell assemblies 100a, 100b. In other embodiments, not shown here, a weighing assembly can include more load cell assemblies or fewer, i.e., one. The attachment of the weighing assembly, i.e., of the shelf bracket 120 portion of weighing assembly 10, is by industry-standard bracket hooks 13 engaging in bracket holes 87 of the upright 85. There are various known industry-standard types of uprights and respective matching shelf bracket attachments and the specific choice of bracket hook or other bracket attachment design is not important. Similarly, the back panel 80 of the shelving unit 300 is shown as having holes 81 (like a ‘peg board’) merely because this is a common type of back panel used in industry. In other embodiments, the back panel can be solid, or slatted, or any other design.

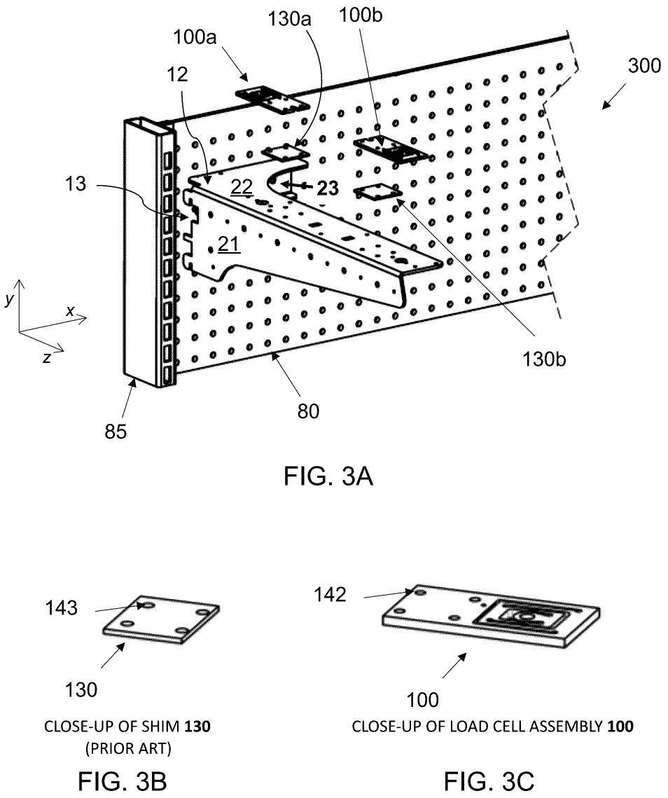

The weighing assembly 10 of FIGS. 2 and 3A is clearly designed to support the ‘left’ side or end of a shelf, i.e., ‘left’ from the perspective of one looking at the weighing assembly 10 with the back panel of the shelving unit 300 in the background. It will be obvious to one skilled in the art that a mirror-image weighing assembly will be necessary for supporting the ‘right’ end of the same shelf. In other words, weighing assemblies in embodiments describing ordinary implementation are provided in pairs of left and right weighing assemblies.

The installation of the planar load cells 100 in the weighing assembly 10 involves anchoring them on a ‘base’ which, according to embodiments, can include a shelf bracket 12 and/or a shim (adapter plate) 130. Referring now to FIGS. 3A, 3B and 3C, mounting holes 142 are provided in load cell assembly 100, which line up with similarly-spaced shim holes 143. Thus, load cell assemblies 100A, 100B can be attached (by screw or rivet or any other appropriate attaching method) to a respective shim 130A, 130B and, in this way, complete the installation of the load cell assemblies on the ‘base’.

### Discussion of Load Cell Assembly Embodiments

Load cells with low profiles may have a characteristically low amplitude signal. Given limitations in the total weight to be measured, and the inherent sensitivity of load cells, the performance of such devices may be compromised by a high noise-to-signal ratio and by unacceptable settling times. Various embodiments of the present invention resolve, or at least appreciably reduce, parasitic noise issues associated with typical low-profile load cells and enable high accuracy weight measurements.

Loading of a spring arrangement is effected by placing a load on, or below, a loading beam, depending on whether the loading beam is anchored to the weighing platform, or to the weighing base. The loading beam may also be referred to as the “loading element” or as the “load-receiving element” or “load-supporting element” (depending on the configuration) of the load cell assembly. The spring arrangement has at least one flexure arrangement having at least two flexures or flexural elements operatively connected in series. The flexure arrangement is operatively connected, at a first end, to the loading beam, and at a second end, to the free or adaptive end of at least one measuring beam.

The flexure arrangement has n flexures (n being an integer) operatively connected in series, the first of these flexures being operatively connected to the loading beam, and the ultimate flexure of the n flexures being operatively connected in series to a second flexure, which in turn, is operatively connected to the first flexure in an assembly of m flexures (m being an integer), operatively connected in series. The ultimate flexure of the m flexures is operatively connected, in series, to a measuring beam of the spring arrangement. Associated with the measuring beam is at least one strain gage, which produces weighing information with respect to the load.

The inventor has discovered that at least two of such flexure arrangements, disposed generally in parallel, may be necessary for the loading element to be suitably disposed substantially in a horizontal position (i.e., perpendicular to the load). In some embodiments, and particularly when extremely high accuracy is not necessary, a single flexure disposed between the loading beam and the measuring beam may be sufficient. This single flexure load cell arrangement may also exhibit increased crosstalk with other load cell arrangements (weighing assemblies may typically have 4 of such load cell arrangements for a single weighing platform). For a given nominal capacity, the overload capacity may also be compromised with respect to load cell arrangements having a plurality of flexures disposed in series between the load receiving beam and the measuring beam. This reduced overload capacity may be manifested as poorer durability and/or shorter product lifetime, with respect to load cell arrangements having a plurality of flexures disposed in series. Nonetheless, the overall performance of the single-flexure arrangement may compare favorably with conventional weighing apparatus and load cell arrangements. In any event, for this case, m+n=−1, which is the lowest value of m+n flexures for the present invention.

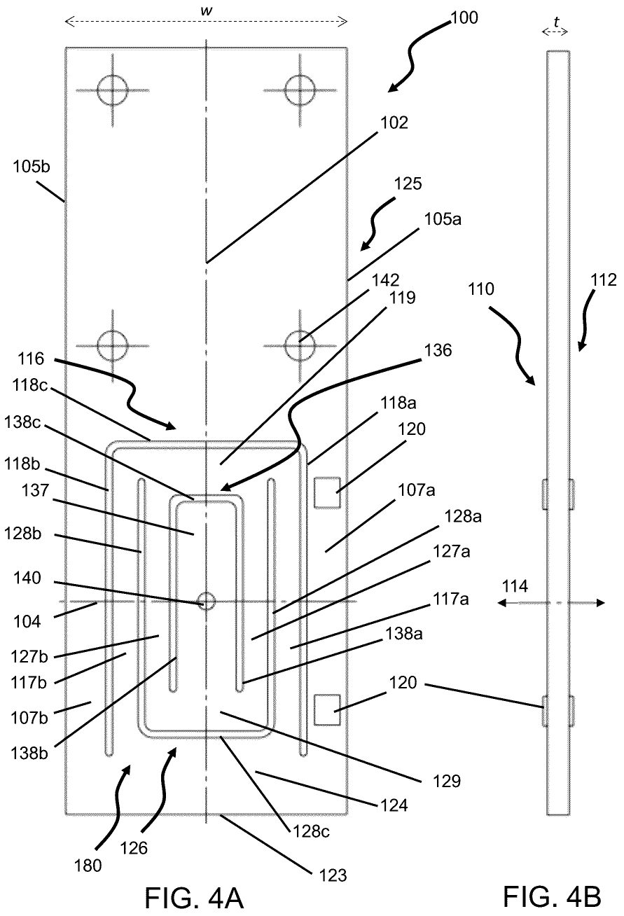

Moreover, there may be two or more spring arrangements for each loading element, disposed generally in parallel. Typically, and as described hereinbelow with respect to FIGS. 4A and 4B, the spring arrangement may include pairs of coupled flexures and coupled measuring beams.

Typically, there are 4 strain gages per loading beam. The strain gages may be configured in a Wheatstone bridge configuration, a configuration that is well known to those of skill in the art. The load cell system may further include a processing unit, such as a central processing unit (CPU). The processing unit may be configured to receive the load or strain signals (e.g., from 4 strain gages SG1-SG4) from each particular load cell and to produce a weight indication based on the load signals, as is known to those of ordinary skill in the art.

Referring collectively to FIGS. 4A and 4B, a load cell body 125 may be made from a block of load cell quality metal or alloy. Particularly advantageous embodiments employing particular magnesium alloys will be described hereinbelow.

Load cell body 125 may be fixed to a weighing assembly via one or more mounting holes or elements 142. A 1^{st} contiguous cutout window 116 passes from a top face 110 through a bottom face 112, perpendicularly through the broad dimension (i.e., with respect to the other 2 dimensions of a three-dimensional Cartesian system) of load cell body 125. 1^{st} contiguous cutout window 116 may be generally C-shaped or U-shaped, and may have arms or a pair of cutout lines 118a, 118b running generally parallel to a central longitudinal axis 102 of load cell body 125, and connected or made contiguous by a cutout line or cutout base 118c. Both central longitudinal axis 102 and a transverse axis 104, disposed transversely thereto, run generally parallel to the broad dimension of load cell body 125. Both of these axes are oriented in perpendicular fashion with respect to a primary axis 114. The thickness of load cell body 125 perpendicular to primary axis 114 is typically within a range of 2 mm to 10 mm, and is designated W_{LCB}.

Long sides 105a and 105b of load cell body 125 run generally along, or parallel to, central longitudinal axis 102. As shown, measuring beams or spring elements 107a and 107b are each disposed between respective cutout lines 118a and 118b, and respective long sides 105a and 105b of load cell body 125, distal to cutout lines 118a and 118b with respect to transverse axis 104. When planar load cell assembly 100 is disposed in a vertically loaded position, the free end of each of beams 107a and 107b may be held in a fixed relationship, substantially perpendicular to the vertical load, by an end block 124 disposed at a free end 123 of load cell body 125.

A 2^{nd} contiguous cutout window 126 also passes from top face 110 through bottom face 112, perpendicularly through the broad dimension of load cell body 125. 2^{nd} contiguous cutout window 126 may be generally C-shaped or U-shaped, and may have arms or a pair of cutout lines 128a, 128b running generally parallel to central longitudinal axis 102, and connected or made contiguous by a cutout line or cutout base 128c. 2^{nd} contiguous cutout window 126 may be enveloped on three sides by 1^{st} contiguous cutout window 116 (such that the 2^{nd} contiguous cutout window is transversely bounded by the 1^{st} contiguous cutout window). The orientation of 2^{nd} contiguous cutout window 126 may be 180° (i.e., generally opposite) with respect to 1^{st} contiguous cutout window 116.

A 3^{rd} contiguous cutout window 136 also passes from top face 110 through bottom face 112, perpendicularly through the broad dimension of load cell body 125. 3^{rd} contiguous cutout window 136 may be generally C-shaped or U-shaped, and may have arms or a pair of cutout lines 138a, 138b running generally parallel to central longitudinal axis 102, and connected or made contiguous by a cutout line or cutout base 138c. 3^{rd} contiguous cutout window 136 may be enveloped on three sides by 2^{nd} contiguous cutout window 126 (such that the 3^{rd} contiguous cutout window is transversely bounded by the 2^{nd} contiguous cutout window). The orientation of 3^{rd} contiguous cutout window 136 may be 180° (i.e., generally opposite) with respect to 2^{nd} contiguous cutout window 126 (and generally aligned with 1^{st} contiguous cutout window 116).

Load cell body 125 has a first flexure arrangement having a first pair of flexure beams 117a, 117b disposed along opposite sides of central longitudinal axis 102, and distal and generally parallel thereto. First pair of flexure beams 117a, 117b may be longitudinally disposed between the first pair of cutout lines and the second pair of cutout lines, and mechanically connected or coupled by a first flexure base 119.

Load cell body 125 has a second flexure arrangement having a second pair of flexure beams 127a, 127b disposed along opposite sides of central longitudinal axis 102, and distal and generally parallel thereto. Second pair of flexure beams 127a, 127b may be longitudinally disposed between the first pair of cutout lines and the second pair of cutout lines, and mechanically connected or coupled by a second flexure base 129.

Contiguous cutout window 136 defines a loading element 137 disposed therein. Loading element 137 is longitudinally defined by 3^{rd} pair of cutout lines 138a and 138b, and is connected to, and extends from, second flexure base 129.

The various cutout lines described above may typically have a width (W_{CO}) of 0.2 mm to 5 mm, and more typically, 0.2 mm to 2.5 mm, 0.2 mm to 2.0 mm, 0.2 mm to 1.5 mm, 0.2 mm to 1.0 mm, 0.2 mm to 0.7 mm, 0.2 mm to 0.5 mm, 0.3 mm to 5 mm, 0.3 mm to 2.5 mm, 0.3 mm to 2.0 mm, 0.3 mm to 1.5 mm, 0.3 mm to 1.0 mm, 0.3 mm to 0.7 mm, 0.3 mm to 0.6 mm, or 0.3 mm to 0.5 mm.

In some embodiments, the ratio of W_{CO} to W_{LCB} (W_{CO}/W_{LCB}) is at most 0.5, at most 0.4, at most 0.3, at most 0.25, at most 0.2, at most 0.15, at most 0.12, at most 0.10, at most 0.08, at most 0.06, or at most 0.05.

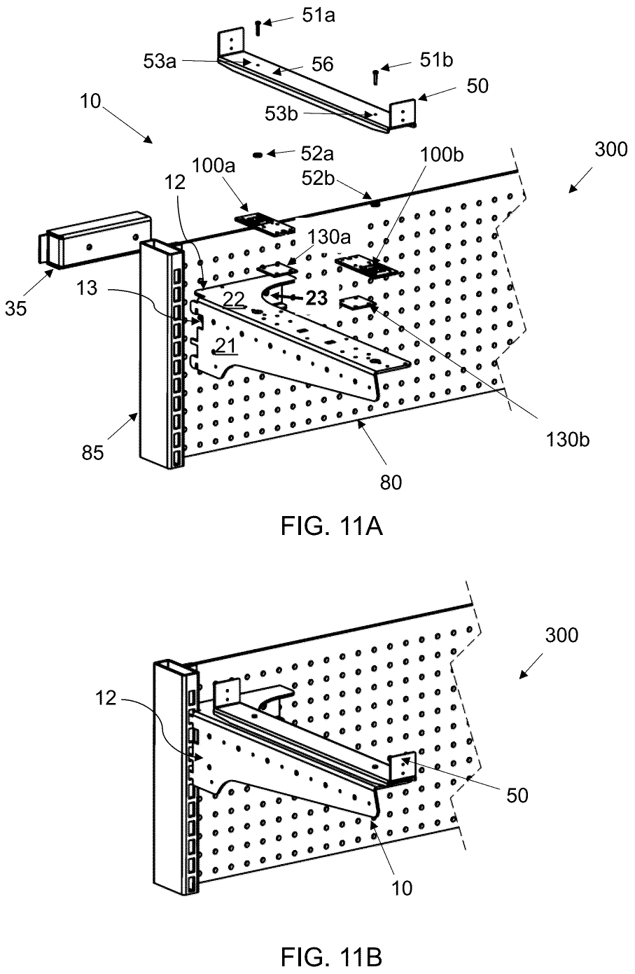

In some embodiments, the ratio of W_{CO} to W_{LCB} (W_{CO}/W_{LCB}) is within a range of 0.03 to 0.5, 0.03 to 0.4, 0.03 to 0.3, 0.03 to 0.2, 0.03 to 0.15, 0.03 to 0.10, 0.04 to 0.5, 0.04 to 0.4, 0.04 to 0.3, 0.04 to 0.2, 0.04 to 0.15, 0.04 to 0.10, 0.05 to 0.5, 0.05 to 0.4, 0.05 to 0.3, 0.05 to 0.2, 0.05 to 0.15, or 0.05 to 0.10. Loading element 137 may also include a hole 140, which may be a threaded hole, for receiving a load, e.g., for receiving or connecting to an upper, weighing platform, or for supporting a load, e.g., connecting to a base, leg, or support (disposed below load cell body 125) of a weighing system (described with respect to FIG. 11). Load-receiving hole 140 may be positioned at an intersection of central longitudinal axis 102 and transverse axis 104.

In the exemplary embodiment provided in FIGS. 3A and 3B, first and second flexure arrangements form a flexure arrangement 180, mechanically disposed between loading element 137 and measuring beams or spring elements 107a and 107b.

At least one strain gage, such as strain (or “strain-sensing”) gages 120, may be fixedly attached to a surface (typically a top or bottom surface) of each of measuring beams 107a and 107b. Strain gages 120 may be adapted and positioned to measure the strains caused by a force applied to the top of the “free” or “adaptive” side 123 of load cell body 125. When a vertical load acts on free end (i.e., an end unsupported by the base, as shown in FIG. 4) 123 of load cell body 125, load cell body 125 undergoes a slight deflection or distortion, with the bending beams assuming a double-bending configuration having an at least partial, and typically primarily or substantially, double-bending behavior. The distortion is measurably sensed by strain gages 120.

It may thus be seen that planar load cell assembly 100 is a particular case of a load cell assembly having the load beam and spring arrangement of FIG. 4A. In this case, the number of intermediate flexures is 2, such that m and n both equal zero. In addition, the intermediate flexures are intermediate flexure beam pairs connected by a flexure base. Similarly, the measuring beams are connected at a first end by the fixed end of load cell body 125, and at the opposite end by adaptive end 124 of load cell body 125.

A load cell body 125 may be made from a block of load cell quality metal or alloy. For example, load cell quality aluminum is one conventional and suitable material. In some embodiments, the alloy may advantageously be a magnesium alloy, typically containing at least 85%, at least 90%, and in some cases, at least 92%, at least 95%, or at least 98% magnesium, by weight or by volume. The magnesium alloy should preferably be selected to have an elastic module (E) that is lower, and preferably, significantly lower, than that of aluminum.

Any planar load cell assembly disclosed herein or otherwise suitable for use in this invention is one with a ‘high’ ratio of width to thickness, where ‘width’ is the dimension across a plan view of the planar load cell assembly, for example the dimension indicated by the arrow marked with w in FIG. 4A, and thickness is the dimension across a side view, for example the dimension indicated by the arrow marked with t in FIG. 4B. Although the figures attached herewith are not necessarily drawn to scale, the exemplary load cell assembly of FIGS. 4A and 4B can be seen to have a width-to-thickness ratio of more than 10. In some embodiments, the ‘high’ width-to-thickness ratio can be more than 3 or more than 4, and more typically more than 6, more than 8, or more than 10.

### Stabilization of the Weighing Assembly

Referring back to FIG. 3A, it can be seen that the exemplary weighing assembly 10 can have a three-dimensional structure comprising at least three substantially planar members in different respective planes. According to the x-y-z axes shown in FIG. 3A, the weighing assembly 10 comprises a ‘vertical’ member 21 in the y-z plane, a ‘horizontal’ member 22 in the x-z plane, and a further ‘vertical’ member 23 in the x-y plane. Each of the three planar members can play a role in serving to immobilize a weighing assembly 10 attached to a shelving unit 300.

Joining the shelf bracket 12 portion of a weighing assembly 10 to an upright 85 of a gondola-type shelving unit 300 by means of bracket hooks 13 may be adequate to render a shelf 90 placed thereupon sufficiently immobilized enough for the ordinary function of remaining horizontal within a reasonable tolerance for displaying products. However, a tighter tolerance might be required for effective deployment and operation of load cell assemblies 100 in intelligent shelves used for tracking inventory and facilitating retail sales transactions. In embodiments, it can be necessary to stabilize a weighing assembly in order to minimize any movement of a shelf bracket or any rotation of a shelf bracket about any axis of the x, y or z axes, because the four (or more) load cell assemblies of left and right weighing assemblies are all desired to be horizontal and level in order for the weight indications generated by the weight assemblies to be as accurate and as reliable as possible. Horizontal can mean on the x-z plane, with a tolerance within ±3°, within ±2°, within ±1°, within ±0.8°, within ±0.5°, within ±0.3°, within ±0.25°, within ±0.20°, within ±0.15°, within ±0.12°, within ±0.10°, within ±0.08°, within ±0.06°, within ±0.05°, within ±0.04°, within ±0.035°, within ±0.030°, within ±0.025°, or within ±0.020°.

Therefore, according to embodiments, it can be helpful to provide additional measures for enhancing the stabilization and immobilization of shelf brackets and the loads they support.

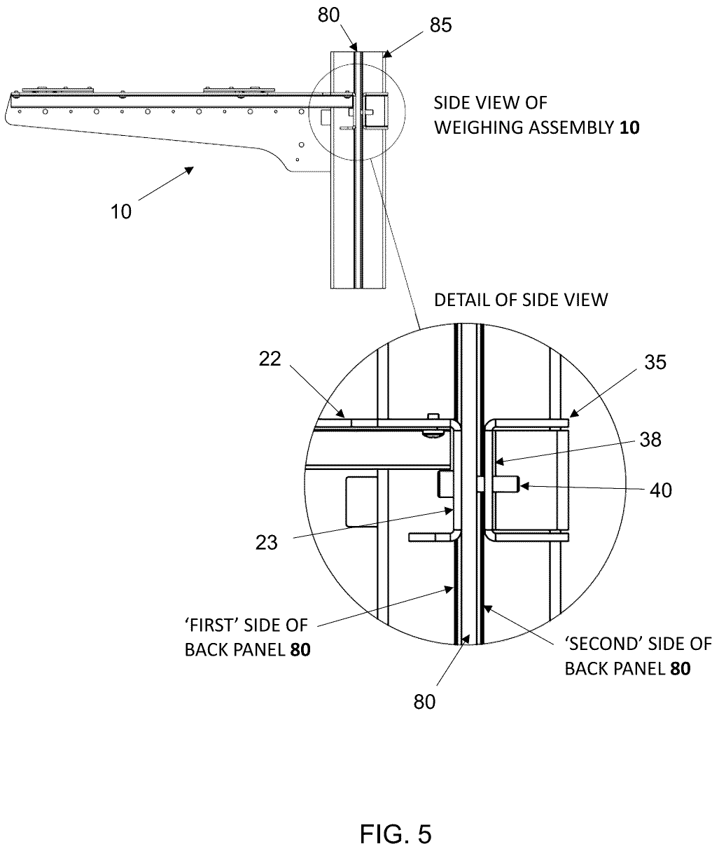

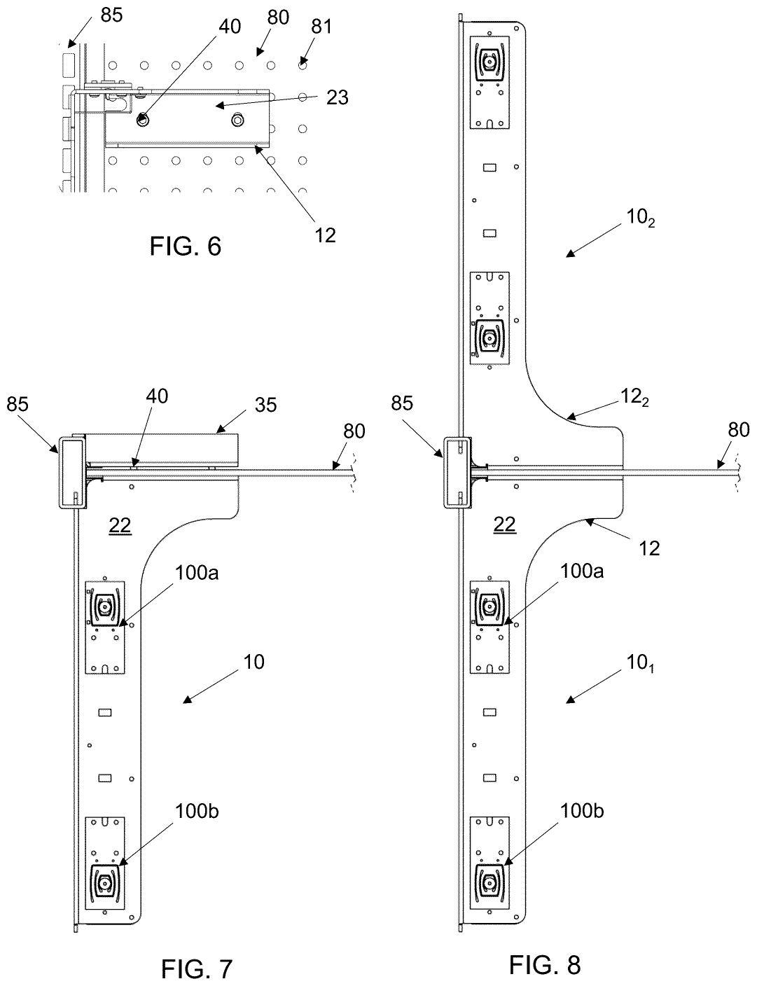

FIGS. 5, 6 and 7 illustrate an example of providing a stabilization element 35, for example, for the purpose of stabilizing and immobilizing the shelf brackets 12. As mentioned above, the shelf bracket 12 includes a vertical (x-y plane) member 23 designed to be flush or close to flush with the back panel 80 of a shelving unit 300. In the embodiment illustrated in FIGS. 5, 6 and 7, an x-y plane member 35 of the stabilization element 35 is joined to the x-y plane member of the shelf bracket 12 by means of one or more connection elements 40. The connection element 40, which can be a screw, a rivet, or any other appropriate mechanical connector, can pass through the back panel 80 of the shelving unit 300 through a hole 82. In FIG. 6, an elevation view of the x-y plane member 23 of the shelf bracket 12 is shown, with two connection elements 40 passing through the back panel 80. In other embodiments, more than two connection elements may be used, or alternatively only one—the important thing is that the connection effectively immobilizes the shelf bracket.

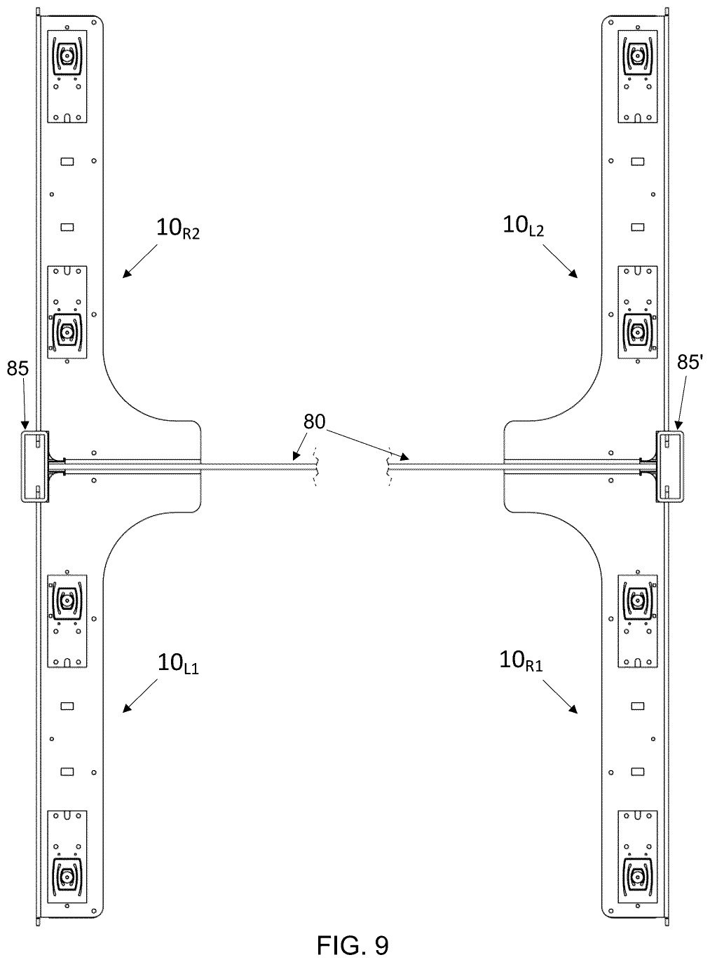

Another non-limiting example of stabilizing the shelf brackets 12 against movement or rotation is illustrated in FIG. 8. Rather than providing a separate stabilization element 35 as in the previous example, in this embodiment the x-y plane member 231 (not shown in FIG. 8) of the shelf bracket 12₁ of weighing assembly 10₁ is joined by connection element(s) 40 (not shown in FIG. 8) to a respective x-y plane member 23₂ of the shelf bracket 12₂ of a second weighing assembly 10₂ installed on the second side of the back panel 80. The arrangement illustrated in FIG. 8 is commonly deployed in double-sided gondola shelving systems 300 such as the one illustrated in FIG. 1. The use of a separate stabilization element 35 is generally appropriate for use in a single-sided gondola shelving system, i.e., where no shelf bracket is to be installed on the back side of the back panel. In some embodiments, however, the separate stabilization element 35 is used for stabilizing shelf brackets even in double-sided gondola shelving units, for example when a shelf on the second side of the back panel is installed at a different height than that of a shelf on the first side. In some embodiments, therefore, both methods of stabilization may be used: wherever back-to-back shelf brackets are installed at the same height, then the shelf brackets can be joined to each other as in FIG. 8, while in other places in a shelving system, where back-to-back brackets are installed at different heights, then the separate stabilization element can be used as in FIGS. 5, 6 and 7. It can be seen that the two weighing assemblies 10₁, 10₂ shown in FIG. 8 are not of exactly the same design—rather, they are substantially mirror images of each other. Referring now to FIG. 9, two pairs of weighing assemblies 10 are illustrated, each pair utilizing one of each design. A first pair, 10_{L1}, 10_{R1}, are respectively the left and right weighing assemblies for supporting a single shelf (not shown). The second pair, 10_{R2}, 10_{L2}, are respectively the right and left (when viewed from the second side of the shelving unit) weighing assemblies for supporting a second shelf. FIG. 9 also shows a first upright 85 and a second upright 85′. The second upright may be part of a second shelving unit, or may be added by itself to a single shelving unit comprising a back panel and a first upright only, in order to ‘finish’ the shelving unit (or concatenation of shelving units) and permit the right-side weighing assembly 10_{R1} to be installed. It will be obvious to one skilled in the art that in the receiving/securing bracket holes (87 in FIG. 2) in a single upright 85 or 85′, there is enough room for the bracket hook (13 in FIG. 2 or 3A) from a second, adjacent shelf bracket. In other words, if a second shelving unit were to be concatenated to the first shelving unit partly illustrated in FIG. 9 (comprising upright 85 and back panel 80), the bracket hook of a respective left-side shelf bracket of the second shelving unit would fit into the same upright hole as the bracket hook of weighing assembly 10_{R1}. While two pairs of weighing assemblies are shown in FIG. 9 so as to show a ‘maximal’ case, it will be obvious to the skilled artisan that in some embodiments only a single pair of weighing assemblies (e.g., 10_{L1}, 10_{R1}) is provided.

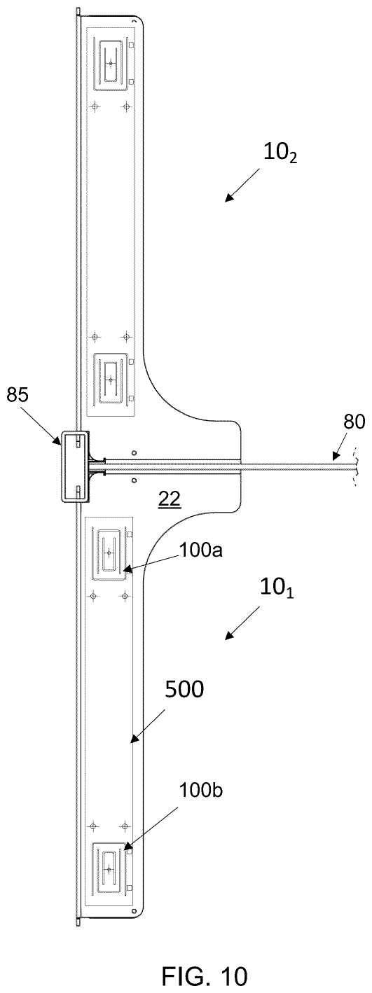

Earlier discussion has assumed that load cell assemblies 100a and 100b installed in a weighing assembly 10 are separate elements. FIG. 10 shows an alternative embodiment in which a weighing assembly 10₁ employs a double-ended planar load cell assembly 500 comprising two planar load cell assemblies 100a, 100b, substantially similar or identical to those described hereinabove, but sharing a common, integral load cell body, and generally disposed at opposite ends thereof, symmetrically about a central transverse axis of the load cell body.

### Stabilization of the Shelf

In some embodiments it can be desirable to stabilize and immobilize the shelf element of a weighing assembly or shelving assembly. This is not necessarily dependent upon also stabilizing and immobilizing the shelf bracket (to ensure the horizontal disposition of load cell assemblies) as discussed above. It can also be desirable to provide a way of reliably transferring the load of the shelf (and of products displayed thereupon) to the load cell assemblies.

Referring now in combination to FIGS. 11A, 111B, 12A, 12B and 12C, a weighing assembly 10 including a shelf bracket 12 is shown. The weighing assembly 10, according to the embodiment illustrated in these figures, also comprises: a receiving bracket 50 for receiving a shelf, a plurality of protruding elements 51a, 51b, and a plurality of joining elements 52a, 52b vertically aligned with respective protruding elements 51a, 51b for receiving the respective protruding elements 51a, 51b. It should be noted that the number of respective protruding elements 51 and joining elements 52 will be the same as the number of load cell assemblies 100 for any given weighing assembly 10. In all of the non-limiting examples shown in this disclosure, the number of load cell assemblies 100 is two, and thus two respective protruding elements 51 and two joining elements 52 are shown.

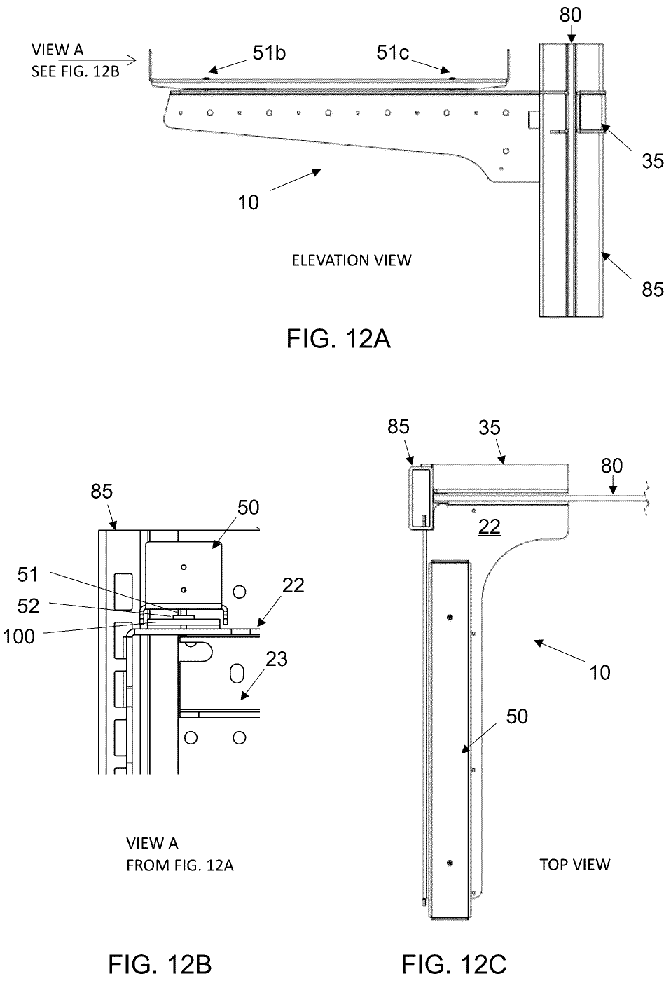

The protruding elements 51a, 51b, together with the joining elements 52a, 52b, can function to transfer the load (weight) of a shelf (not shown in these figures) and any products displayed thereupon to the load cell assemblies 100a, 100b. In some embodiments the protruding elements 51 can transfer the load directly by having a lower end positioned in a receptacle in the load cell assembly 100 and in other embodiments the protruding elements function to ensure the positioning of the joining elements 52 around the holes (140 in FIG. 4A) on the load cell assemblies 100 so as to transfer the load to the load cell assemblies 100 via the joining elements 52. They can also function to inhibit movement of the receiving bracket 50 in the horizontal plane, for example by being installed in or through holes (140 in FIG. 4A) in respective load cell assemblies. In some embodiments, protruding elements 51 and joining elements 52 can be threaded (e.g., a threaded bolt and respective nut) and in other embodiments they can be unthreaded (e.g., a simple bolt and respective washer). In some embodiments both a threaded nut and a washer may be provided. A protruding element 51 can be deployed in any one of a number of approaches. For example, a protruding element can be disposed on a receiving bracket 50. As another example, a protruding element 51 can be disposed on joining element 52. As another example, the protruding elements 51a, 51b can be inserted through holes 53a, 53b in the longitudinal member 56 of the receiving bracket 50, and either (a) (as shown in the example of FIG. 12B) further inserted through holes 140 in load cell assemblies 100a, 100b, and secured by respective joining elements 52a, 52b interposed between the load cell assemblies 100a, 100b and the receiving bracket, preferably flush with the upper surfaces of the load cell assemblies 100a, 100b or (b) be received in receptacles (not shown) in load cell assemblies 100a, 100b and secured by respective joining elements 52a, 52b interposed between the load cell assemblies 100a, 100b and the receiving bracket 50, preferably flush with the lower surface of the receiving bracket 50. In the last example, a head portion of a protruding element 51 can be disposed on the upper surface of the longitudinal member 56 of receiving bracket 50 while the remainder of the protruding element 51 is inserted through the hole 53.

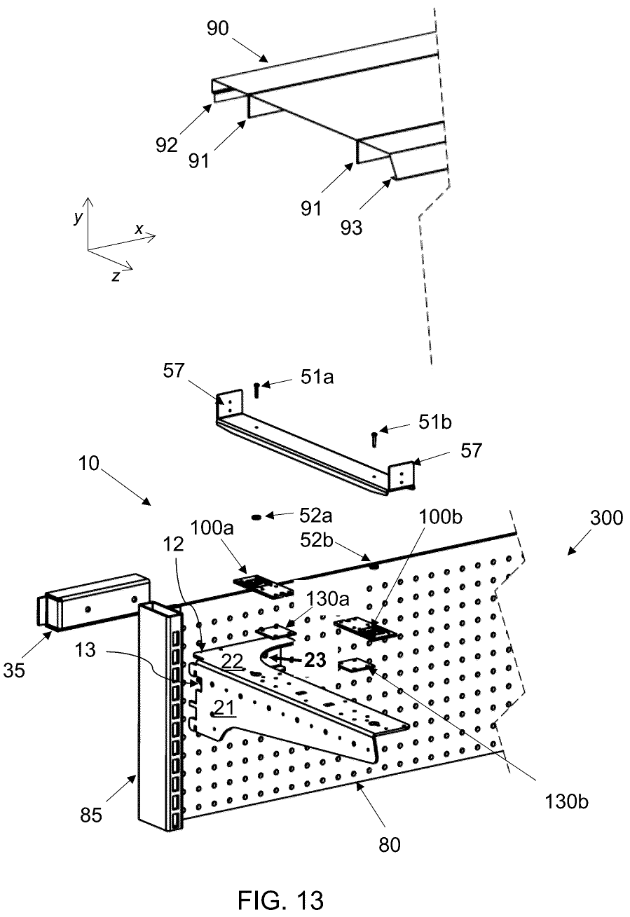

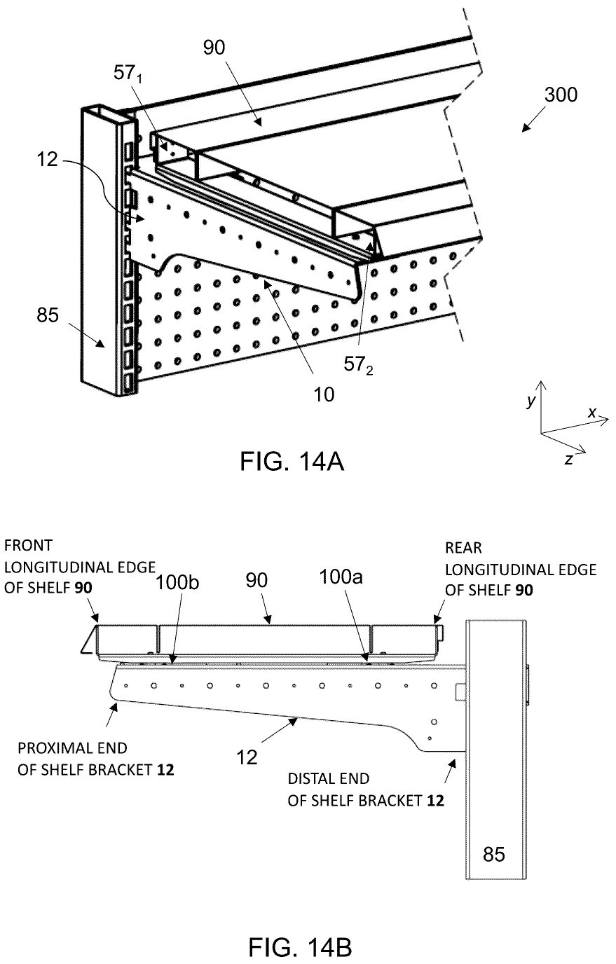

Referring to FIG. 13, a metal shelf 90 can have any number of vertically disposed longitudinal members 91 provided mainly for the mechanical stability and/or rigidity of the shelf 90. The members are called ‘longitudinal’ because they run at least a portion of what is usually the longest dimension in a shelf, and this phrasing is used herein even for the case where a shelf is ‘short’ and the end-to-end dimension is not the longest, The shelf can also have a front lip 93 (shown as angled but can also be vertical, as the exact angle of the front lip 93 to the body of the shelf 90 is not important here) and a rear flange 92 which also can be vertical or angled like the front lip 93. Substantially vertical members 57 of receiving bracket 50 are positioned so as to engage one or preferably more of the longitudinal members 91, front lip 92 and rear flange 92, such that movement of the shelf in the z-axis is limited or inhibited. FIG. 14A shows the exploded elements of FIG. 13, assembled, and it can be seen that the position of first vertical member 57₁ of the receiving bracket 50 next to rear flange 92 of the shelf 90 prevents the shelf 90 from slipping in a first direction on the z-axis, or at least limits the extent of the movement, while the position of second vertical member 57₂ of the receiving bracket 50 next to front lip 93 of the shelf 90 prevents the shelf 90 from slipping in a second direction on the z-axis (or, again, limits the extent of the movement)—the first and second directions corresponding to frontwards and rearwards. FIG. 14B provides a side elevation view of the assembly drawing of FIG. 14A. As can be seen, the rear longitudinal edge of shelf 90 does not necessarily sit all the way ‘back’ on the shelf bracket 12, and in this example sits between load cell assembly 100b and the distal end of the shelf bracket 12. Similarly, the shelf can ‘stick out’ further (e.g., from a back panel 80 of a shelving unit 300, neither shown in FIG. 14B) than does the proximal end of the shelf bracket 21. In other words, the proximal end of the shelf bracket 12 can be disposed anywhere between the front longitudinal edge of the shelf 90 and rear longitudinal edge of the shelf 90; the only guiding principle is that all load cell assemblies (in this example: 100a, 100b) be disposed under a portion of the shelf 90 so as to bear the entire load of the shelf 90 and, in embodiments, produce weight indications therefor.

Self-Stabilized Weighing Assembly with Two Shelf Brackets

In embodiments, it can be desirable to achieve the benefits of the present invention without using shelf stabilization. This can be accomplished, in a non-limiting example, by providing a weighing assembly that includes two shelf brackets and components that provide sufficient rigidity and stabilization such that the need for a stabilizing element (or backing assembly) is obviated.

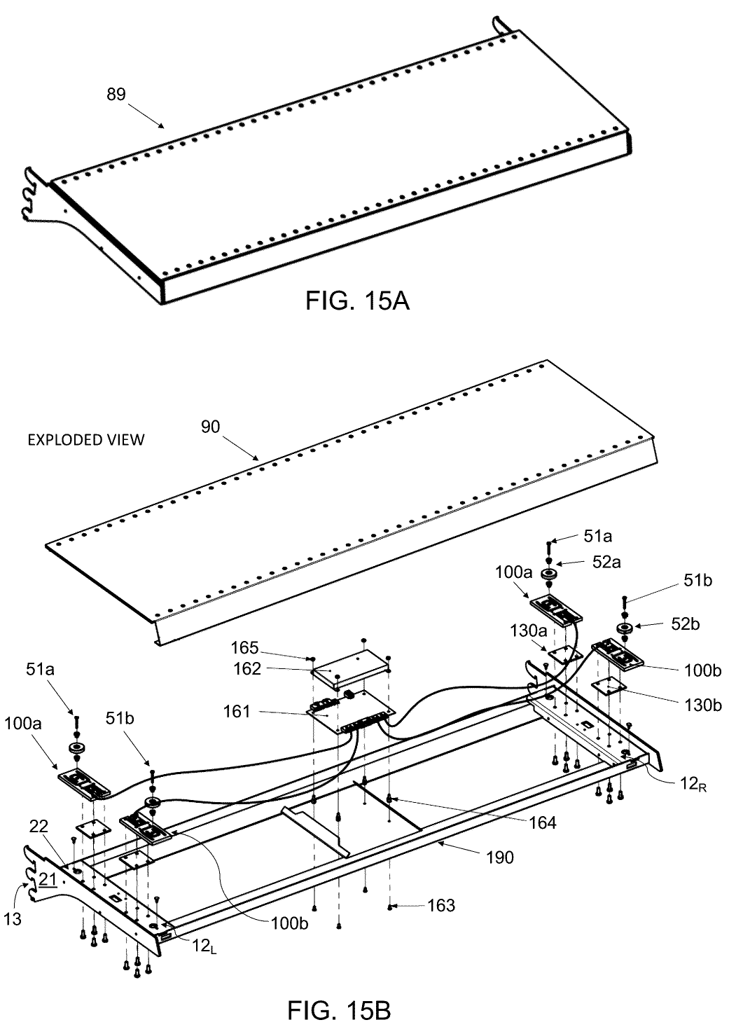

Reference is made to FIGS. 15A and 15B, which respectively, show an assembled weighing assembly 89 comprising two shelf brackets 12_{L} and 12_{R} according to embodiments of the present invention, and an exploded view of the weighing assembly. The weighing assembly 89 of FIGS. 15A and 15B is self-stabilizing, i.e., does not require the use of an additional stabilizing element or connection to a back wall of a shelving unit, and can be installed in a shelving unit (e.g., shelving unit 300) without any tools and by a single employee.

Substantially as shown, each of the two shelf brackets 12_{L} and 12_{R} may comprise a vertical member 21 which includes industry-standard bracket hooks 13 for engaging with uprights 85, and a horizontal member 22. Planar load cells 100 are fixed to the shelf bracket 12, in the same way as illustrated, e.g., in FIGS. 3A, 11A and 13, by anchoring them on a ‘base’ which, according to embodiments, can include the shelf bracket 12 and a shim (adapter plate) 130. As was discussed with reference to FIGS. 3B and 3C, mounting holes 142 are provided in load cell assembly 100, which line up with similarly-spaced shim holes 143. Thus, load cell assemblies 100A, 100B can be attached (by screw or rivet or any other appropriate attaching method) to a respective shim 130A, 130B and, in this way, complete the installation of the load cell assemblies on the ‘base’.

The two shelf brackets 12_{L} and 12_{R} are joined mechanically by a shelf frame 190 which, although illustrated as a simple frame, can include any member(s) such as one or more beam members, which, when joined with the shelf brackets 12_{L} and 12_{R}, provide rigidity. The shelf frame 190 can be an ‘open structural member’ as shown in non-limiting example shown in FIG. 15B, as the ‘openness’ serves to reduce the weight and cost of the illustrated structural member, but this only is for purposes of illustration and the shelf frame need not be open if it is deemed desirable by a designer to use a solid, non-open member or assembly of members that provides structural rigidity at an acceptable weight and cost. Shelf frame 190 can be fabricated from any material such as a metal or a plastic deemed suitable in terms of rigidity, weight and cost.

As discussed earlier, protruding elements 51a, 51b, together with the joining elements 52a, 52b, can function to transfer the load (weight) of a shelf 90 and any products displayed thereupon to the load cell assemblies 100a, 100b. In embodiments, the protruding elements 51 can transfer the load directly by having a lower end positioned in a receptacle in the load cell assembly 100 and in other embodiments the protruding elements function to ensure the positioning of the joining elements 52 around the holes (140 in FIG. 4A) on the load cell assemblies 100 so as to transfer the load to the load cell assemblies 100 via the joining elements 52. In some embodiments, protruding elements 51 and joining elements 52 can be threaded (e.g., a threaded bolt and respective nut) and in other embodiments they can be unthreaded (e.g., a simple bolt and respective washer). In some embodiments both a threaded nut and a washer may be provided as shown in FIG. 15B. One of ordinary skill in the art will appreciate that various conventional arrangements can be employed for coupling the load (shelf 90) to the load cell assemblies 100a, 100b. In the non-limiting example of FIG. 15B, a processor 161 is provided on-board the weighing assembly 89 in order to simplify communication with load cell assemblies. In the illustrated example, processor 161 is affixed to the shelf frame 190 with upper fasteners 165 and lower fasteners 163. A processor cover 162 can be provided, e.g., to protect the processor from dust, moisture or detritus, and spacers 164 may be used to isolate the processor from a metallic shelf frame 190.

### Incorporation in a System

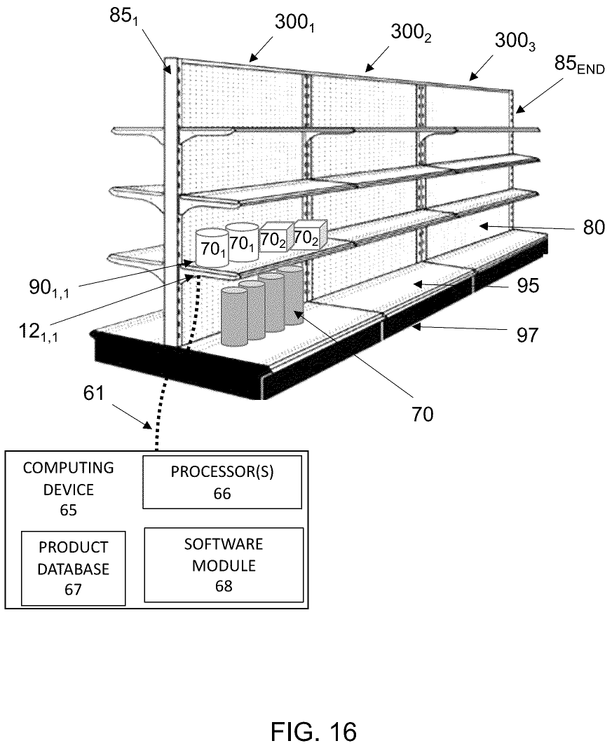

FIG. 16 shows a concatenated assembly of three shelving units 300 similar to those shown in FIG. 1. A variety of different products 70, i.e., non-homogeneous products, can be seen on display in shelving unit 300₁, including, on shelf 90₁₋₁ (the double subscript 1-1 indicating the first shelf of the first shelving unit 300₁) supported by shelf bracket 12₁₋₁, a first plurality of products 70₁ with a first SKU (stock keeping unit)-identifier and a second plurality of products 70₂ with a second SKU-identifier. The expression ‘displayed’ merely means that the products are in/on the shelving unit and does not imply that being on display is a limiting feature of any embodiments.

As described earlier in connection with the discussion of FIG. 4A, each load cell assembly 100 can include a processor, which may be configured to receive the load or strain signals from the strain (e.g., from 4 strain gages SG1-SG4) from each particular load cell and to produce a weight indication based on the load signals. Each processor can have a communications arrangement for communicating the weight indication, for example by means of a communications channel (61 in FIG. 16) which can be a wired connection or a wireless connection (as non-limiting examples: any short-range point-to-point communication system such as IrDA, RFID (Radio Frequency Identification), TransferJet, Wireless USB, DSRC (Dedicated Short Range Communications), or Near Field Communication; or wireless sensor networks such as: ZigBee, EnOcean; Personal area networks, Bluetooth, TransferJet, or Ultra-wideband). The communications arrangement of the weighing assembly (or of a processor associated with the weighing assembly) is of course selected so as to be appropriate to the communications technology chosen for the communications channel 61. The communication of weight indication(s) by means of the communications channel 61 can be to a computing device 65 configured to receive information from the weighing assemblies and track the weights of shelves 90 and of the products 70 displayed thereupon. The computing device 65 can include one or more processors 66 for executing computer code, a software module 67 that includes computer code for execution by the one or more processors 66, and/or a product database 67. Preferably, the computer code includes executable instructions for processing the received information about shelf weights (the weight indications) and determining (a) that a change in weight of a shelf has changed, (b) that a product has been added to or removed from a shelf and (c) which product has been added to or removed from a shelf. Preferably, the computing device 65 receives weight indications from all of the individual load cell assemblies installed in both of the weighing assemblies that support any one specific shelf, so that the determinations will be more accurate and more reliable. The determination (a) that a change in weight of a shelf has changed can be made, for example, by tracking the weight of a shelf over time and comparing one time-based value to another. The determination (b) that a product has been added to or removed from a shelf can be made, for example, by determining that the determined change in the weight of a shelf is substantial enough to be a product movement, i.e., is not below a pre-determined threshold. For example, a child leaving chewing gum on a shelf may register as a change in weight of the shelf, but the change can be determined as not being substantial enough to be a product movement. Similarly, the computer code can be configured to exclude ‘false positives’ such as a person leaning on the shelf, or a person leaving an unidentified weight (i.e., not correlating with a known product) on the shelf. The determination (c) which product has been added to or removed from a shelf is made by analyzing the change in weight from the addition or removal, and by looking up product weights in a product database 67 which includes product weights and SKU-identifiers. The product database 67 can optionally include statistical and/or historical information about the distribution of weight for a particular product/SKU-identifier. The determining can optionally include applying the statistical and/or historical information to help in the determining.

Methods for tracking non-homogeneous products on a shelf can use a plurality of weighing assemblies that are jointly operable to measure the combined weight of the shelf and of the products arranged thereupon. In an example, a method comprises: (a) monitoring weight measurement data corresponding to the weight of the shelf and the products arranged thereupon, the weight measurement data measured by the plurality of weighing assemblies and transmitted therefrom as respective streams of weight measurement data points; (b) responsively to a change over time in the values of the weight measurement data, determining a set of weight-event parameters of a weight event, the set of weight-event parameters comprising a product identification and an action taken with respect to the product, the determining comprising: (i) aggregating, across all of the streams, changes in the weight measurement data corresponding to a specific time, (ii) mapping a change in weight distribution on the shelf, using the aggregated changes in weight measurement data, and (iii) assigning a set of weight-event parameters for resolving the mapped change in weight distribution, using product-weight data retrieved from a product database; and (c) performing at least one of: (i) recording information about the results of the selecting in a non-transient, computer-readable medium, and (ii) displaying information about the results of the selecting on a display device.

In some embodiments, the assigning comprises: (i) identifying at least one candidate set of weight-event parameters for resolving the mapped change in weight distribution, using product-weight data retrieved from a product database, (ii) assigning an event likeliness score to each candidate set of weight-event parameters, and (iii) selecting the set of candidate weight-event parameters having the highest event likeliness score. The determining can use product positioning data from a product positioning plan in at least the identifying. The determining can include calculating a probability in at least the assigning. In some such embodiments, the probability can be calculated using a probability distribution function. In some such embodiments, a parameter of the probability distribution function can be derived using a machine learning algorithm applied to historical weight data for a product. The assigned set of weight-event parameters can include exactly one product and one action, or can include at least one of (i) two or more products and (ii) two or more actions. The action taken with respect to the product is selected from the group consisting of removing the product from the shelf, adding the product to the shelf, and moving the product from one position on the shelf to another.

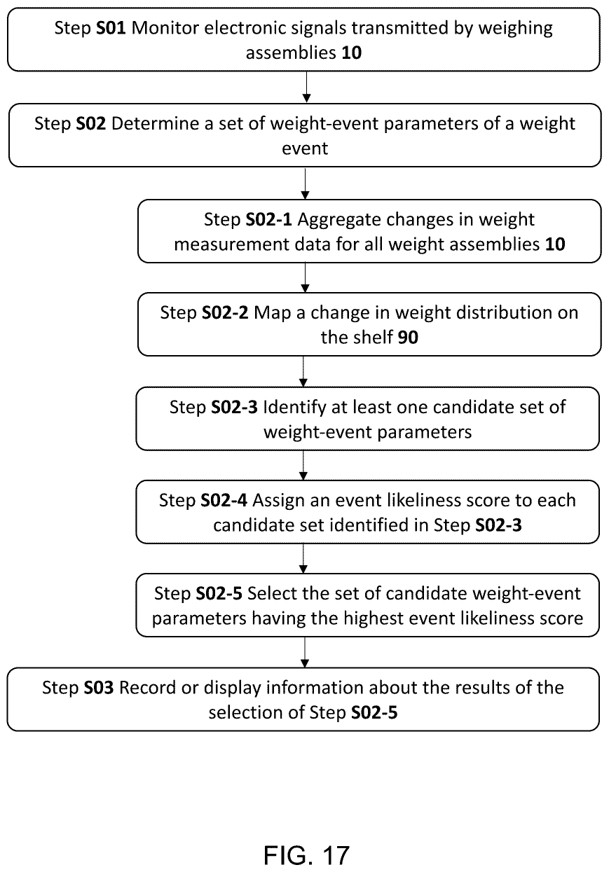

A method for tracking non-homogeneous products on a shelf, according to embodiments of the present invention, is now disclosed; a flow chart of the method is shown in FIG. 17. According to the method, a plurality of weighing assemblies 10 is jointly operable to measure the combined weights of the shelf 90 and any and all products 70 arranged thereupon. The method, as shown in the flow chart of FIG. 17, comprises:

Step S01: monitoring electronic signals transmitted by weighing assemblies 10. Each electronic signal is from a different weighing assembly 10, and includes a respective stream of weight measurement data points. The weight measurement data points correspond to the weight of the shelf and the products arranged thereupon and, as mentioned earlier, each point reflects a portion of the total weight that is distributed among all of the weighing assemblies 10. The monitoring of the signals includes assessing the values, for example to detect changes in the weights over time, e.g., a difference between a first weight measurement data point at a first time and a second weight measurement data point at a second time, that can be indicative of an action taken with respect to a product.

Step S02: determining a set of weight-event parameters of a weight event. The determining is carried out in response to a change in values, over time, i.e., from one time point to another (not necessarily a consecutive time point) in weight measurement data. The determining can be carried out in response to such a change in values being greater than a given threshold, or that the absolute value of the change is greater than a given threshold. A weight event is an event in which an action is taken with respect to a product so as to change the weight or weight distribution of products on a shelf. Weight-event parameters include a product identification (or identification of more than one product involved in a single weight event, if appropriate) and an action taken with respect to the identified product (or products). A set of weight-event parameters can include a single product and a single action, or one or more products each associated with one or more actions. The determining can be probabilistic. Uncertainties in carrying out the method can mean that the determining selects the most likely set of weight-event parameters for a weight event. For example, the result of a determining can that that product #1 70₁ being added to a shelf 90 is the ‘most likely’ explanation for a detected change in weight measurement data, as opposed to product #2 70₂ being added or product #3 being added, both of which can be alternative but ultimately less likely candidates for the determining. The uncertainties can stem from any number of sources, including, for example, inaccuracy of the weighing assemblies or unresolved noise and/or drift in the stream of data points. An additional source of uncertainty can include the time it takes for a measurement made by weighing assembly to stabilize (e.g., as a function of the elasticity of a load cell component or of the shelf itself), combined with a system requirement to resolve the weight-event parameters within a limited amount of time, such that an actual total change in weight might not be captured because of a time constraint or other limitation. Other sources of uncertainty will be enumerated later in this discussion where relevant.

As further shown in the flowchart in FIG. 17, Step S02 includes five sub-steps, as follows:

Step S02-1: aggregating changes in weight measurement data for all weight assemblies 10. As used herein, ‘aggregating’ has the meaning of ‘summing’. As discussed earlier, changes in weight measurement data are aggregated for each specific point in time; the aggregation can be for every point in time in a specific time interval or for all points in time as long as the monitoring of Step S01 continues, or for each determining; or for points in time selected according to a given periodicity or selected randomly; the only requirement is that aggregated data all correspond to a given point in time and therefore the streams are preferably synchronized.

Step S02-2: mapping a change in weight distribution on the shelf 90. A weight of a product placed on the shelf (for example) is distributed to all of the weighing assemblies of a shelf so that the aggregate of the increment in measurements made by all of the weighing assemblies equals the total incremental weight of the product; this step solves for the magnitude and location of the weight of the product placed on the shelf (i.e., or removed from the shelf or moved along the shelf) given the individual weight measurement data of the various weighing assemblies. In some embodiments the mapping can be deterministic, producing a single answer for the magnitude of the weight added/removed/moved and the coordinates of the center of weight of that weight. In other embodiments, the mapping can be probabilistic. For example, instead of mapping to a single weight center (X, Y), the mapping of product weight to x,y coordinates can be considered to have a probabilistic distribution (e.g., a density function). The probabilistic function can take into account, for example, unknowns with regards to the uniformity of the make-up or structure of the shelf, or with regards to possible angular displacement of the shelf from horizontal. It can also take into account inaccuracies in one or more of the weighing assemblies. Using a non-deterministic result out of the mapping sub-step can be another source in uncertainty in the overall determining step. In some embodiments the result of this mapping step can be stored in a repository of weight distribution mappings 51 in computer-readable storage medium 68.

Step S02-3: identifying at least one candidate set of weight-event parameters for the weight event. In this step, product data for reference can be accessed or retrieved from a product database 67 which can include, inter alia, baseline weights for products as well as ranges and distributions of possible and/or historical weights for products. Data for reference can be accessed or retrieved from a product positioning plan 69 (a planogram). The identifying includes matching a weight added/removed/moved (‘the event weight’) in Step S03-2 with the weight of a product according to data in the product database 67 and/or appearing in the planogram. The matching can return a single deterministic answer or can return an answer consisting of one or more products that may match the event weight, or come close with varying levels of probability. Probability may be assigned according to a wide variety of factors, some of which are illustrated in the following examples:

In an example, two products in the product database both have a weight matching the event weight, but only one of them is in the planogram for the shelf in question. While both products are identified in candidate sets of weight-event parameters, the one appearing in the planogram is assigned a higher probability.

In another example, two products in the product database both have a weight matching the event weight, but they appear in the planogram as belonging on other shelves. One belongs, according to the planogram, on a nearby shelf, while the other appears on a far-away shelf. While both products are identified in candidate sets of weight-event parameters, the one appearing in the planogram on a closer shelf is assigned a higher probability.

In another example, two products appearing in the product database and in the planogram have a weight matching the event weight, and the weight event is an addition to the shelf. The first product was identified with a ‘removal’ weight-event from the same shelf ten minutes earlier, and the second product was identified with a ‘removal’ event five minutes earlier. While both products are identified in candidate sets of weight-event parameters, the one identified in a removal weight event five minutes earlier is assigned a higher probability.

In another example, the aggregated change in weight on the shelf was 500 grams. A first product appearing in the planogram for that shelf weighs 50 grams more, according to the product database, and a second product weighs 30 grams less. While both products are identified in candidate sets of weight-event parameters, the product weighing 30 grams less is assigned a higher probability. In another example, the second product weighing 30 grams less ‘belongs’ on the left side of the shelf according to the planogram and the first product weighing 50 grams more belongs on the right side; according to the mapping of weight distribution in Step S02-02, the weight-center of the weight added or removed was closer to the right side, and the product weighing 50 grams more is assigned a higher probability.

In another example, two products appearing in the product database and in the planogram have a weight matching the event weight, and the weight event is a removal from the shelf. The first product has a sales rate of one can per week, and the second product has a sales rate of five cans per week. While both products are identified in candidate sets of weight-event parameters, the product with the higher sales rate is assigned a higher probability.

In yet another example, two products appearing in the product database and in the planogram have a weight matching the event weight, and the weight event is a removal from the shelf. The first product is ‘on sale’ this week at a 20% discount, and while both products are identified in candidate sets of weight-event parameters, the product with discount is assigned a higher probability.

In some embodiments, an assigned probability can be calculated using a probability distribution function. A probability distribution function can be pre-programmed based on hypothetical data and/or empirical data. A probability distribution function can be derived using a machine learning algorithm applied to historical weight data for a product.

In an illustrative example, two products appearing in the product database and in the planogram have a weight within three grams on either side of the event weight, and the weight event is a removal from the shelf. Associated with the first of the two product is a history of being 10 grams heavy 20 percent of the time and 5 grams heavy 30 percent of the time. The rest of the time, the product weight is within 2 grams either way of the baseline weight (e.g., the nominal, mean or median weight, or the ‘listed’ weight in the product database). Associated with the second of the two products is a history of being 10 grams heavy 5 percent of the time and within 3 grams either way of the baseline weight the remainder of the time. A probability distribution function derived using a machine learning algorithm applied to the respective historical weight data (a simplified version of which is presented in the foregoing example) for each of the two products assigns a higher probability to the second product. Nonetheless, both products are identified in candidate sets of weight-event parameters. The skilled artisan will appreciate that the machine learning algorithm selected for deriving probability distribution functions for product weights and calculating probabilities therefrom can be any of those known in the art and suited to the historical product-weight data, such as, for example and non-exhaustively: Linear Regression, Logistic Regression, Decision Tree, SVM, Naive Bayes, kNN, K-Means and Random Forest.

The skilled artisan will appreciate that any of the factors involved in the foregoing examples of assigning probabilities can be combined in any way, along with other intrinsic and extrinsic factors that can affect the assigning of probabilities.

Step S02-4: assigning an event likeliness score to each candidate set identified in Step S02-3. The foregoing discussion with respect to Step S02-3 included assigning probabilities to candidate sets of weight-event parameters, the assigning of an event likeliness score takes other factors into account as well, in addition to the probabilities assigned in Step S02-3. The ‘other factors’ can include the uncertainties discussed earlier including factors related to the weight measurement data, to noise and drift, to the uncertainty in mapping the weight distribution on the shelf, and so on. Thus, a final event likeliness score is assigned to each candidate set of weight-event parameters, so as to account for all of the uncertainty introduced in the various steps of the method.

Step S02-5: selecting the set of candidate weight-event parameters having the highest event likeliness score assigned in Step S02-4. The result of the ‘selecting’ in the last sub-step of Step S02 is therefore the result of the ‘determining’.

Step S03: recording or displaying information about the results of the selection of Step S02-5. The results of the selecting (i.e., of the determining) can be recorded, for example in the non-transient computer-readable storage medium 68, or in a similar storage medium in another location, for example in the ‘cloud’, where the results are transmitted via an internet connection. The results, alternatively or additionally, can be displayed on a display device, such as display device 62 or on another display device, which, for purposes of illustration, can be one intended to convey information to a customer of an unattended retail arrangement, or the screen of an inventory clerk in a storage warehouse.

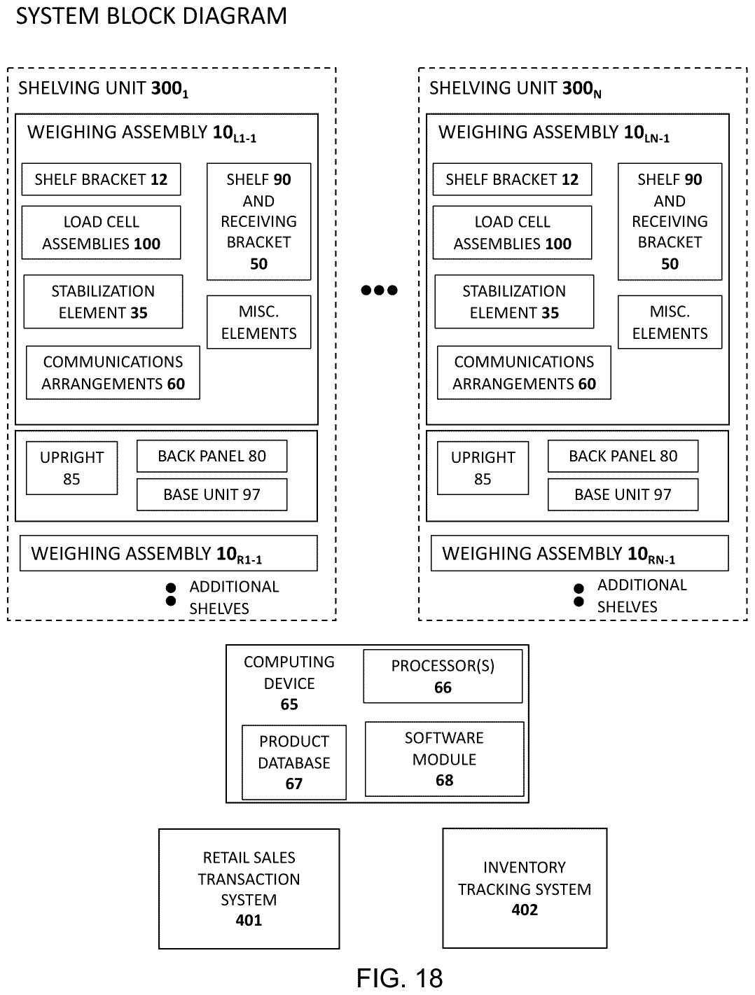

Any of the steps of the method can be carried out by the one or more computer processors 66. In some embodiments, not all of the steps of the method are necessarily carried out. In some embodiments, a system, e.g., the system shown in FIG. 18, can be for tracking non-homogeneous products on a shelf and can comprise a plurality of weighing assemblies 10, one or more computer processors 66, and a computer-readable storage medium 68 containing program instructions 50 which, when executed by the one or more processors 66, can cause the one or more processors 66 to carry out the steps of the foregoing method.

Additional methods for tracking and disambiguating non-homogeneous products are disclosed in co-pending International Patent Application PCT/IB2019/055488, filed on Jun. 28, 2019, and published as WO/2020/003221 on Jan. 2, 2020, which is hereby incorporated by reference for all purposes as if fully set forth herein.

In some embodiments, non-weighing sensors such as, for example, optical sensors or barcode readers, can be used in conjunction with any of the weighing sensors, weighing assemblies and shelf arrangements disclosed herein. Such sensors can be expensive and/or unreliable and/or difficult to maintain or suffer from other disadvantages, and therefore in other embodiments, exclusively weighing sensors are used for disambiguating non-homogeneous products. In such ‘weighing-only’ embodiments, systems for tracking products on a shelf, or systems for unattended retail sales transactions and/or tracking inventory are devoid of other such sensors, i.e., optical sensors, barcode readers, or manual input devices and the like for identifying specific products or SKU's. In some such embodiments in which solely weighing sensors are used in tracking and disambiguation, environmental sensors such as temperature sensors and noise-detecting sensors may be used in the analysis of streams of weight data points received from weighing assemblies but not directly in the disambiguation of non-homogeneous products. Thus, it can be the that a system or method as disclosed herein uses only weight-related information, or is devoid of non-weighing sensors or of optical sensors, or that the methodology of product identification is independent of optical information (e.g., from such optical sensors), and this does not preclude the use of environmental sensors in analyzing (including, optionally, modifying) streams of data points received from weighing assemblies.

FIG. 18 includes a block diagram showing details of a system for executing unattended retail sales transactions and/or tracking inventory of products, using any of the embodiments of weighing assemblies (e.g., weighing assemblies 10) and shelving arrangements disclosed herein. Such a system includes one or more shelving units 300₁ . . . 300_{N}, each of which can include any of the weighing assembly features shown. Each shelving unit include a number of shelves 90, each supported by a left-and-right pair of weighing assemblies 10 including shelf brackets 12. Each pair of weighing assemblies 10 includes a weighing assembly 10 for supporting a different end of the shelf 90. As an example, weighing assemblies 10_{L1-1} and 10_{R1-1} are respective left and right assemblies for supporting a first shelf 90₁₋₁ in first shelving unit 300₁. Each of the load cell assemblies 100 installed in the system can communicate weight information with computing device 65. Once computing device 65 determines that a product has been added to or removed from a shelf, and further determines which specific product has been added to or removed from a shelf (as discussed earlier in connection with FIG. 16), then the information can be forwarded to a retail sales transaction system 401 and or an inventory tracking system 402.

It will be appreciated by those of skill in the art that not all of the elements in the block diagram in FIG. 18 need be present in order to practice the invention.

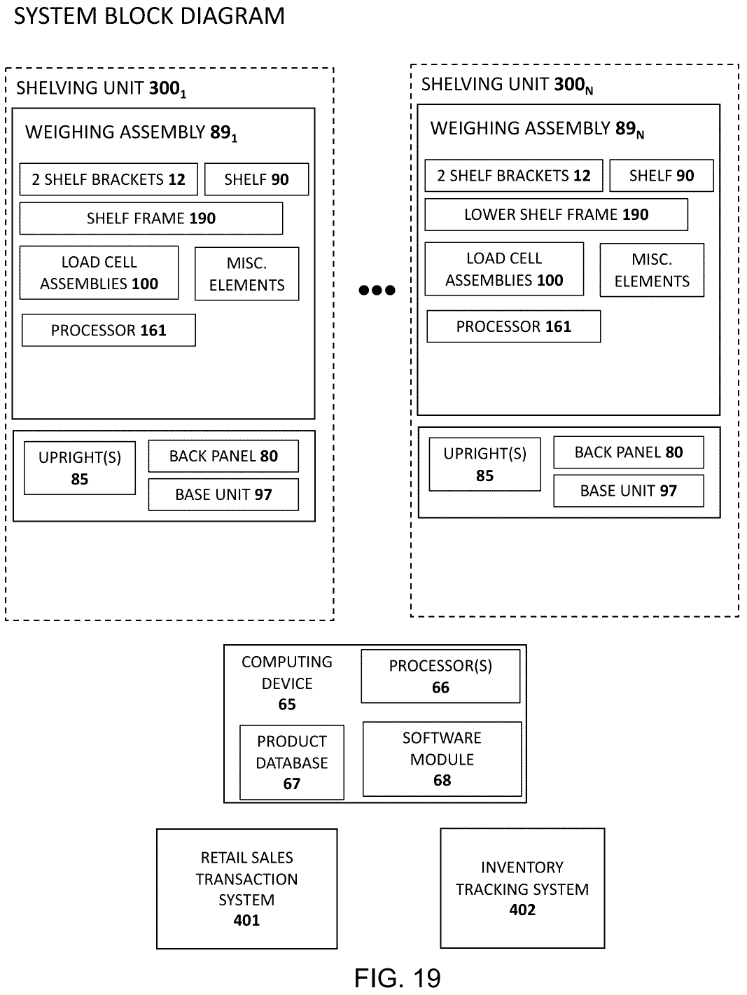

FIG. 19 includes a block diagram showing details of a system for executing unattended retail sales transactions and/or tracking inventory of products, using weighing assemblies 89 and shelving arrangements disclosed in the discussion of FIGS. 15A and 15B. Such a system includes one or more shelving units 300₁ . . . 300_{N}, each of which can include any of the weighing assembly features shown. Each shelving unit include a number of weighing assemblies 89. Each weighing assembly 89 includes shelf brackets 12_{L} and 12_{R}; shelf 90, shelf frame 190, load cell assemblies 100, processor 161 and miscellaneous elements for assembly, internal stabilization and the like. Each of the load cell assemblies 100 installed in the system can communicate weight information with computing device 65. Once computing device 65 determines that a product has been added to or removed from a shelf, and further determines which specific product has been added to or removed from a shelf (as discussed earlier in connection with FIG. 16), then the information can be forwarded to a retail sales transaction system 401 and or an inventory tracking system 402.

It will be appreciated by those of skill in the art that not all of the elements in the block diagram in FIG. 19 need be present in order to practice the invention.

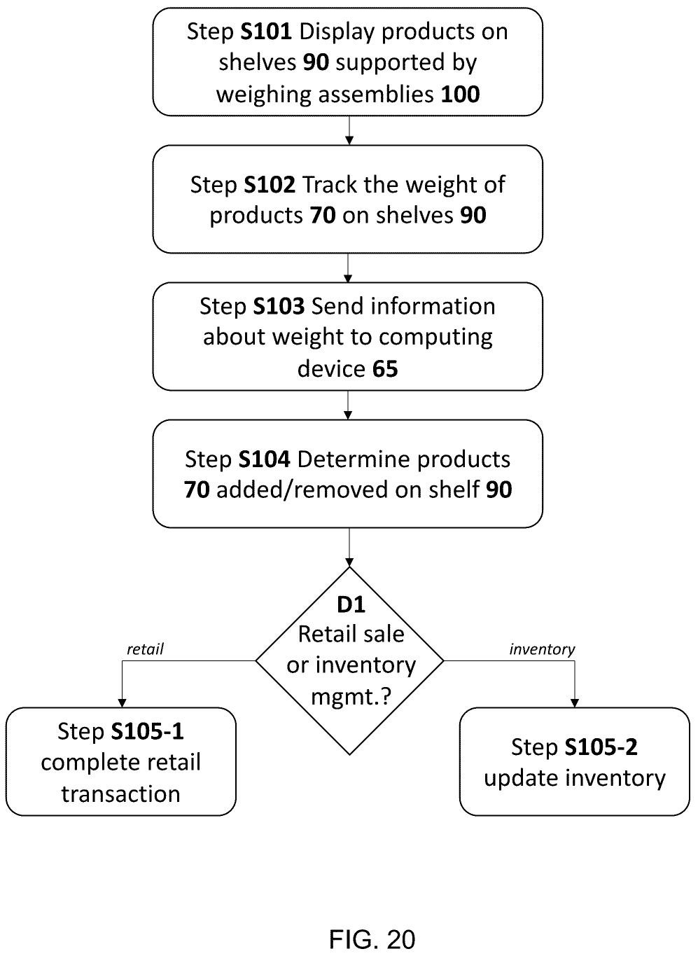

Referring now to FIG. 20, a method is disclosed for executing unattended retail sales transactions and/or tracking inventory of products, using any of the embodiments of weighing assemblies and shelving arrangements disclosed herein. According to embodiments, the method includes:

Step S101 displaying products on shelves 90 which are supported by weighing assemblies 100 according to any of the embodiment disclosed herein. Products need not be homogeneous, as in later step S104 a determination will be made as to which products are added and or removed on a shelf.

Step S102 tracking the weight of products 70 on shelves 90, using the load cell assemblies 100 installed in the weighing assemblies supporting each shelf.

Step S103 sending information about the weight of products to the computing device 65. As described earlier in connection with FIGS. 15 and 16, this includes communication of information about weight indications from the processors of the load cell assemblies 100 by means of a communications channel 61.

Step S104 determining which products 70 were added to or removed from a shelf 90, as discussed earlier in connection with FIG. 16.

Decision Step D1 as to whether the information is to be used in a retail sale transaction or for inventory management, or for both. The result of the decision is of course known and included in the computer code of the system.

Step S105-1 complete retail transaction if that is a result of Decision Step D1.

Step S105-2 update an inventory entry if that is a result of Decision Step D1.

It will be appreciated by those of skill in the art that not all of the steps of the method need be carried out in order to practice the invention.

### FURTHER EMBODIMENTS

In accordance with embodiments of the invention, weighing-enabled shelving arrangements with autonomous weighing capabilities are disclosed. Weighing-enabled shelving arrangements can be useful for enabling unattended retail transactions where the weight of a product removed from a shelf can be automatically recorded and subsequently used in charging a customer for the product. Typically, the shelving arrangement is connected to a computing device with a tracking module for tracking the weight of all products on a given shelf. The tracking module can respond to a change in weight on the shelf (or of the shelf plus the products stored thereupon) by, for example, sending information to a retail module that charges the customer for products taken. The tracking module can respond to a change in weight on the shelf by, for example, updating an inventory record. The computing device can also include a database of products and respective weights, so that the particular product removed from the shelf can be identified, for example, by stock-keeping unit (SKU) number. Where the term “SKU” is used, any suitable unique identifier of a product as employed in an inventory management system or retail sales system can be used. The database can include or be linked to a statistical analysis of weights for any given product. The tracking module can also be linked to a retail module and/or an inventory module which process the information from the tracking module and complete a retail sales transaction and/or record a change in inventory, respectively. As used herein, the term “SKU” means stock-keeping unit. The use of SKU-identifiers is a standard means of identifying unique products across industries. Unique products can be, for example, products defined by unique combinations of physical characteristics, e.g., weight (whether nominal or average), volume, dimensions, etc. and/or non-physical characteristics, e.g., brand or packaging design. It can be that two products can be similar in physical characteristics but have different SKU-identifiers; in some embodiments they can be considered as ‘non-homogeneous’ and in other embodiments they may not. However, any use of the term ‘products’ in this disclosure or in the claims attached thereto includes the concept of ‘non-homogeneous products’. In an example, a particular brand of cookies may offer products with a number of different SKU-identifiers: a first SKU for the brand's large package of large chocolate cookies, a second SKU for the brand's small package of the same large chocolate cookies, and a third SKU for the brand's large package of small chocolate cookies, and so on. The term “non-homogeneous”, as applied herein to a group of products, means that the products in the group do not all share the same SKU-identifier, but should not be understood to imply that each product in a group has a unique SKU-identifier. For example, a group of non-homogeneous products might include: (a) 10 large packages of large chocolate cookies bearing a first brand and having a first SKU-identifier, and (b) 2 large packages of small chocolate cookies from a second brand and having a second SKU-identifier, or, without limitation any combination of products having, in combination, two or more SKU-identifiers. A group of products having, in combination, two or more SKU-identifiers can be considered ‘non-homogeneous’ with respect to one another.

### Shelving Unit Embodiments

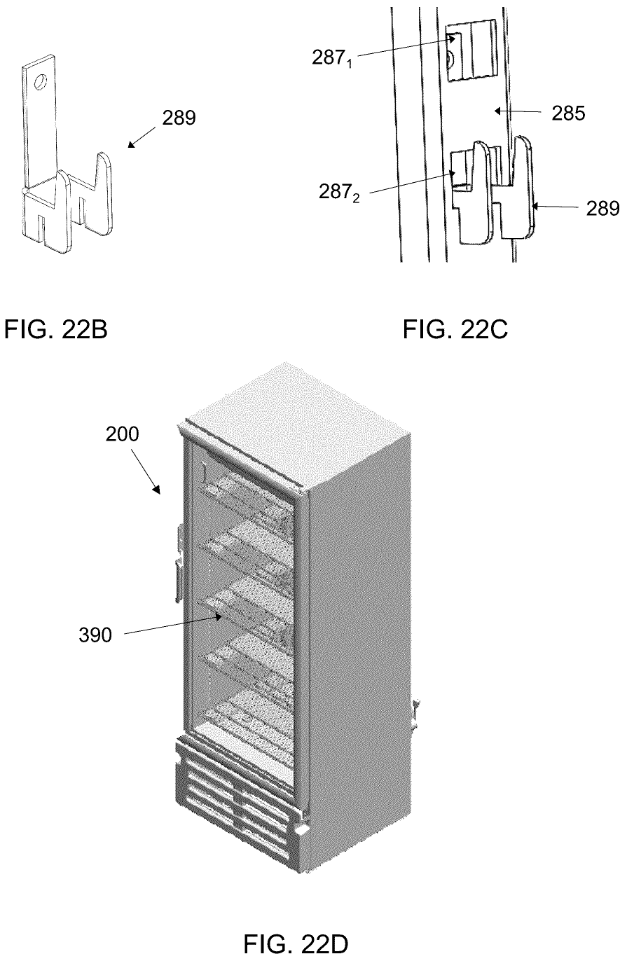

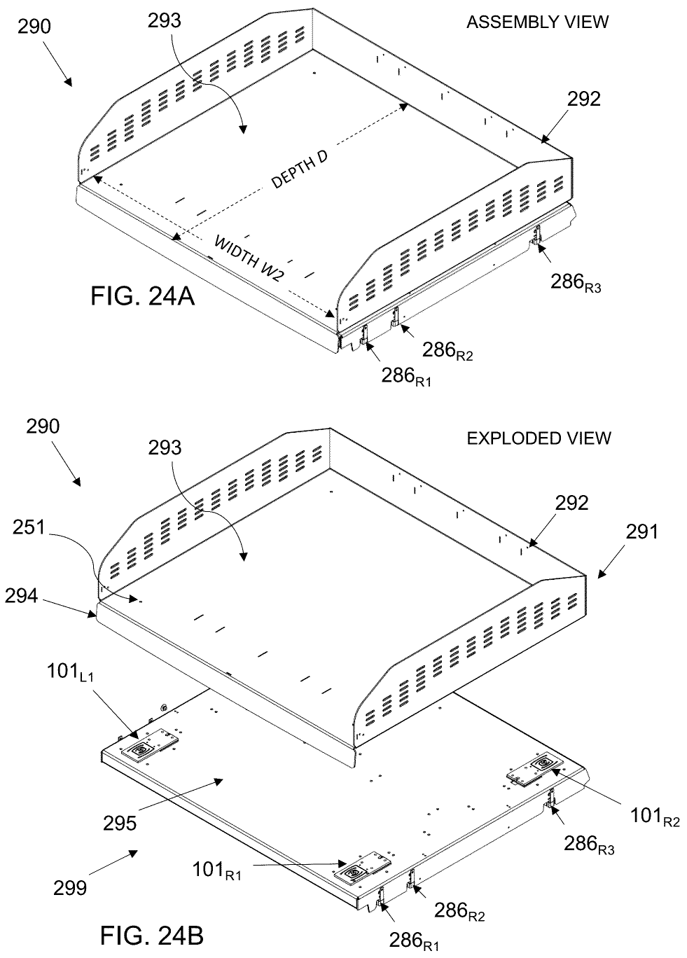

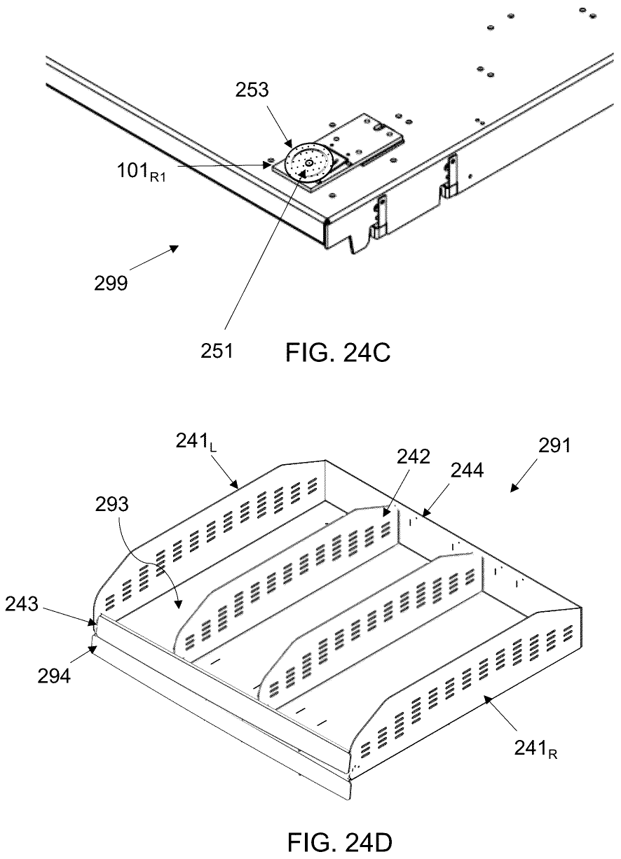

A weighing-enabled shelving arrangement can be a standalone unit adapted for retail sales transactions. In a non-limiting example shown in FIG. 22A, a weighing-enabled standalone shelving unit 200 includes a shelving volume 210 defined by shelving housing 205, the shelving volume 210 enclosed by left and right walls 281_{L} and 281_{R}, and back wall 280. In some embodiments any one or more of left and right walls 281_{L} and 281_{R}, and back wall 280 can be a partial wall. Note: the weighing capabilities and weighing-relevant components of shelf assemblies 290 are discussed below in connection with FIG. 24B. A door 220 can be provided on or near the front boundary of the shelving unit 200 (front being the direction open for access to a shelving volume 210 enclosed on three sides), the door being operative in some embodiments to preserve the interior temperature of the shelving unit 200 in the case that it is a refrigerated unit, and in some embodiments being operative for any one or more of improving hygiene, limiting entry of dust and dirt, limiting customer interaction with the products while choosing, and having a locking mechanism so as to control access to the products within the shelving unit for commercial reasons: As is known in the art, a locking mechanism can be adapted to allow opening of the door upon receipt of an electronic signal, for example from a computer system with a retail module, where the signal is part of the retail sales transaction process, e.g., allowing opening upon swiping of a card or a screen input from a user or cashier. Together with the door 220, a shelving volume 210 can be enclosed on all four sides.

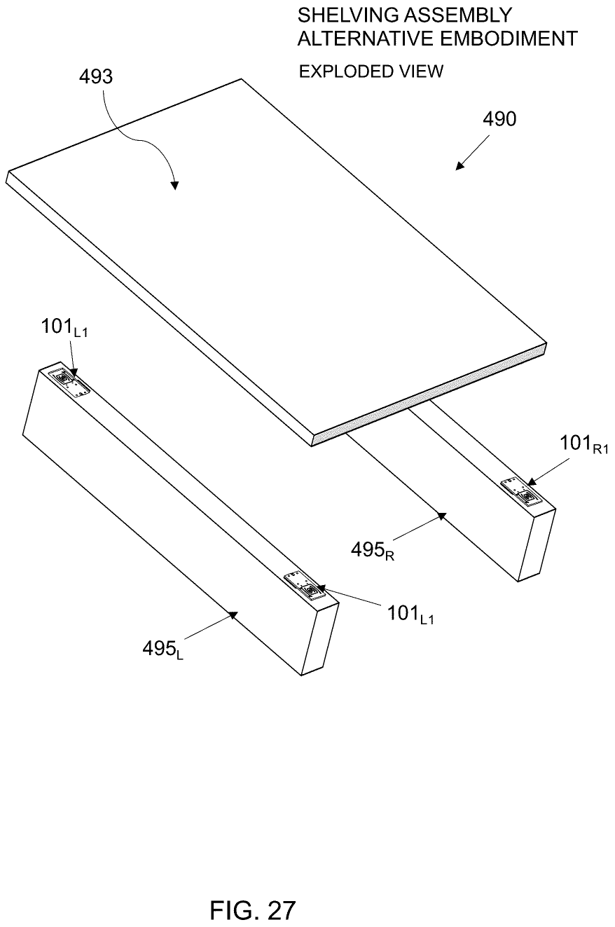

A shelving unit 200 includes at least one shelf assembly 290 (or at least shelf assembly 490 of FIG. 27, as discussed later). In FIG. 22A five shelf assemblies 290 are shown. The number of shelf assemblies 290 in a shelving unit 200 can be as few as one and as many as practicably can fit in the shelving unit while allowing access for shelf-stockers and customers to the products 70 stocked and displayed thereupon. Products can be stocked and displayed homogeneously, i.e., in groups of identical products taking up part or all of a shelf assembly 290, or mixed with non-identical products, as illustrated in FIG. 22A by the display on the two lower shelf assemblies 290 of products 70₁, 70₂, 70₃ and 70₄.

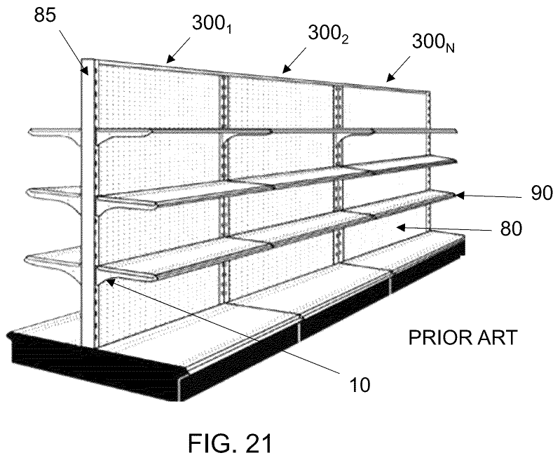

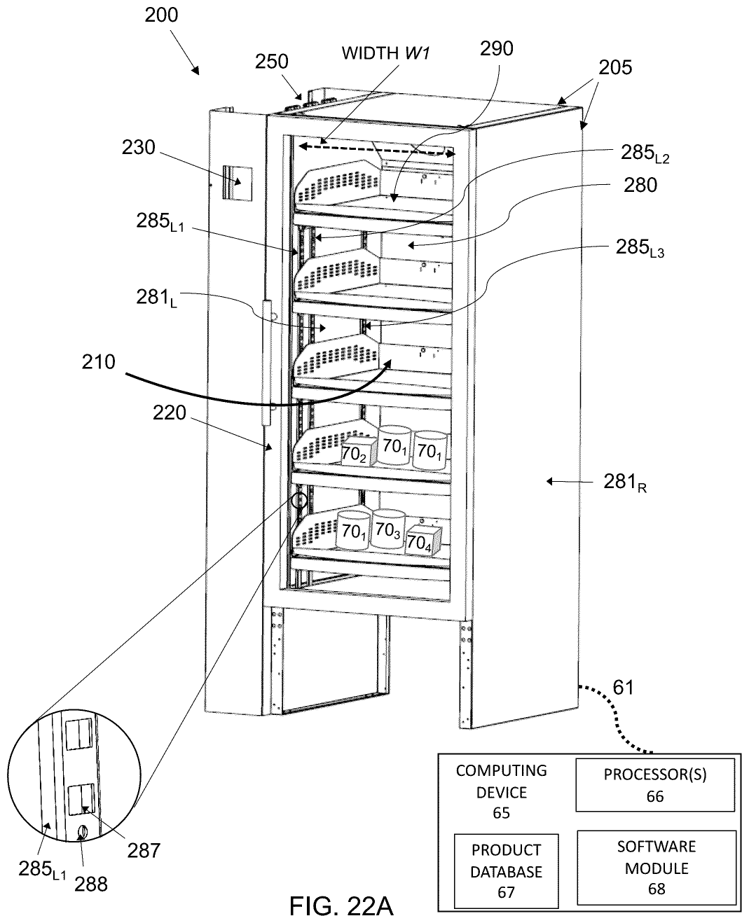

Shelf assemblies 290 are attached to one or two or three of left and right walls 281_{L}, 281_{R} and back wall 280. The shelf assembly 290 can be attached directly to any of the walls and preferably is by employing one or more attachment elements 285 such as, for example, the attachment elements 285_{L1}, 285_{L2}, 285_{L} in FIG. 22A. In some embodiments attachment elements 285 share similarities with uprights 85 used in open shelving bays (e.g., in FIG. 21), in that each comprises a plurality of attachment elements (e.g., recesses or holes) designed for the easy insertion and removal of shelf bracket hooks along a continuous strip, and are different from uprights 85 in that they are fixedly attached to a side wall 281 or back wall 280 of an enclosed shelving unit 200. In other embodiments (not shown) attachment elements 285 can be only as large as necessary for having a single attachment arrangement (e.g., recess, hole, peg, hook, etc.) for use by a single shelf, or can have several such attachment arrangements so as to allow flexibility in the height-placement of shelf assemblies 290, but without having the continuous strip configuration of the attachment arrangements shown in FIG. 22A. The detail inset of FIG. 22A shows a close-up of attachment element 285_{L1} which includes attachment-element-points 287. Attachment-element-points 287 are shown as holes, but in other embodiments they can be, for example, protruding members, recesses, or slots, which mate with corresponding attachments points 286 (FIG. 24B, see additional discussion below). An attachment element 285 can also include fastening arrangements 288 for fastening the attachment element 285 to a wall 281 of the shelving unit 200.

Referring now to FIGS. 22B and 22C, according to an alternative embodiment, an attachment component 289 can be provided for effecting the attachment of a shelf assembly 290 to the attachment element 285. In the non-limiting example of FIG. 22C, attachment component 289 hooks into attachment-element-point 287₂ (the top part of attachment component 289 can also be seen through the ‘window’ of attachment-element-point 287₁). In such an embodiment, the attachment points 286 of shelf assembly 290 mate with attachment components 289 rather than directly with attachment-element-points 287. The skilled artisan will understand that the attachment component 289 of FIGS. 22B and 22C is shown as one non-limiting example of an attachment component, and any component design that achieves the design goal of securing a shelf assembly (or a load base thereof) to an attachment element on a side wall of a shelving unit, and especially such that the securing is reversible and repeatable, can be suitable.

FIG. 22A shows three attachment elements 285_{L1}, 285_{L2}, 285_{L3} on the left wall 281_{L} of the shelving unit 200, and a skilled artisan can easily understand that in such an example there can be three corresponding and similar attachment elements 285_{R1}, 285_{R2}, 285_{R3} on the right wall 281_{R}. However, this presentation of 3 (or, as can be reasonably extrapolated: 6) attachment elements 285 is by way of illustrative example only, and the actual number of attachment elements 285 and their respective placement is merely a design choice where the design goal is providing sufficient support in the right places for each shelf assembly 290 so that shelf assemblies 290 are substantially immobilized in a horizontal position and maximally resistant to rolling or pitching from forces reasonably applied to any of the parts of the shelf assembly 290. Such forces can be generated by, for example, uneven distribution of products, employees or customers leaning on or against a shelf assembly 290 or a child pulling himself up by grasping the front edge of a shelf assembly 290.

In some embodiments, left and right walls 281_{L}, 281_{R} can be partial walls or not be present at all, in which case the lack of a front-edge attachment element on the side wall (e.g., 285_{M} on the front edge of left wall 281_{L}), or even no side wall attachment elements, in which the designer can put in additional structural elements for stabilizing and immobilizing the shelf assemblies 290 without deviating from the spirit of the invention.

As shown in FIG. 22A, shelving unit 200 can include a refrigeration unit 250 for chilling products 70 and keeping them at a desired temperature.

A shelving unit can also include a retail transaction apparatus 230. A retail transaction apparatus 230 can include any combination of credit card reader, cash and coin slots, and a user interface including, for example, a display screen, and be provided for the purpose of enacting payment for products 70 selected and removed from the shelving unit 200. The retail transaction apparatus need not be installed on the shelving unit 200 itself and instead can be a distance away, for example, at a cashier's position. In another example, there can be one retail transaction apparatus for a plurality of shelving units 200.

According to embodiments, a shelf assembly includes a plurality of load cell 100 which track the weight of products on the shelf assemblies 290, as well as changes in the weight, e.g., from the addition of products 70 on the shelf assembly 290 or the removal of products on the shelf assembly 290.

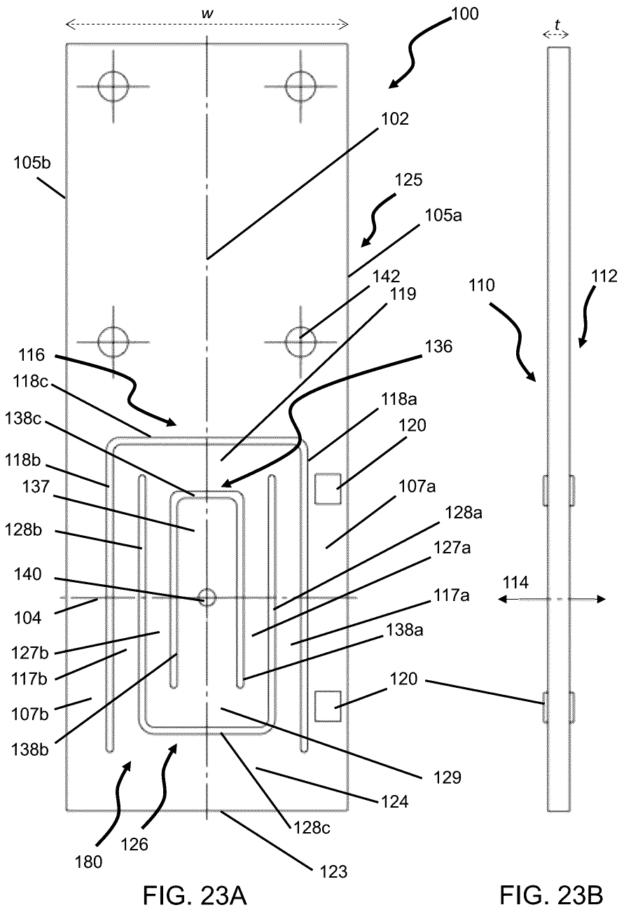

As will be described later in connection with the discussion of FIG. 23A, each load cell assembly 100 can include a processor, which may be configured to receive the load or strain signals from the strain (e.g., from 4 strain gages SG1-SG4) from each particular load cell and to produce a weight indication based on the load signals. Each processor can have a communications arrangement for communicating the weight indication, for example by employing a communications channel 61 which can be a wired connection or a wireless connection (as non-limiting examples: any short-range point-to-point communication system such as IrDA, RFID (Radio Frequency Identification), TransferJet, Wireless USB, DSRC (Dedicated Short Range Communications), or Near Field Communication; or wireless sensor networks such as: ZigBee, EnOcean; Personal area networks, Bluetooth, TransferJet, or Ultra-wideband). Still referring to FIG. 22A, the communications arrangement of a weighing-enabled shelving unit 200 (or of a processor associated with the shelving unit) is of course selected so as to be appropriate to the communications technology chosen for the communications channel 61. The communication of weight indication(s) by load cells 100 via the communications channel 61 can be to a computing device 65 configured to receive information from the weighing assemblies and track the weights of shelf assemblies 290 and of the products 70 displayed thereupon. The computing device 65 can include one or more processors 66 for executing computer code, a software module 67 that includes computer code for execution by the one or more processors 66, and/or a product database 68. Preferably, the computer code includes executable instructions for processing the received information about shelf assembly weights (the weight indications) and determining (a) that a change in weight of a shelf assembly has changed, (b) that a product 70 has been added to or removed from a shelf and (c) which product has been added to or removed from a shelf. Preferably, the computing device 65 receives weight indications from all of the individual load cell assemblies 100 installed in any one specific shelf assembly 290, so that the determinations will be more accurate and more reliable. The determination (a) that a change in weight of a shelf assembly 290 has changed can be made, for example, by tracking the weight of a s shelf assembly 290 over time and comparing one time-based value to another. The determination (b) that a product 70 has been added to or removed from a shelf assembly 290 can be made, for example, by determining that the determined change in the weight of a shelf assembly 290 is substantial enough to be a product movement, i.e., is not below a pre-determined threshold. For example, a child leaving chewing gum on a shelf assembly 290 may register as a change in weight of the shelf assembly 290, but the change can be determined as not being substantial enough to be a product movement. Similarly, the computer code can be configured to exclude ‘false positives’ such as a person leaning on the shelf, or a person leaving an unidentified weight (i.e., not correlating with a known product) on the shelf. The determination (c) which product has been added to or removed from a shelf is made by analyzing the change in weight from the addition or removal, and by looking up product weights in a product database 67 which includes product weights and SKU-identifiers. The product database 67 can optionally include statistical and/or historical information about the distribution of weight for a particular product/SKU-identifier. The determining can optionally include applying the statistical and/or historical information to help in the determining.

FIG. 22D shows an example of a shelving unit 200 configured as a display refrigerator. To ensure adequate internal airflow, shelf assemblies 390 can be provided with open spaces horizontal surfaces so as to be at least partly open for a vertical airflow.

### Discussion of Load Cell Assembly Embodiments

Load cells with low profiles may have a characteristically low amplitude signal. Given limitations in the total weight to be measured, and the inherent sensitivity of load cells, the performance of such devices may be compromised by a high noise-to-signal ratio and by unacceptable settling times. Various embodiments of the present invention resolve, or at least appreciably reduce, parasitic noise issues associated with typical low-profile load cells and enable high accuracy weight measurements.

Loading of a spring arrangement is effected by placing a load on, or below, a loading beam, depending on whether the loading beam is anchored to the weighing platform, or to the weighing base. (Note: the term “weighing base” is used herein interchangeable with the term “load cell base” and no difference in meaning between the two terms should be inferred.) The loading beam may also be referred to as the “loading element” or as the “load-receiving element” or “load-supporting element” (depending on the configuration) of the load cell assembly. The spring arrangement has at least one flexure arrangement having at least two flexures or flexural elements operatively connected in series. The flexure arrangement is operatively connected, at a first end, to the loading beam, and at a second end, to the free or adaptive end of at least one measuring beam.

The flexure arrangement has n flexures (n being an integer) operatively connected in series, the first of these flexures being operatively connected to the loading beam, and the ultimate flexure of the n flexures being operatively connected in series to a second flexure, which in turn, is operatively connected to the first flexure in an assembly of m flexures (m being an integer), operatively connected in series. The ultimate flexure of the m flexures is operatively connected, in series, to a measuring beam of the spring arrangement. Associated with the measuring beam is at least one strain gage, which produces weighing information with respect to the load.

The inventor has discovered that at least two of such flexure arrangements, disposed generally in parallel, may be necessary for the loading element to be suitably disposed substantially in a horizontal position (i.e., perpendicular to the load).

In some embodiments, and particularly when extremely high accuracy is not necessary, a single flexure disposed between the loading beam and the measuring beam may be sufficient. This single flexure load cell arrangement may also exhibit increased crosstalk with other load cell arrangements (weighing assemblies may typically have 4 of such load cell arrangements for a single weighing platform). For a given nominal capacity, the overload capacity may also be compromised with respect to load cell arrangements having a plurality of flexures disposed in series between the load receiving beam and the measuring beam. This reduced overload capacity may be manifested as poorer durability and/or shorter product lifetime, with respect to load cell arrangements having a plurality of flexures disposed in series. Nonetheless, the overall performance of the single-flexure may compare favorably with conventional weighing apparatus and load cell arrangements. In any event, for this case, m+n=−1, which is the lowest value of m+n flexures for the present invention.

Moreover, there may be two or more spring arrangements for each loading element, disposed in parallel. Typically, and as described hereinbelow with respect to FIGS. 23A and 23B, the spring arrangement may include pairs of coupled flexures and coupled measuring beams.

Typically, there are 4 strain gages per loading beam. The strain gages may be configured in a Wheatstone bridge configuration, a configuration that is well known to those of skill in the art. The load cell system may further include a processing unit, such as a central processing unit (CPU). The processing unit may be configured to receive the load or strain signals (e.g., from 4 strain gages SG1-SG4) from each particular load cell and to produce a weight indication based on the load signals, as is known to those of ordinary skill in the art.

Referring collectively to FIGS. 23A and 23B, a load cell body 125 may be made from a block of load cell quality metal or alloy. Particularly advantageous embodiments employing particular magnesium alloys will be described hereinbelow.

Load cell body 125 may be fixed to a weighing assembly 10 via one or more mounting holes or elements 142. A 1^{st} contiguous cutout window 116 passes from a top face 110 through a bottom face 112, perpendicularly through the broad dimension (i.e., with respect to the other 2 dimensions of a three-dimensional Cartesian system) of load cell body 125. 1^{st} contiguous cutout window 116 may be generally C-shaped or U-shaped, and may have arms or a pair of cutout lines 118a, 118b running generally parallel to a central longitudinal axis 102 of load cell body 125, and connected or made contiguous by a cutout line or cutout base 118c. Both central longitudinal axis 102 and a transverse axis 104, disposed transversely thereto, run generally parallel to the broad dimension of load cell body 125. Both of these axes are oriented in perpendicular fashion with respect to a primary axis 114. The thickness (indicated by the arrow marked ‘t’ in FIG. 23B) of load cell body 125 perpendicular to primary axis 114 is typically within a range of 2 mm to 10 mm, and is designated W_{LCB}.

Long sides 105a and 105b of load cell body 125 run generally along, or parallel to, central longitudinal axis 102.

As shown, measuring beams or spring elements 107a and 107b are each disposed between respective cutout lines 118a and 118b, and respective long sides 105a and 105b of load cell body 125, distal to cutout lines 118a and 118b with respect to transverse axis 104. When planar load cell assembly 100 is disposed in a vertically loaded position, the free end of each of beams 107a and 107b may be held in a fixed relationship, substantially perpendicular to the vertical load, by an end block 124 disposed at a free end 123 of load cell body 125.

A 2^{nd} contiguous cutout window 126 also passes from top face 110 through bottom face 112, perpendicularly through the broad dimension of load cell body 125. 2^{nd} contiguous cutout window 126 may be generally C-shaped or U-shaped, and may have arms or a pair of cutout lines 128a, 128b running generally parallel to central longitudinal axis 102, and connected or made contiguous by a cutout line or cutout base 128c. 2^{nd} contiguous cutout window 126 may be enveloped on three sides by 1^{st} contiguous cutout window 116 (such that the 2^{nd} contiguous cutout window is transversely bounded by the 1^{st} contiguous cutout window). The orientation of 2^{nd} contiguous cutout window 126 may be 180° (i.e., generally opposite) with respect to 1^{st} contiguous cutout window 116.

A 3^{rd} contiguous cutout window 136 also passes from top face 110 through bottom face 112, perpendicularly through the broad dimension of load cell body 125. 3^{rd} contiguous cutout window 136 may be generally C-shaped or U-shaped, and may have arms or a pair of cutout lines 138a, 138b running generally parallel to central longitudinal axis 102, and connected or made contiguous by a cutout line or cutout base 138c. 3^{rd} contiguous cutout window 136 may be enveloped on three sides by 2^{nd} contiguous cutout window 126 (such that the 3^{rd} contiguous cutout window is transversely bounded by the 2^{nd} contiguous cutout window). The orientation of 3^{rd} contiguous cutout window 136 may be 180° (i.e., generally opposite) with respect to 2^{nd} contiguous cutout window 126 (and generally aligned with 1^{st} contiguous cutout window 116).

Load cell body 125 has a first flexure arrangement having a first pair of flexure beams 117a, 117b disposed along opposite sides of central longitudinal axis 102, and distal and generally parallel thereto. First pair of flexure beams 117a, 117b may be longitudinally disposed between the first pair of cutout lines and the second pair of cutout lines, and mechanically connected or coupled by a first flexure base 119.

Load cell body 125 has a second flexure arrangement having a second pair of flexure beams 127a, 127b disposed along opposite sides of central longitudinal axis 102, and distal and parallel thereto. Second pair of flexure beams 127a, 127b may be longitudinally disposed between the first pair of cutout lines and the second pair of cutout lines, and mechanically connected or coupled by a second flexure base 129.

Contiguous cutout window 136 defines a loading element 137 disposed therein. Loading element 137 is longitudinally defined by 3^{rd} pair of cutout lines 138a and 138b, and is connected to, and extends from, second flexure base 129.

The various cutout lines described above may typically have a width (W_{CO}) of 0.2 mm to 5 mm, and more typically, 0.2 mm to 2.5 mm, 0.2 mm to 2.0 mm, 0.2 mm to 1.5 mm, 0.2 mm to 1.0 mm, 0.2 mm to 0.7 mm, 0.2 mm to 0.5 mm, 0.3 mm to 5 mm, 0.3 mm to 2.5 mm, 0.3 mm to 2.0 mm, 0.3 mm to 1.5 mm, 0.3 mm to 1.0 mm, 0.3 mm to 0.7 mm, 0.3 mm to 0.6 mm, or 0.3 mm to 0.5 mm.

In some embodiments, the ratio of W_{CO} to W_{LCB} (W_{CO}/W_{LCB}) is at most 0.5, at most 0.4, at most 0.3, at most 0.25, at most 0.2, at most 0.15, at most 0.12, at most 0.10, at most 0.08, at most 0.06, or at most 0.05.

In some embodiments, the ratio of W_{CO} to W_{LCB} (W_{CO}/W_{LCB}) is within a range of 0.03 to 0.5, 0.03 to 0.4, 0.03 to 0.3, 0.03 to 0.2, 0.03 to 0.15, 0.03 to 0.10, 0.04 to 0.5, 0.04 to 0.4, 0.04 to 0.3, 0.04 to 0.2, 0.04 to 0.15, 0.04 to 0.10, 0.05 to 0.5, 0.05 to 0.4, 0.05 to 0.3, 0.05 to 0.2, 0.05 to 0.15, or 0.05 to 0.10. Loading element 137 may also include a hole 140, which may be a threaded hole, for receiving a load, e.g., for receiving or connecting to an upper, weighing platform, or for supporting a load, e.g., connecting to a base, leg, or support (disposed below load cell body 125) of a weighing system. Load-receiving hole 140 may be positioned at an intersection of central longitudinal axis 102 and transverse axis 104.

In the exemplary embodiment provided in FIGS. 23A and 23B, first and second flexure arrangements form a flexure arrangement 180, mechanically disposed between loading element 137 and measuring beams or spring elements 107a and 107b.

At least one strain gage, such as strain (or “strain-sensing”) gages 120, may be fixedly attached to a surface (typically a top or bottom surface) of each of measuring beams 107a and 107b. Strain gages 120 may be adapted and positioned to measure the strains caused by a force applied to the top of the “free” or “adaptive” side 123 of load cell body 125. When a vertical load acts on free end 123 (i.e., an end unsupported by the base) of load cell body 125, load cell body 125 undergoes a slight deflection or distortion, with the bending beams assuming a double-bending configuration having an at least partial, and typically primarily or substantially, double-bending behavior. The distortion is measurably sensed by strain gages 120.

It may thus be seen that in the illustrated examples discussed above, load cell assembly 100 is a particular case of a planar load cell assembly, having the load beam and spring arrangement of FIG. 23A. In this case, the number of intermediate flexures is 2, such that m and n both equal zero. In addition, the intermediate flexures are intermediate flexure beam pairs connected by a flexure base. Similarly, the measuring beams are connected at a first end by the fixed end of load cell body 125, and at the opposite end by adaptive end 124 of load cell body 125.

A load cell body 125 may be made from a block of load cell quality metal or alloy. For example, load cell quality aluminum is one conventional and suitable material. In some embodiments, the alloy may advantageously be a magnesium alloy, typically containing at least 85%, at least 90%, and in some cases, at least 92%, at least 95%, or at least 98% magnesium, by weight or by volume. The magnesium alloy should preferably be selected to have an elastic module (E) that is lower, and preferably, significantly lower, than that of aluminum.

In some embodiments, it can be desirable to employ a planar load cell assembly as disclosed herein with a ‘high’ ratio of width to thickness, where ‘width’ is the dimension across a plan view of the planar load cell assembly, for example the dimension indicated by the arrow marked with w in FIG. 23A, and thickness is the dimension across a side view, for example the dimension indicated by the arrow marked with t in FIG. 23B. Although the figures attached herewith are not necessarily drawn to scale, the exemplary load cell assembly of FIGS. 23A and 23B can be seen to have a width-to-thickness ratio of more than 10. In some embodiments, the ‘high’ width-to-thickness ratio can be more than 2, more than 3, more than 5, or more than 10. In other embodiments, any type of load cell can be used.

It should be noted that with respect to embodiments disclosed herein in which it is indicated that a load cell assembly is anchored so as to be attached at least indirectly to a load cell base (which in an assembled configuration is below the load cell assembly), such an arrangement represents a non-limiting example cited for convenience, and in any such embodiment a load cell assembly can alternatively be anchored so as to be attached to a shelf or shelf tray (which in an assembly configuration is above the load cell assembly). These two structural options can provide the same functionality of providing shelf assemblies and shelving units with built-in weighing capabilities.

### Shelf Assembly Embodiments

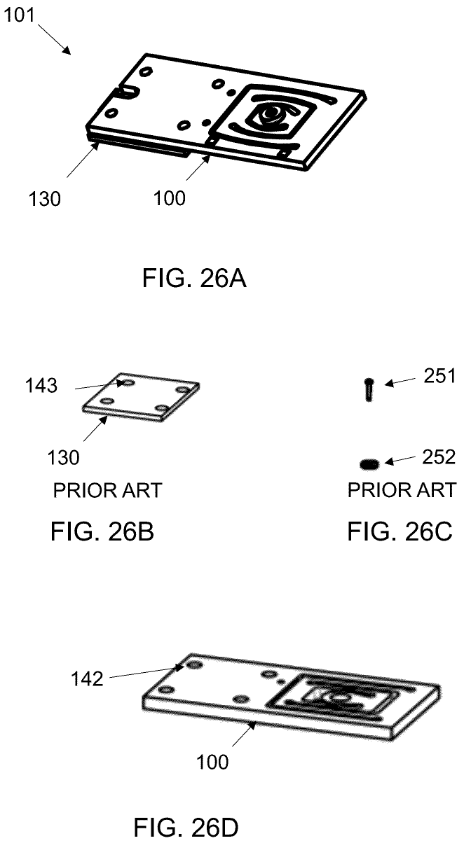

Referring now to FIGS. 24A and 24B, an example of a shelf assembly 290 according to an embodiment is shown in both assembled and exploded views. A shelf assembly 290 comprises a weighing base 299 and a shelf or shelf tray 291. The weighing base 299 can comprise a shelf base 295 and a plurality of load cell installation assemblies 101. In this example four load cell installation assemblies 101_{L1}, 101_{L2} (not shown, blocked by shelf tray 291), 101_{R1}, 101_{R2} are provided, but a higher or lower number of load cell installation assemblies can be provided while meeting the design goal of providing accurate weight indications of products 70 on a shelf assembly 290 or added thereto or removed therefrom. As shown in FIG. 26A, a load cell installation assembly comprises a planar load cells 100 and a shim (adapter plate) 130. Mounting holes 142 (FIG. 6D) are provided in load cell assembly 100, which line up with similarly-spaced shim holes 143 (FIG. 6B). Thus, load cell assemblies 100 can be attached (by screw or rivet or any other appropriate attaching method) to a respective shim 130, and, in this way, complete the installation of the load cell installation assemblies on the weighing base 299.

Referring again to FIGS. 24A and 24B, the shelf tray 291 can include a receiving bracket (not shown) for securing and stabilizing a shelf tray 291 on a weighing base 299. In some embodiments a shelf tray 291 can be attached in other ways to a weighing bracket 299. A plurality of prior-art protruding elements 251 (FIG. 6C) and a plurality of joining elements 252 (also FIG. 26C) vertically aligned with respective protruding elements 251 for receiving the respective protruding elements 251 can be provided for transferring load to the load cell assemblies 100. It should be noted that the number of respective protruding elements 251 and joining elements 252 will be the same as the number of load cell assemblies 100 for any given shelf assembly 290. For, example, in the non-limiting example shown in FIG. 24B, the number of load cell assemblies 100 (of load cell installation assemblies 101) is four, and thus four respective protruding elements 251 and four joining elements 252 are used.

As mentioned in the preceding paragraph, the protruding elements 251 together with the joining elements 252, can function to transfer load (the weight of the shelf tray 291 and of products 70 displayed thereupon) to the load cell assemblies 100. In some embodiments the protruding elements 251 can transfer the load directly by having a lower end positioned in a receptacle in the load cell assembly 100, and in other embodiments the protruding elements function to ensure the positioning of the joining elements 252 around the holes 140 (in FIG. 23A) on the load cell assemblies 100 so as to transfer the load to the load cell assemblies 100 via the joining elements 252. They can also function to inhibit movement of the aforementioned receiving bracket (not shown) or of the shelf tray 291 in the horizontal plane, for example by being installed in or through the holes 140 in respective load cell assemblies 100. In some embodiments, protruding elements 251 and joining elements 252 can be threaded (e.g., a threaded bolt and respective nut) and in other embodiments they can be unthreaded (e.g., a simple bolt and respective washer). In some embodiments both a threaded nut and a washer may be provided. A protruding element 251 can be deployed in any one of a number of approaches. For example, a protruding element 251 can be disposed on a receiving bracket. As another example, a protruding element 251 can be disposed on joining element 252. As yet another example, a protruding element 251 can be disposed on the shelf tray 291 (preferably flush with the upper surface of the shelf tray 251), the respective joining element 252 holding it in its place on the shelf tray 291. In another example, illustrated in FIG. 24C, a weight distributor 253 in the form of a button or disk can be provided to transfer load (the weight of the shelf tray 291 and of products 70 displayed thereupon) to joining element 251. In FIG. 24C, at least a circumferential rim (or, in other examples, the entire upper surface) of weight distributor 253 is raised higher than joining element 251 above the face of the load cell installation assembly 101 so that the weight distributor 253 is in contact with the shelf tray 291 when in an assembled state. In some embodiments, weight distributor 253 acts as a spacer to ensure that the height of joining element 251 above the face of the load cell installation assembly 101 stays substantially constant during the life of the shelf assembly 290.

It should be noted that use of the term ‘shelf tray’ should not be taken to literally mean a tray, e.g., as illustrated in the non-limiting example of FIGS. 24A and 24B wherein shelf tray 291 includes tray rim 292. Front flange 294 of shelf tray 291 is optional and has both aesthetic and functional purposes, e.g., obscuring the shelf base 295, the load cell installation assemblies 101 and the miscellaneous elements that might be provided for attachments. In other embodiments, shelf tray 291 can be flat without a tray rim 292, and if additional structural support is necessary for the shelf tray 291, e.g., to resist twisting or bending, it is possible to apply other engineering solutions for strengthening the structure.

The tray rim 292 of FIGS. 24A and 24B can include one or more of: side walls 241_{L} and 241_{R}, and rear wall 244. These rim walls can be provided, for example, with respective spacing, height and even thickness so as to inhibit the leaning of products 70 against a side wall 281 and/or back wall 280 of shelving unit 200, which would tend to transfer a part of the load of a product weight from the shelf tray 291 directly to the shelving unit 200 i.e., not via the load cell installation assemblies 101. For example, a side wall 241 can be provided with a gap of at least 3 mm or at least 5 mm or at least 10 mm between it and the side wall 281 of the shelving unit 200. According to the example, the height of the side wall 241 can be at least 5 cm or at least 8 cm or at least 10 cm, or alternatively at least 20% or at least 40% or at least 50% of the height of products 70 such as, for example, soft drink bottles, stocked nearby on the shelf. The side wall 241, including, for example, corrugation or ribs (not shown), can have, in such an example, a thickness of at least 3 mm or at least 4 mm or at least 5 mm. The skilled artisan will quickly grasp that the proper combination of spacing, height and thickness, including as a function of specific products or types of products will greatly reduce the likelihood that any products 70 lean against a side wall 281 of shelving unit 200. Similarly, front wall 243 can be provided to reduce the likelihood that a product 70 leans against door 220 of the shelving unit 200. In addition, one or more vertical dividing walls 242 can be provided to inhibit products 70 from leaning against each other, to avoid false readings of e.g., weight being removed from a shelf.

Referring once again to FIGS. 24A and 24B, a shelf assembly 290 can comprise attachment arrangements or points 286 which mate with attachment elements 285 of side walls 281 and/or back wall 280 of shelving unit 200. If attachment elements 285 comprise holes or recesses, then attachment points 286 can comprise protruding members such as hooks or knobs or similar, and vice versa—if attachment elements 285 comprise protruding members such as hooks or knobs, then attachment points 286 can comprise corresponding recesses or holes. Shelf assembly 290 preferably extends from left wall 281_{L} to right wall 281_{R} such that attachment points on the two sides can mate with attachment elements 285 or attachment components 289 that are joined to the attachment elements 285. In some embodiments, shelf assembly 290 has a width that is at least 80% or at least 90% or at least 95% of the distance between left wall 281_{L} and right wall 281_{R}. According to embodiments, there is only a single shelf assembly 290 at any given height in shelving unit 220.

FIG. 4A indicates a depth D of a shelf assembly 290. To help ensure shelving stability, inter alia, it can be advantageous to ensure that there are attachment arrangements or points 286 in the 50% of depth D nearest the front of a shelf assembly 290, or in the 30% or 25% or 20% or 15% or 10% or 5% of depth D nearest the front of a shelf assembly.

FIG. 24A also indicates a width W2 of a shelf assembly 290. Referring back to FIG. 22A, width W1 is an interior width of a shelving unit 200. It may be desirable to provide a shelf assembly, or a plurality of shelf assemblies, that efficiently exploit the interior volume of a shelving unit. Thus, width W2 is at least half of width W1, meaning that there can only be one shelving assembly 200 at any given height of a shelving unit 200. In embodiments, the ratio of W1 to W2 can be greater than 60%, greater than 70%, greater than 80%, greater than 90%, greater than 95% or greater than 99%

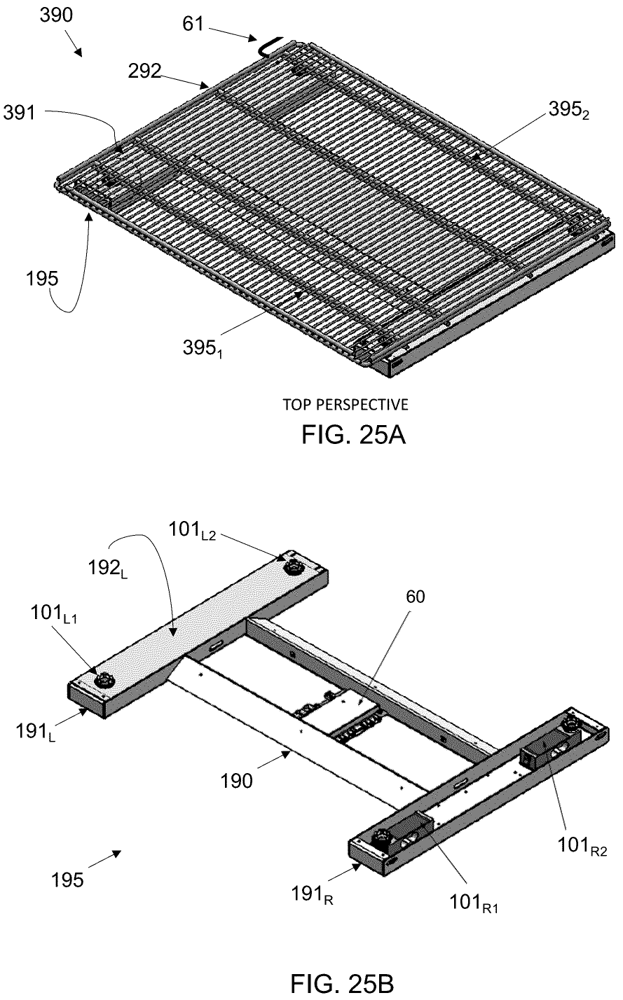

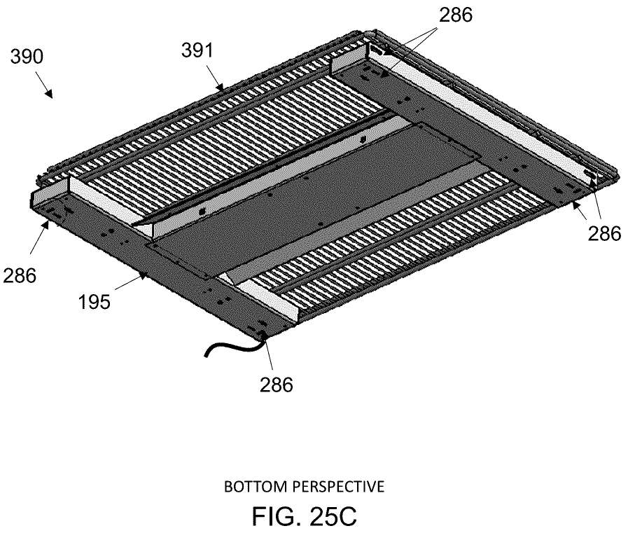

We now refer to FIGS. 25A-C.

A shelf assembly 390 for a refrigerator such as, for example, shelving unit 200 of FIG. 22D, includes a weighing base 195 and a shelf 391. As was described earlier, the shelf 391 can include a peripheral rim 292 to reduce the likelihood that a product leans against the internal wall of the refrigerator 200, which would reduce the force measurable on the shelf 391. Weighing base 195 includes opposing load-cell bases 191_{L}, 191_{R} detachedly attachable to respective left and right internal walls of the refrigerator, e.g., according to the attachment options discussed hereinabove with respect to FIGS. 22A-C. As shown in FIG. 25C, the bottom of the weighing base 195 (and therefore the bottom of the shelf assembly 390) includes attachment arrangements 286. Each of the load-cell bases 191 includes a plurality of load cells 101 (of any type, not necessarily planar load cells). Thus, there are at least two load cells 101 on each side, or at least 4 load cells for each weighing base 195. The two load-cell bases 191 are joined to form a rigid, e.g., stable, resistant to twisting, and/or not flexible, frame. A single-member beam 190 is shown as joining the two load-cell bases 191 but any appropriate design and number of left-to-right beams can be used. The beam can be used to support electronic communication arrangements 60, for example transmitted via a communications channel 61, as shown in FIG. 25B. In some embodiments, the load-cell bases 191 and/or the beam are covered with covers 192. It can be desirable for the weighing base 195 to allow at least a minimum amount of vertical airflow to flow freely within the interior of the refrigerator/shelving unit 200, and for this purpose a portion of the horizontal surface of the weighing base 195 can be ‘open’ to a vertical airflow, the term ‘vertical’ meaning any airflow within the refrigerator, which in many implementations is vertical or predominantly vertical, e.g., within ±100 of vertical, or within ±20° of vertical, or within ±30° of vertical, or within ±40° of vertical, or within ±450 of vertical. Preferably, at least 25% of the horizontal surface area of the weighing base 195 to vertical airflow, or at least 30%, or at least 35%, or at least 40%, or at least 45%, or at least 50%. In some embodiments, as much as 80% or as much as 70% or as much as 60% of the horizontal surface area of the weighing base 195 can be open to vertical airflow.

The horizontal area of the shelf 391 is also at least partly open to vertical airflow. In embodiments, the horizontal surface area of the shelf 391 can be at least 40% open or at least 50% open or at least 60% open or at least 70% open or at least 80% open or at least 90% open. In embodiments, the shelf 391 can utilize a wire grid design. A wire grid design is mostly open, and airflow passing through the open horizontal areas of the weighing base 195 is not be substantially blocked by the wires of the grid, which generally create minor turbulence as the air passes therethrough without a substantial pressure drop. In some embodiments, a wire-grid shelf can include both thinner wires, e.g., front-to-back wires deployed across the shelf 391 for supporting products, and thicker wires, e.g., left-to-right wires for structural support. As shown in FIG. 25A, left-to-right wires 395 are spaced so as to transmit force, e.g., the weight of the shelf and of products displayed thereupon, to the load cells assemblies 101 in the load-cell bases 191. Thus, the load cell assemblies 101 mediate between the weighing base 195 and the shelf 391, and the shelf 391 does not sit directly on the weighing base 195 or on the cover 192. The left-to-right wires 395 are illustrated in FIG. 25B as being thicker than the front-to-back wires, but in other examples they can all be the same thickness and weight. The skilled artisan will understand that a selection criterion for the left-to-right wires is sufficient rigidity, e.g., resistance to twisting, sagging, etc.

Reference is now made to FIG. 27, in which an alternative embodiment of a shelf assembly 490 is shown. Respective left and right weighing bars 495_{L}, 495_{R} are provided as fixed attachments to left and right side-walls 281_{L}, 281_{R} of shelving unit 200. Obviously, there can be multiple pairs of weighing bars provided in a single shelving unit 200—one for each shelf assembly 490 desired to be installed in the shelving unit 200. Each weighing bar comprises a pair of load cell installation assemblies 101. The shelf assembly 490 further comprises a shelf tray 493, which can be attached to the respective left and right weighing bars 495_{L}, 495_{R} by a receiving bracket (now shown) or by other fastening methods known in the art. Protruding elements 251 and receiving elements 252 can be used here in the same manner as discussed hereinabove.

The embodiments illustrated in FIGS. 24A and 24B, in FIGS. 25A-C, and in FIG. 27 are three diverse examples of weighing-enabled shelving units and shelf assemblies and do not exhaust the possibilities of a retail display and sales system employing load cells. For example, in other embodiments (not illustrated), weighing bars can be deployed in a direction that is orthogonal to the direction of the weighing bars 495 in FIG. 27, such that they each extend from the left wall of a shelving unit to the right wall, one such ‘transverse’ weighing bar proximate to the back wall and secured either to the back wall or to the two side walls, and the other ‘transverse’ weighing bar proximate to the front of the shelf assembly 490 and secured at both ends to the two side walls.

Methods for tracking non-homogeneous products on a shelf can use a plurality of weighing assemblies that are jointly operable to measure the combined weight of the shelf and of the products arranged thereupon. In an example, a method comprises: (a) monitoring weight measurement data corresponding to the weight of the shelf and the products arranged thereupon, the weight measurement data measured by the plurality of weighing assemblies and transmitted therefrom as respective streams of weight measurement data points; (b) responsively to a change over time in the values of the weight measurement data, determining a set of weight-event parameters of a weight event, the set of weight-event parameters comprising a product identification and an action taken with respect to the product, the determining comprising: (i) aggregating, across all of the streams, changes in the weight measurement data corresponding to a specific time, (ii) mapping a change in weight distribution on the shelf, using the aggregated changes in weight measurement data, and (iii) assigning a set of weight-event parameters for resolving the mapped change in weight distribution, using product-weight data retrieved from a product database; and (c) performing at least one of: (i) recording information about the results of the selecting in a non-transient, computer-readable medium, and (ii) displaying information about the results of the selecting on a display device.

In some embodiments, the assigning comprises: (i) identifying at least one candidate set of weight-event parameters for resolving the mapped change in weight distribution, using product-weight data retrieved from a product database, (ii) assigning an event likeliness score to each candidate set of weight-event parameters, and (iii) selecting the set of candidate weight-event parameters having the highest event likeliness score. The determining can use product positioning data from a product positioning plan in at least the identifying. The determining can include calculating a probability in at least the assigning. In some such embodiments, the probability can be calculated using a probability distribution function. In some such embodiments, a parameter of the probability distribution function can be derived using a machine learning algorithm applied to historical weight data for a product. The assigned set of weight-event parameters can include exactly one product and one action, or can include at least one of (i) two or more products and (ii) two or more actions. The action taken with respect to the product is selected from the group consisting of removing the product from the shelf, adding the product to the shelf, and moving the product from one position on the shelf to another.

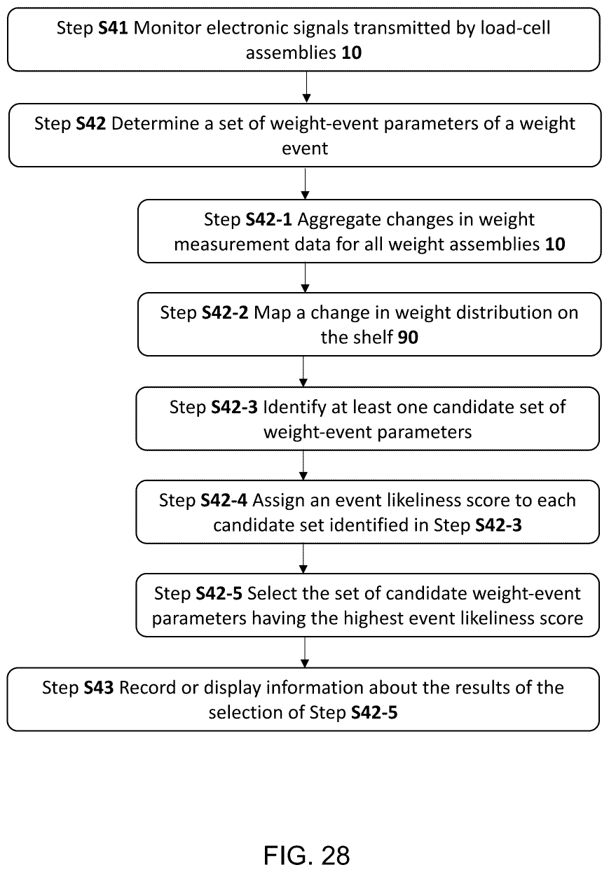

A method for tracking non-homogeneous products on a shelf, according to embodiments of the present invention, is now disclosed; a flow chart of the method is shown in FIG. 28. According to the method, a plurality of weighing assemblies 10 is jointly operable to measure the combined weights of the shelf 90 and any and all products 70 arranged thereupon. The method, as shown in the flow chart of FIG. 28, comprises:

Step S41: monitoring electronic signals transmitted by weighing assemblies 10. Each electronic signal is from a different weighing assembly 10, and includes a respective stream of weight measurement data points. The weight measurement data points correspond to the weight of the shelf and the products arranged thereupon and, as mentioned earlier, each point reflects a portion of the total weight that is distributed among all of the weighing assemblies 10. The monitoring of the signals includes assessing the values, for example to detect changes in the weights over time, e.g., a difference between a first weight measurement data point at a first time and a second weight measurement data point at a second time, that can be indicative of an action taken with respect to a product.

Step S42: determining a set of weight-event parameters of a weight event. The determining is carried out in response to a change in values, over time, i.e., from one time point to another (not necessarily a consecutive time point) in weight measurement data. The determining can be carried out in response to such a change in values being greater than a given threshold, or that the absolute value of the change is greater than a given threshold. A weight event is an event in which an action is taken with respect to a product so as to change the weight or weight distribution of products on a shelf. Weight-event parameters include a product identification (or identification of more than one product involved in a single weight event, if appropriate) and an action taken with respect to the identified product (or products). A set of weight-event parameters can include a single product and a single action, or one or more products each associated with one or more actions. The determining can be probabilistic. Uncertainties in carrying out the method can mean that the determining selects the most likely set of weight-event parameters for a weight event. For example, the result of a determining can that that product #1 70₁ being added to a shelf 90 is the ‘most likely’ explanation for a detected change in weight measurement data, as opposed to product #2 70₂ being added or product #3 being added, both of which can be alternative but ultimately less likely candidates for the determining. The uncertainties can stem from any number of sources, including, for example, inaccuracy of the weighing assemblies or unresolved noise and/or drift in the stream of data points. An additional source of uncertainty can include the time it takes for a measurement made by weighing assembly to stabilize (e.g., as a function of the elasticity of a load cell component or of the shelf itself), combined with a system requirement to resolve the weight-event parameters within a limited amount of time, such that an actual total change in weight might not be captured because of a time constraint or other limitation. Other sources of uncertainty will be enumerated later in this discussion where relevant.

As further shown in the flowchart in FIG. 28, Step S42 includes five sub-steps, as follows:

Step S42-1: aggregating changes in weight measurement data for all weight assemblies 10. As used herein, ‘aggregating’ has the meaning of ‘summing’. As discussed earlier, changes in weight measurement data are aggregated for each specific point in time; the aggregation can be for every point in time in a specific time interval or for all points in time as long as the monitoring of Step S41 continues, or for each determining; or for points in time selected according to a given periodicity or selected randomly; the only requirement is that aggregated data all correspond to a given point in time and therefore the streams are preferably synchronized.

Step S42-2: mapping a change in weight distribution on the shelf 90. A weight of a product placed on the shelf (for example) is distributed to all of the weighing assemblies of a shelf so that the aggregate of the increment in measurements made by all of the weighing assemblies equals the total incremental weight of the product; this step solves for the magnitude and location of the weight of the product placed on the shelf (i.e., or removed from the shelf or moved along the shelf) given the individual weight measurement data of the various weighing assemblies. In some embodiments the mapping can be deterministic, producing a single answer for the magnitude of the weight added/removed/moved and the coordinates of the center of weight of that weight. In other embodiments, the mapping can be probabilistic. For example, instead of mapping to a single weight center (X, Y), the mapping of product weight to x,y coordinates can be considered to have a probabilistic distribution (e.g., a density function). The probabilistic function can take into account, for example, unknowns with regards to the uniformity of the make-up or structure of the shelf, or with regards to possible angular displacement of the shelf from horizontal. It can also take into account inaccuracies in one or more of the weighing assemblies. Using a non-deterministic result out of the mapping sub-step can be another source in uncertainty in the overall determining step. In some embodiments the result of this mapping step can be stored in a repository of weight distribution mappings 51 in computer-readable storage medium 68.

Step S42-3: identifying at least one candidate set of weight-event parameters for the weight event. In this step, product data for reference can be accessed or retrieved from a product database 67 which can include, inter alia, baseline weights for products as well as ranges and distributions of possible and/or historical weights for products. Data for reference can be accessed or retrieved from a product positioning plan 69 (a planogram). The identifying includes matching a weight added/removed/moved (‘the event weight’) in Step S43-2 with the weight of a product according to data in the product database 67 and/or appearing in the planogram. The matching can return a single deterministic answer or can return an answer consisting of one or more products that may match the event weight, or come close with varying levels of probability. Probability may be assigned according to a wide variety of factors, some of which are illustrated in the following examples:

In an example, two products in the product database both have a weight matching the event weight, but only one of them is in the planogram for the shelf in question. While both products are identified in candidate sets of weight-event parameters, the one appearing in the planogram is assigned a higher probability.

In another example, two products in the product database both have a weight matching the event weight, but they appear in the planogram as belonging on other shelves. One belongs, according to the planogram, on a nearby shelf, while the other appears on a far-away shelf. While both products are identified in candidate sets of weight-event parameters, the one appearing in the planogram on a closer shelf is assigned a higher probability.

In another example, two products appearing in the product database and in the planogram have a weight matching the event weight, and the weight event is an addition to the shelf. The first product was identified with a ‘removal’ weight-event from the same shelf ten minutes earlier, and the second product was identified with a ‘removal’ event five minutes earlier. While both products are identified in candidate sets of weight-event parameters, the one identified in a removal weight event five minutes earlier is assigned a higher probability.

In another example, the aggregated change in weight on the shelf was 500 grams. A first product appearing in the planogram for that shelf weighs 50 grams more, according to the product database, and a second product weighs 30 grams less. While both products are identified in candidate sets of weight-event parameters, the product weighing 30 grams less is assigned a higher probability. In another example, the second product weighing 30 grams less ‘belongs’ on the left side of the shelf according to the planogram and the first product weighing 50 grams more belongs on the right side; according to the mapping of weight distribution in Step S42-02, the weight-center of the weight added or removed was closer to the right side, and the product weighing 50 grams more is assigned a higher probability.

In another example, two products appearing in the product database and in the planogram have a weight matching the event weight, and the weight event is a removal from the shelf. The first product has a sales rate of one can per week, and the second product has a sales rate of five cans per week. While both products are identified in candidate sets of weight-event parameters, the product with the higher sales rate is assigned a higher probability.

In yet another example, two products appearing in the product database and in the planogram have a weight matching the event weight, and the weight event is a removal from the shelf. The first product is ‘on sale’ this week at a 20% discount, and while both products are identified in candidate sets of weight-event parameters, the product with discount is assigned a higher probability.

In some embodiments, an assigned probability can be calculated using a probability distribution function. A probability distribution function can be pre-programmed based on hypothetical data and/or empirical data. A probability distribution function can be derived using a machine learning algorithm applied to historical weight data for a product.

In an illustrative example, two products appearing in the product database and in the planogram have a weight within three grams on either side of the event weight, and the weight event is a removal from the shelf. Associated with the first of the two product is a history of being 10 grams heavy 20 percent of the time and 5 grams heavy 30 percent of the time. The rest of the time, the product weight is within 2 grams either way of the baseline weight (e.g., the nominal, mean or median weight, or the ‘listed’ weight in the product database). Associated with the second of the two products is a history of being 10 grams heavy 5 percent of the time and within 3 grams either way of the baseline weight the remainder of the time. A probability distribution function derived using a machine learning algorithm applied to the respective historical weight data (a simplified version of which is presented in the foregoing example) for each of the two products assigns a higher probability to the second product. Nonetheless, both products are identified in candidate sets of weight-event parameters. The skilled artisan will appreciate that the machine learning algorithm selected for deriving probability distribution functions for product weights and calculating probabilities therefrom can be any of those known in the art and suited to the historical product-weight data, such as, for example and non-exhaustively: Linear Regression, Logistic Regression, Decision Tree, SVM, Naive Bayes, kNN, K-Means and Random Forest.

The skilled artisan will appreciate that any of the factors involved in the foregoing examples of assigning probabilities can be combined in any way, along with other intrinsic and extrinsic factors that can affect the assigning of probabilities.

Step S42-4: assigning an event likeliness score to each candidate set identified in Step S42-3. The foregoing discussion with respect to Step S42-3 included assigning probabilities to candidate sets of weight-event parameters, the assigning of an event likeliness score takes other factors into account as well, in addition to the probabilities assigned in Step S42-3. The ‘other factors’ can include the uncertainties discussed earlier including factors related to the weight measurement data, to noise and drift, to the uncertainty in mapping the weight distribution on the shelf, and so on. Thus, a final event likeliness score is assigned to each candidate set of weight-event parameters, so as to account for all of the uncertainty introduced in the various steps of the method.

Step S42-5: selecting the set of candidate weight-event parameters having the highest event likeliness score assigned in Step S42-4. The result of the ‘selecting’ in the last sub-step of Step S42 is therefore the result of the ‘determining’.

Step S43: recording or displaying information about the results of the selection of Step S42-5. The results of the selecting (i.e., of the determining) can be recorded, for example in the non-transient computer-readable storage medium 68, or in a similar storage medium in another location, for example in the ‘cloud’, where the results are transmitted via an internet connection. The results, alternatively or additionally, can be displayed on a display device, such as display device 62 or on another display device, which, for purposes of illustration, can be one intended to convey information to a customer of an unattended retail arrangement, or the screen of an inventory clerk in a storage warehouse.

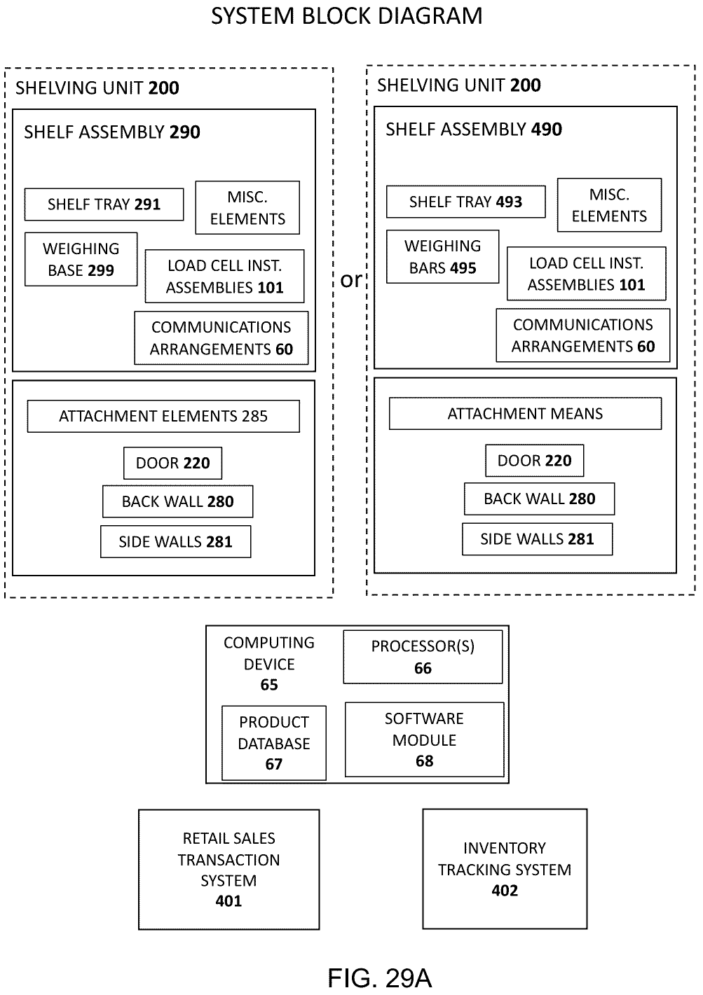

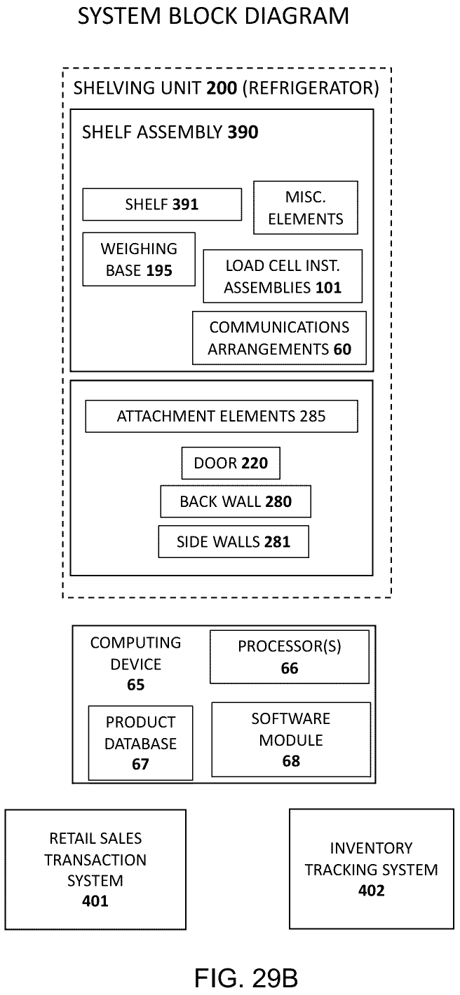

Any of the steps of the method can be carried out by the one or more computer processors 66. In some embodiments, not all of the steps of the method are necessarily carried out. In some embodiments, a system, e.g., the system shown in FIG. 29A or 29B, can be for tracking non-homogeneous products on a shelf and can comprise a plurality of weighing assemblies 10, one or more computer processors 66, and a computer-readable storage medium 68 containing program instructions 50 which, when executed by the one or more processors 66, can cause the one or more processors 66 to carry out the steps of the foregoing method.

Additional methods for tracking and disambiguating non-homogeneous products are disclosed in co-pending International Patent Application PCT/IB2019/055488, filed on Jun. 28, 2019, and published as WO/2020/003221 on Jan. 2, 2020, which is hereby incorporated by reference for all purposes as if fully set forth herein.

In some embodiments, non-weighing sensors such as, for example, optical sensors or barcode readers, can be used in conjunction with any of the weighing sensors, weighing assemblies and shelf arrangements disclosed herein. Such sensors can be expensive and/or unreliable and/or difficult to maintain or suffer from other disadvantages, and therefore in other embodiments, exclusively weighing sensors are used for disambiguating non-homogeneous products. In such ‘weighing-only’ embodiments, systems for tracking products on a shelf, or systems for unattended retail sales transactions and/or tracking inventory are devoid of other such sensors, i.e., optical sensors, barcode readers, or manual input devices and the like for identifying specific products or SKU's. In some such embodiments in which solely weighing sensors are used in tracking and disambiguation, environmental sensors such as temperature sensors and noise-detecting sensors may be used in the analysis of streams of weight data points received from weighing assemblies but not directly in the disambiguation of non-homogeneous products. Thus, it can be the that a system or method as disclosed herein uses only weight-related information, or is devoid of non-weighing sensors or of optical sensors, or that the methodology of product identification is independent of optical information (e.g., from such optical sensors), and this does not preclude the use of environmental sensors in analyzing (including, optionally, modifying) streams of data points received from weighing assemblies.

### Incorporation in a System

FIGS. 9A and 9B include block diagram showing details of systems for executing unattended retail sales transactions and/or tracking inventory of products, using any of the embodiments of shelving units and shelf assemblies disclosed herein. Such a system includes a shelving unit 200, which can include any of the shelving unit features shown. Each shelving unit includes a number of shelf assemblies 290 (or alternatively, shelf assemblies 490 as discussed above with respect to FIG. 27 or shelf assemblies 390 as discussed above with respect to FIGS. 25A-C).

Each shelf assembly 290 includes shelf tray 291, weighing base 299, load cell installation assemblies 101, communications arrangements 60 by which the processors of load cell assemblies can communicate weight information with other system elements, and miscellaneous mechanical elements.

Each shelf assembly 490 includes shelf tray 493, weighing bars 495_{L} and 495_{R}, load cell installation assemblies 101, communications arrangements 60 by which the processors of load cell assemblies can communicate with other system elements, and miscellaneous mechanical elements.

Each shelf assembly 390 includes shelf 391, weighing base 195, load cell installation assemblies 101, communications arrangements 60 by which the processors of load cell assemblies can communicate with other system elements, and miscellaneous mechanical elements. In some embodiments (not shown in FIG. 29B) the shelf assembly can include a weighing-base cover.

Each of the load cell assemblies 100 of load cell installation assemblies 101 can communicate weight information with computing device 65. Once computing device 65 determines that a product has been added to or removed from a shelf, and further determines which specific product has been added to or removed from a shelf, then the information can be forwarded to a retail sales transaction system 401 and or an inventory tracking system 402.

It will be appreciated by those of skill in the art that not all of the elements in the block diagram in FIGS. 29A and 29B need be present in order to practice the invention.

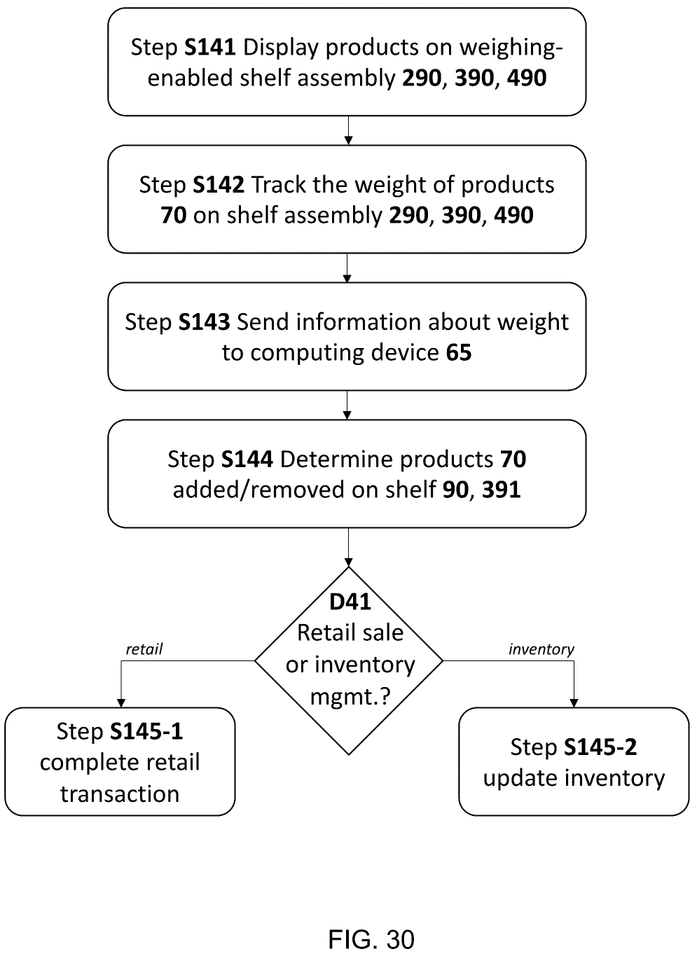

Referring now to FIG. 30, a method is disclosed for executing unattended retail sales transactions and/or tracking inventory of products, using any of the embodiments of weighing assemblies and shelving arrangements disclosed herein. According to embodiments, the method includes:

Step S141 displaying products 70 on weighing-enabled shelf assemblies 290, 390, 490 according to any of the embodiments disclosed herein. Products need not be homogeneous, as in later step S104 a determination will be made as to which products are added and or removed on a shelf.

Step S142 tracking the weight of products 70 on shelf assemblies 290, using the load cell assemblies 100 installed in the load cell installation assemblies of each shelf assembly.

Step S143 sending information about the weight of products 70 to the computing device 65. This includes communication of information about weight indications from the processors of the load cell assemblies 100 via a communications channel 61.

Step S144 determining which products 70 were added to or removed from a shelf 90, 391.

Decision Step D41 as to whether the information is to be used in a retail sale transaction or for inventory management, or for both. The result of the decision is of course known and included in the computer code of the system.

Step S145-1 complete retail transaction if that is a result of Decision Step D41.

Step S145-2 update an inventory entry if that is a result of Decision Step D41.

Not all of the steps of the method need be carried out in order to practice the invention.

### Additional Discussion

In embodiments, a shelving unit, for enabling a retail transaction for the sale of products from the shelving unit, comprises: (a) a weighing-enabled shelf assembly comprising: (i) a base unit comprising at least one and typically a plurality of load cell assemblies; and (ii) a shelf unit disposed atop the base unit, the base unit being configured to receive the weight load of the shelf unit and distribute it among the plurality of load cell assemblies; and (b) a shelving unit housing surrounding the shelf assembly, typically on at least three sides to form an enclosure, wherein the width of the shelf assembly is more than half the interior width of the enclosure such that for any given height of the enclosure there is no more than one shelf assembly.

In some embodiments, the shelving unit can additionally comprise: (c) one or more computer processors in electronic communication with at least one of the plurality of load cells; (d) a non-transitory computer-readable storage medium on which are stored program instructions, which when executed cause the one or more processors to perform the following steps: (i) tracking the weight of products borne by the shelf unit, using the plurality of load cell assemblies; (ii) calculating a change in weight of the products on the shelf; and (iii) in response to the calculating: (1) determining that a product has been added to or removed from the shelf unit, and (2) in response to the determining that a product has been added to or removed from the shelf unit, further determining a product-specific identifier of the added or removed product; and (iii) completing a retail sales transaction, using the result of the determining and of the further determining.

In some embodiments, the width of the shelf assembly is greater than 90% of the interior width of the enclosure.

In some embodiments, the shelving unit additionally comprises a retail transaction apparatus.

In embodiments, a shelving unit having weighing capabilities comprises at least a first shelf assembly, each shelf assembly including: (i) a shelf, (ii) a plurality of load cell assemblies, each load cell assembly of the plurality including: (A) a load cell body having a free end and an anchored portion, the load cell body including a spring element and at least one receiving element; and (B) a strain-sensing gage, bonded to the spring element, the strain-sensing gage adapted to measure a strain in the spring element, in the loaded disposition; and (iii) a load cell base, wherein, in a weighing configuration, (i) the plurality of load cell assemblies are adapted to receive a vertical load from the shelf, and (ii) the receiving element has an unloaded disposition and a loaded disposition in which the at least one receiving element receives the vertical load, wherein in the loaded position, the free end attains a depressed position with respect to the free end in the unloaded disposition.

In some embodiments, the shelving unit can also comprise (b) a shelving unit housing forming a shelving volume horizontally bounded by left and right walls. In some such embodiments, the shelving volume can be additionally bounded by a back wall. In some embodiments, the shelving volume can additionally be bounded by a door in the front.

In some embodiments, the shelving unit can also comprise: (c) at least a first attachment element, attached to the left wall, and at least a second attachment element, attached to the right wall, wherein the at least first and at least second attachment elements effect securement of the shelf assembly to the left and right walls. In some embodiments, the shelving unit can also comprise at least a first attachment element attached to the back wall.

In some embodiments, the shelf has a depth D defined as a minimum distance from a front edge to a back edge of the shelf, the back edge facing the back wall, wherein the securement may be effected within a distance of 0.50-D from the front edge. In some embodiments, the securement may be effected within a distance of 0.30-D, 0.25-D, 0.20-D, 0.15-D, or 0.10-D from the front edge.

In some embodiments, each shelf assembly can additionally comprise at least one protruding element, wherein the at least one protruding element is vertically aligned with the at least one receiving element, whereby, in the loaded disposition, the at least one receiving element receives the vertical load via the at least one protruding element. The at least one protruding element can be disposed on the shelf.

In some embodiments, the shelving unit can further comprise an attachment component for securing the shelf assembly to the attachment element, wherein the securing includes attaching the attachment component to an attachment-element-point of the attachment element and mating the attachment component to an attachment point of the shelf assembly.

In some embodiments, the attachment elements can be adapted for multiple non-destructively reversible securements.

In some embodiments, the securement of the shelf assembly to the left and right walls can include securement of the load cell base to the left and right walls.

In some embodiments, the shelf assembly can comprise a plurality of load cell bases, wherein the attachment of the shelf assembly to the left and right walls is by attachment of at least one load cell base to each of the left and right walls. The attachment elements can be adapted for fixed attachment of the load cell bases.

In some embodiments, the shelving unit can additionally comprise a retail transaction apparatus. In some embodiments, the shelving unit can additionally comprise a door that includes an electronically engageable lock. In some embodiments, the load cell assembly can comprise a load cell. In some embodiments, the load cell assembly can comprise a double ended load cell. In some embodiments, the load cell assembly can comprise a load cell having a flexural member. In some embodiments, the flexural member can be is an integral portion of the load cell body.

In some embodiments, the strain-sensing gage can be being associated with a processing unit configured to receive strain signals therefrom, and to produce a weight indication based on the strain signals. The shelving unit can additionally comprise a communications arrangement for sending information about the weight indication to a computing device. The shelving unit can additionally comprise the computing device, wherein the computing device includes a software module for determining, based on the information, that a product has been added to or removed from a shelf. The product can be a member of a group of products characterized by a plurality of SKU-identifiers, and the determining by the software module can additionally include determining the SKU-identifier of the product that has been added or removed from the shelf. The result of the determining by the software module can be further used to perform at least one of a retail sales transaction and an inventory adjustment in a computerized inventory system.

In some embodiments, the shelving unit can additionally comprise a refrigeration unit. In some embodiments, each of the attachment elements can include at least one attachment-element-point adapted for mating with corresponding attachment points of a shelf assembly. In some embodiments, each shelf assembly can have exactly one respective load cell base, each one respective load cell base supporting all of the plurality of load cell assemblies of the respective shelf assembly.

In some embodiments, the plurality of load cell assemblies of the shelf assembly can consist of 4 load cell assemblies. In some embodiments, each shelf assembly can extend substantially from the left wall to the right wall.

In embodiments, a shelving unit comprises a shelf assembly that includes (i) a shelf and (ii) securement arrangements for fixing the position of the shelf assembly in a shelving unit, the shelf assembly having a left side facing a left wall of the shelving unit and a right side facing a right wall of the shelving unit, wherein the shelf assembly includes: (a) a planar load cell assembly comprising at least one load cell arrangement disposed on a single metal load cell body, the load cell body having a primary axis, a central longitudinal axis, and a transverse axis disposed transversely with respect to the primary and central longitudinal axes, a broad dimension of the load cell body being disposed along the primary axis, the load cell body having rectangular faces, each load cell arrangement including: (i) a first contiguous cutout window passing through the broad dimension and formed by a first pair of cutout lines disposed parallel to the central longitudinal axis, and connected by a first cutout base; (ii) a second contiguous cutout window passing through the broad dimension and formed by a second pair of cutout lines disposed parallel to the central longitudinal axis, and connected by a second cutout base; and (iii) a third contiguous cutout window passing through the broad dimension and formed by a third pair of cutout lines disposed parallel to the central longitudinal axis, and connected by a third cutout base, wherein the second contiguous cutout window is transversely bounded by the first contiguous cutout window, and the third contiguous cutout window is transversely bounded by the second contiguous cutout window; and wherein the second cutout base is disposed diametrically opposite both the first cutout base and the third cutout base. Each load cell arrangement additionally includes (iv) a pair of measuring beams, disposed along opposite edges of the load cell body, and parallel to the central longitudinal axis, each of the measuring beams longitudinally defined by a respective cutout line of the first pair of cutout lines; (v) a first flexure arrangement having a first pair of flexure beams, disposed along opposite sides of the central longitudinal axis, and parallel thereto, the first pair of flexure beams longitudinally disposed between the first pair of cutout lines and the second pair of cutout lines, and mechanically connected by a first flexure base; (vi) a second flexure arrangement having a second pair of flexure beams, disposed along opposite sides of the central longitudinal axis, and parallel thereto, the second pair of flexure beams longitudinally disposed between the second pair of cutout lines and the third pair of cutout lines, and mechanically connected by a second flexure base; (vii) a loading element, longitudinally defined by the third pair of cutout lines, and extending from the second flexure base, the transverse axis passing through the loading element; and (viii) at least one strain gage, fixedly attached to a surface of a measuring beam of the measuring beams. The shelf assembly additionally includes a load cell base including the securement arrangements and attached to the load cell body at an anchored end thereof, wherein at least one of the securement arrangements is on the left side of the shelf assembly and at least one of the securement arrangements is on the right side of the shelf assembly.

In some embodiments, the shelf assembly can additionally comprise at least one protruding element, wherein, in an assembled configuration, the at least one protruding element is vertically aligned with the at least one receiving element. The at least one protruding element can be disposed on the shelf.

In some embodiments, the securement arrangements can include attachment points adapted for mating with one of: (i) an attachment-element-point of a shelving unit wall and (ii) an attachment component of a shelving unit. An attachment point can include at least one of a protruding member, a recess, a hole and a slot. The shelf assembly has a depth D defined as a minimum distance from a front edge to a back edge of the shelf, the back edge facing the back wall, and at least one of the securement arrangements may be disposed within a distance of 0.50-D from the front edge. At least one of the securement arrangements may be disposed within a distance of 0.30-D, 0.25-D, 0.20-D, 0.15-D, or 0.10-D from the front edge. The attachment points can be adapted for multiple non-destructively reversible securements.

In some embodiments, the securement of the shelf assembly to the left and right walls can be by securement of a load cell base to the left and right walls.

In some embodiments, the shelf assembly can comprise a plurality of load cell bases, wherein the attachment of the shelf assembly to the left and right walls is by attachment of at least one load cell base to each of the left and right walls. The attachment points can be adapted for fixed securement of the load cell bases.

In embodiments, a shelf assembly with weighing capabilities comprises (a) a shelf; (b) securement arrangements adapted for securing the shelf assembly to a shelving unit; and (c) a load cell assembly including: (i) a load cell body having a free end and an anchored portion, the load body including a spring element and at least one receiving element adapted to receive a vertical load from the receiving bracket, the receiving element having an unloaded disposition and a loaded disposition in which the free end is depressed with respect to the free end in the unloaded disposition; and (ii) a strain-sensing gage, bonded to the spring element, the strain-sensing gage adapted to measure a strain in the spring element, in the loaded disposition. The shelf assembly also comprises (d) a load cell base including the securement arrangements, the load cell base attached to the load cell body at the anchored portion thereof.

In some embodiments, it can be that (i) at least one of the securement arrangements is on a left side of the shelf assembly so as to face, in an assembled configuration, a left wall of the shelving unit, and (ii) at least one of the securement arrangements is on a right side of the shelf assembly so as to face, in an assembled configuration, a right wall of the shelving unit.

In embodiments, a method, of tracking inventory of products displayed on shelving comprising weighing assemblies, comprises: (a) storing products characterized by a plurality of SKU-identifiers on a shelf assembly with weighing capabilities, the shelf assembly comprising a load cell assembly including (i) a load cell body having a free end and an anchored portion, the load cell body including a spring element and at least one receiving element, (ii) a strain-sensing gage, bonded to the spring element, the strain-sensing gage adapted to measure a strain in the spring element, in the loaded disposition, and (iii) a load cell base including securement arrangements for attaching the shelf assembly to a shelving unit; (b) tracking the weight of the products on the shelf, using the load cell assembly; (c) in response to a change in weight of the products on the shelf, sending information about the weight of the products from the load cell assembly to a computing device; and in response to receiving the information about the weight of the products: (i) determining, by the computing device, that a product has been added to or removed from the shelf, and (ii) in response to the determining that a product has been added to or removed from the shelf, further determining an SKU-identifier of the product added or removed.

In some embodiments, the method can additionally comprise the step of recording a change in an inventory management system. The method can additionally comprise the step of completing a retail sales transaction, using the result of the determining and of the further determining.

In embodiments, a retail sales system has a shelving unit as disclosed herein, or substantially as described herein.

In embodiments, a shelving unit having weighing capabilities comprises: (a) at least a first shelf assembly, each shelf assembly including: (i) a shelf; (ii) a plurality of load cell assemblies, each planar load cell assembly comprising at least one load cell arrangement disposed on a single metal load cell body, the load cell body having a primary axis, a central longitudinal axis, and a transverse axis disposed transversely with respect to the primary and central longitudinal axes, a broad dimension of the load cell body being disposed perpendicular to the primary axis, each load cell arrangement including: (A) a first contiguous cutout window passing through the broad dimension and formed by a first pair of cutout lines disposed generally parallel to the central longitudinal axis, and connected by a first cutout base; (B) a second contiguous cutout window passing through the broad dimension and formed by a second pair of cutout lines disposed generally parallel to the central longitudinal axis, and connected by a second cutout base, wherein the second contiguous cutout window is transversely bounded by the first contiguous cutout window; (C) a pair of measuring beams disposed along opposite edges of the load cell body and generally parallel to the central longitudinal axis, each of the measuring beams longitudinally defined by a respective cutout line of the first pair of cutout lines; (D) a first flexure arrangement having a first pair of flexure beams, disposed along opposite sides of the central longitudinal axis, and generally parallel thereto, the first pair of flexure beams longitudinally disposed between the first pair of cutout lines and the second pair of cutout lines, and mechanically connected by a first flexure base; (E) a loading element, longitudinally defined by an innermost pair of cutout lines, comprising a receiving element and extending from an innermost flexure base, the transverse axis passing through the loading element; and (F) at least one strain gage, fixedly attached to a surface of a measuring beam of the measuring beams; and (iii) a load cell base, adapted to anchor the anchored portion of the load cell body, and optionally adapted to anchor each anchored portion of each load cell body of each of the plurality of load cell assemblies, wherein the load cell base is attached to the load cell body at the anchored portion thereof; (b) a shelving unit housing forming a shelving volume horizontally bounded by left, right, and back walls; and (c) an attachment element, attached to one of the left, right and back walls, wherein the attachment element effects securement of the shelf assembly to one of left, right and back walls.

In some embodiments, each shelf assembly can additionally comprise at least one protruding element, wherein the at least one protruding element is vertically aligned with the at least one receiving element, whereby, in the loaded disposition, the at least one receiving element receives the vertical load via the at least one protruding element.

In some embodiments, the shelving unit can further comprise an attachment component for securing the shelf assembly to the attachment element, wherein the securing includes attaching the attachment component to an attachment-element-point of the attachment element and mating the attachment component to an attachment point of the shelf assembly.

In some embodiments, the securement of the shelf assembly to one of the left, right and back walls can include securement of the load cell base to the left and right walls.

In some embodiments, the shelf assembly can comprise a plurality of load cell bases, wherein the attachment of the shelf assembly to the left and right walls is by attachment of at least one load cell base to each of the left and right walls.

In some embodiments, the attachment elements can be adapted for fixed attachment of the load cell bases.

In some embodiments, the shelf can comprise an upwardly extending rim member on at least one of the four sides of the shelf, the rim member being sized and/or disposed so as to prevent a product borne by the shelf to transfer any of its weight load directly to a wall or door of the shelving unit by leaning thereupon.

In some embodiments, the shelf can comprise an upwardly extending dividing member, the dividing member being sized and/or disposed so as to prevent a product borne by the shelf to transfer any of its weight load to another product borne by the shelf by leaning thereupon.

In some embodiments, it can be that (i) the width of the shelf assembly is more than half the interior width of the enclosure and (ii) for any given height of the enclosure there is at most one shelf assembly.

In some embodiments, the shelving unit can additionally comprise a retail transaction apparatus. In some embodiments, the shelving unit can additionally comprise a door that includes an electronically engageable lock.

In some embodiments, the load cell assembly can comprise a double ended load cell.

In some embodiments, the load cell assembly can comprise a load cell having a flexural member. In such embodiments, the flexural member can be an integral portion of the load cell body.

In some embodiments, the strain gage is associated with a processing unit configured to receive strain signals therefrom, and to produce a weight indication based on the strain signals. In such embodiments, the shelving unit can additionally comprise a communications arrangement for sending information about the weight indication to a computing device. In such embodiments, the shelving unit can additionally comprise the computing device, wherein the computing device includes program instructions stored in a non-transitory computer-readable storage medium, which when executed by one or more processors of the computing device cause the one or more processors to determine, based on the information, that a product has been added to or removed from a shelf. In some such embodiments, it can be that the product is a member of a group of products characterized by a plurality of SKU-identifiers, and the determining by the one or more processors additionally includes determining the SKU-identifier of the product that has been added or removed from the shelf. In some such embodiments, the result of the determining by the software module can be further used to perform at least one of a retail sales transaction and an inventory adjustment in a computerized inventory system.

In some embodiments, the shelving unit can additionally comprise a refrigeration unit.

In some embodiments, each shelf assembly can have exactly one respective load cell base, each one respective load cell base supporting all of the plurality of load cell assemblies of the respective shelf assembly.

In some embodiments, the plurality of load cell assemblies of the shelf assembly can consist of 4 load cell assemblies.

In some embodiments, each shelf assembly may extend substantially from the left wall to the right wall.

In some embodiments, the shelving unit comprises a plurality of attachment elements, of which at least one is attached to the left wall and at least one is attached to the right wall.

A method is disclosed for tracking inventory of products displayed on shelf assemblies installed in a shelving unit, each shelf assembly having a width more than half the internal width of the shelving unit such that the shelving unit includes no more than one shelf assembly at any given height. The method comprises: (a) storing products characterized by a plurality of SKU-identifiers on a shelf assembly with weighing capabilities, the shelf assembly comprising a load cell assembly including (i) a load cell body having a free end and an anchored portion, the load cell body including a spring element and at least one receiving element, (ii) a strain-sensing gage, bonded to the spring element, the strain-sensing gage adapted to measure a strain in the spring element, in the loaded disposition, and (iii) a load cell base including securement arrangements for attaching the shelf assembly to a shelving unit, the securement arrangements being placed so as to engage with corresponding securement elements on respective left and right side walls of the shelving unit; (b) tracking the weight of the products on the shelf, using the load cell assembly; (c) in response to a change in weight of the products on the shelf, sending information about the weight of the products from the load cell assembly to a computing device; and (d) in response to receiving the information about the weight of the products: (i) determining, by the computing device, that a product has been added to or removed from the shelf, and (ii) in response to the determining that a product has been added to or removed from the shelf, further determining an SKU-identifier of the product added or removed.

In some embodiments, the method can additionally comprise the step of recording a change in an inventory management system.

In some embodiments, the method can additionally comprise the step of completing a retail sales transaction, using the result of the determining and of the further determining.

### STILL FURTHER EMBODIMENTS

A system for mapping the weight distribution of a non-homogeneous plurality of products on a shelf is disclosed, the system comprising: (a) one or more load cell assemblies, each load cell assembly comprising: (i) at least one load cell arrangement disposed on a single metal load cell body, the load cell body having a primary axis, a central longitudinal axis, and a transverse axis disposed transversely with respect to the primary and central longitudinal axes, a broad dimension of the load cell body being disposed perpendicular to the primary axis, each the load cell arrangement including: (A) a first contiguous cutout window passing through the broad dimension and formed by a first pair of cutout lines disposed generally parallel to the central longitudinal axis, and connected by a first cutout base; (B) a second contiguous cutout window passing through the broad dimension and formed by a second pair of cutout lines disposed generally parallel to the central longitudinal axis, and connected by a second cutout base, wherein the second contiguous cutout window is transversely bounded by the first contiguous cutout window; (C) a pair of measuring beams disposed along opposite edges of the load cell body and generally parallel to the central longitudinal axis, each of the measuring beams longitudinally defined by a respective cutout line of the first pair of cutout lines; (D) a first flexure arrangement having a first pair of flexure beams, disposed along opposite sides of the central longitudinal axis, and generally parallel thereto, the first pair of flexure beams longitudinally disposed between the first pair of cutout lines and the second pair of cutout lines, and mechanically connected by a first flexure base; (E) a loading element, longitudinally defined by an innermost pair of cutout lines, comprising a receiving element and extending from an innermost flexure base, the transverse axis passing through the loading element; and (F) at least one strain gage, fixedly attached to a surface of a measuring beam of the measuring beams; (b) one or more computer processors; and (c) a non-transient computer-readable storage medium comprising program instructions, which when executed by the one or more computer processors, cause the one or more computer processors to carry out the following steps: (i) receiving, from each of the plurality of load cell assemblies, respective synchronized data streams of weight measurement data points, each of the weight measurement data points representing a proper fraction of the total weight of the shelf and of any products arranged thereupon, wherein the sum of the proper fractions represented by the weight measurement data points for any given time is equal to one; (ii) accessing, from transient or non-transient computer memory, an earlier mapping of the weight distribution of products on the shelf; and (iii) in response to receiving a weight measurement data point with a changed value, remapping the weight distribution of products on the shelf, the remapping being carried out (A) using a comparison of received weight measurement data points with the earlier mapping, (B) in accordance with a mapping rule that applies a mathematical function for weight distribution.

In accordance with embodiments of the invention, methods and systems for tracking products and product weights on weighing-enabled shelving arrangements with autonomous weighing capabilities are disclosed. Weighing-enabled shelving arrangements can be useful for enabling, for example, inventory management or unattended retail transactions, where the weight of a product removed from a shelf can be automatically recorded and subsequently used in charging a customer for the product. Similarly, tracking the addition of a product to a shelf or the moving of a product one place to another within a shelf can be useful. Typically, the shelving arrangement is connected to a computing device with a tracking module for tracking the weight of all products on a given shelf. The tracking module can respond to a change in weight on the shelf (or of the shelf plus the products stored thereupon) by, for example, sending information to a retail module that charges the customer for products taken. Additionally or alternatively, a tracking module can respond to a change in weight on the shelf by, for example, updating an inventory record. The computing device can also include a database of products and respective weights, so that the particular product removed from the shelf can be identified, for example, by stock-keeping unit (SKU) number. The database can include or be linked to a statistical analysis of weights for any given product, and the computing device can in some embodiments collect and use historical data to perform unsupervised (or, alternatively, supervised) machine learning in order to calculate the probability that a given measured change in weight relates to the addition, removal or moving of specific products. The computing device can also use information accessed in a planogram, which is a representation of the preferred or default product positioning plan layout for a shelving arrangement, as is known in the retail industry. The tracking module can also be linked to a retail module and/or an inventory module which can process the information from the tracking module and complete a retail sales transaction and/or record a change in inventory, respectively.

We now refer to FIGS. 1A and 1B. In embodiments, a shelf 90 is provided for storing or displaying products 70. Products can be diverse, e.g., 70₁ and 70₂ are different products, and any number of each type of different products can be placed on a shelf 90. While shown as differing in size and shape, they can also differ in weight, dimensions, contents or weight history (e.g., a histogram of past weight values for each respective product), and can be distinguished by having different SKUs, i.e., stock-keeping unit identification numbers, or by other unique identifiers. As used herein, the term “SKU” means stock-keeping unit. The use of SKU-identifiers is a standard means of identifying unique products across industries. Unique products can be, for example, products defined by unique combinations of physical characteristics, e.g., weight (whether nominal or average), volume, dimensions, etc. and/or non-physical characteristics, e.g., brand or packaging design. It can be that two products can be similar in physical characteristics but have different SKU-identifiers; in some embodiments they can be considered as ‘non-homogeneous’ and in other embodiments they may not. However, any use of the term ‘products’ in this disclosure or in the claims attached thereto includes the concept of ‘non-homogeneous products’. In an example, a particular brand of cookies may offer products with a number of different SKU-identifiers: a first SKU for the brand's large package of large chocolate cookies, a second SKU for the brand's small package of the same large chocolate cookies, and a third SKU for the brand's large package of small chocolate cookies, and so on. The term “non-homogeneous”, as applied herein to a group of products, means that the products in the group do not all share the same SKU-identifier, but should not be understood to imply that each product in a group has a unique SKU-identifier. For example, a group of non-homogeneous products might include: (a) 10 large packages of large chocolate cookies bearing a first brand and having a first SKU-identifier, and (b) 2 large packages of small chocolate cookies from a second brand and having a second SKU-identifier, or, without limitation any combination of products having, in combination, two or more SKU-identifiers. A group of products having, in combination, two or more SKU-identifiers can be considered ‘non-homogeneous’ with respect to one another. Thus, within any group of non-homogeneous products, products can differ from other members of the group in terms of, and not exhaustively: product packaging design and/or materials, weight, size, one or more external dimensions, brand, contents, list of ingredients, size and number of sub-divisions within a product packaging, and product-weight history such as can be represented by a database of past weight data, where the past weight data can encompass not only total weight but also the distribution of weight over the footprint of the product.

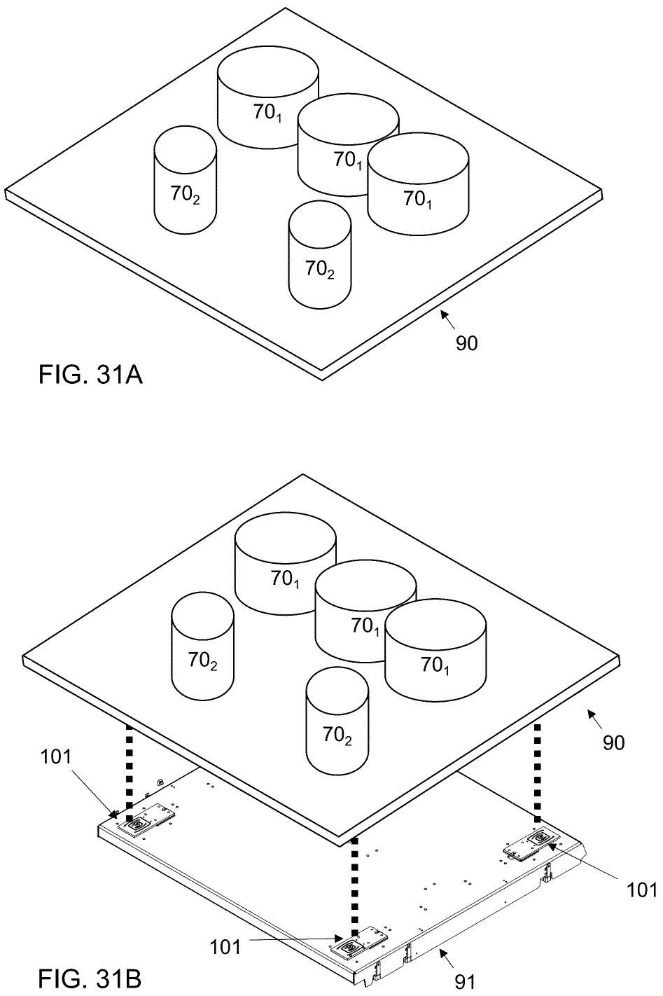

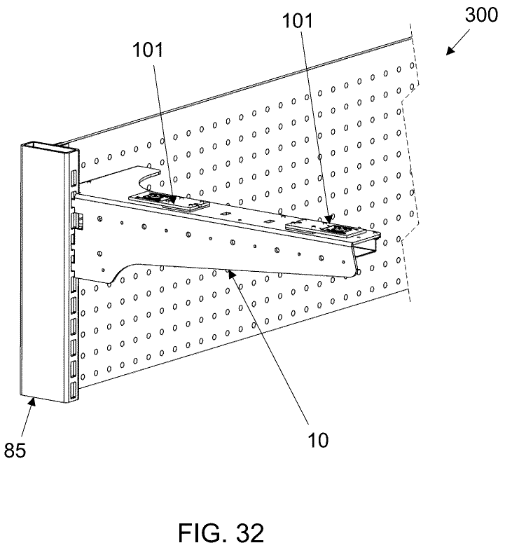

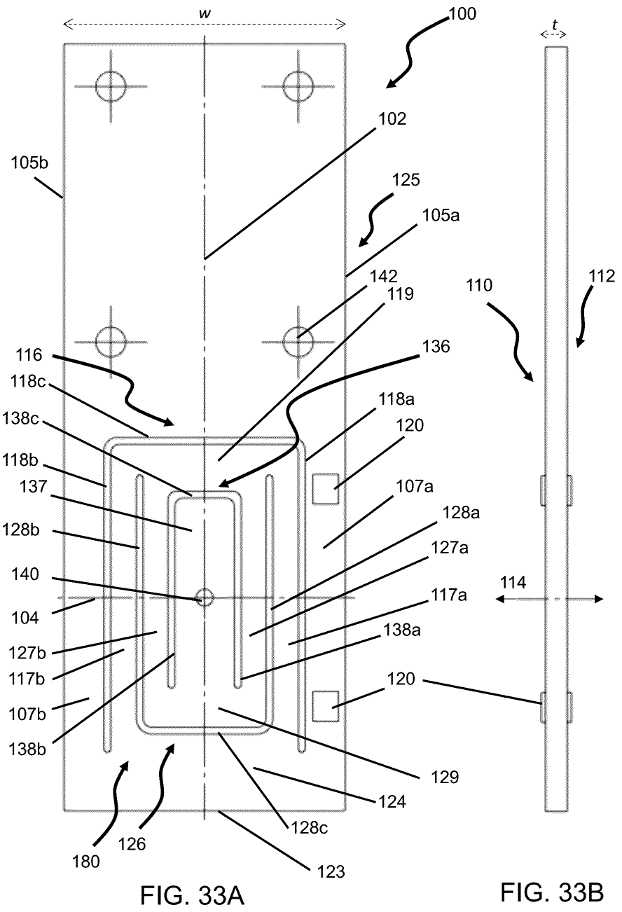

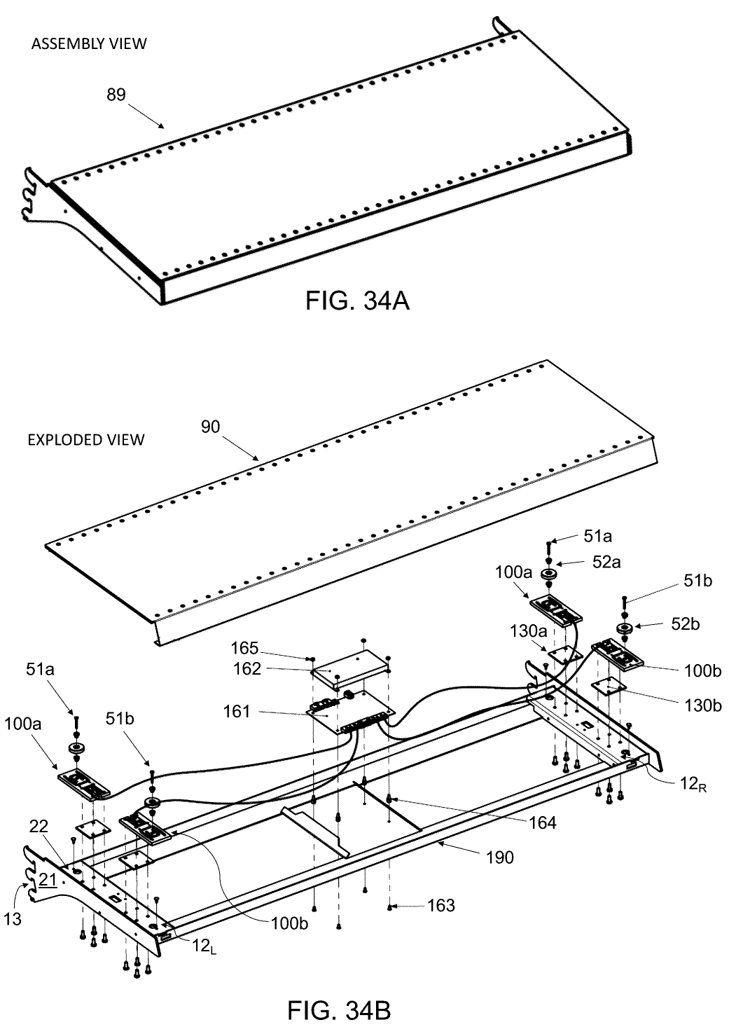

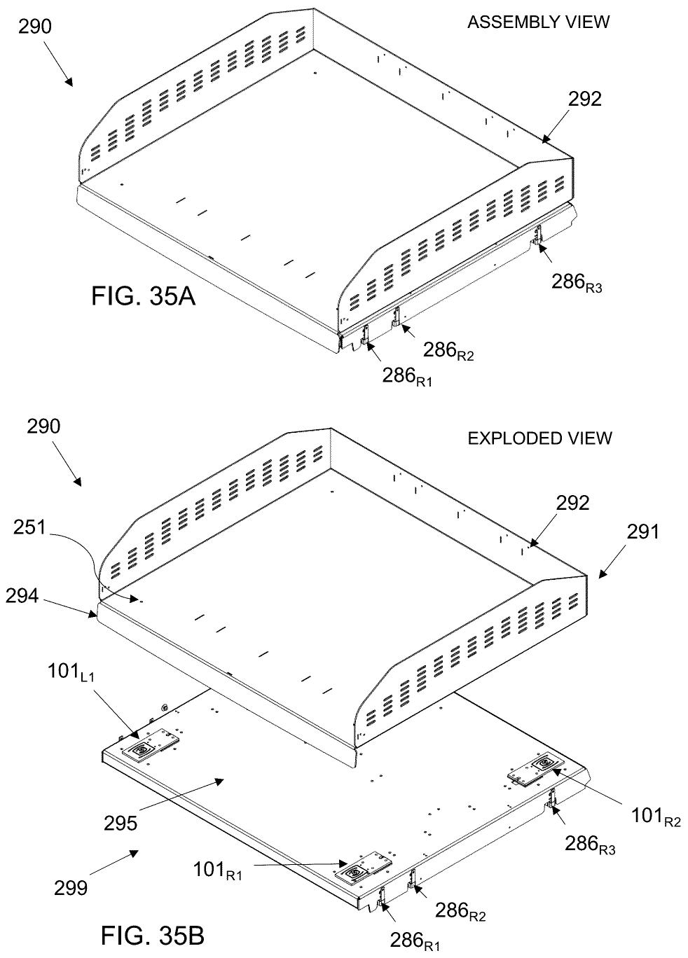

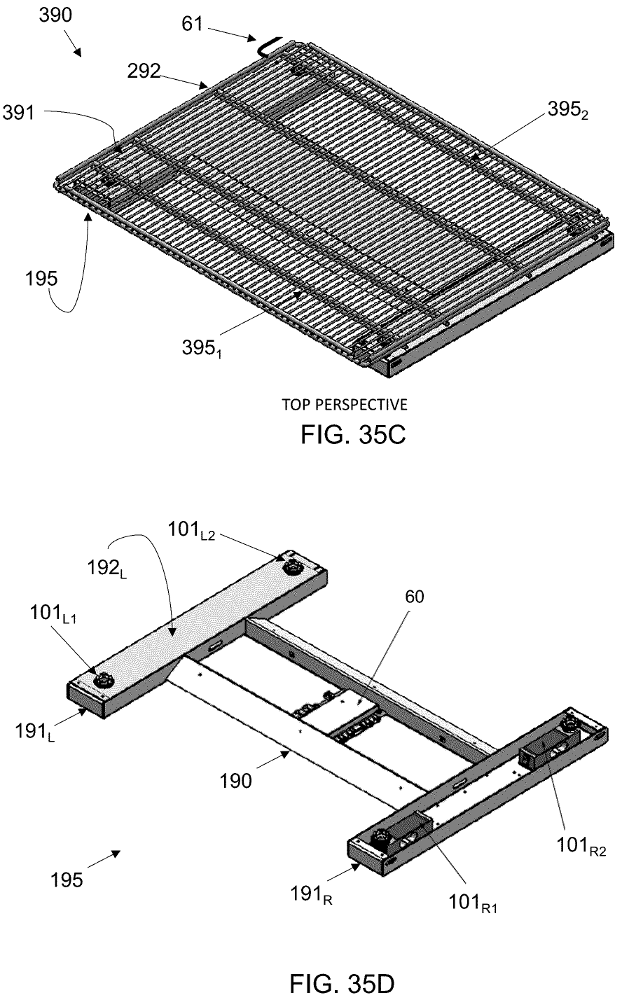

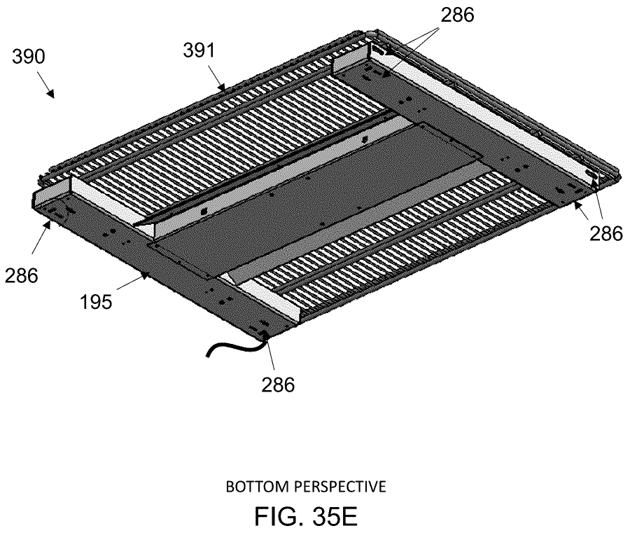

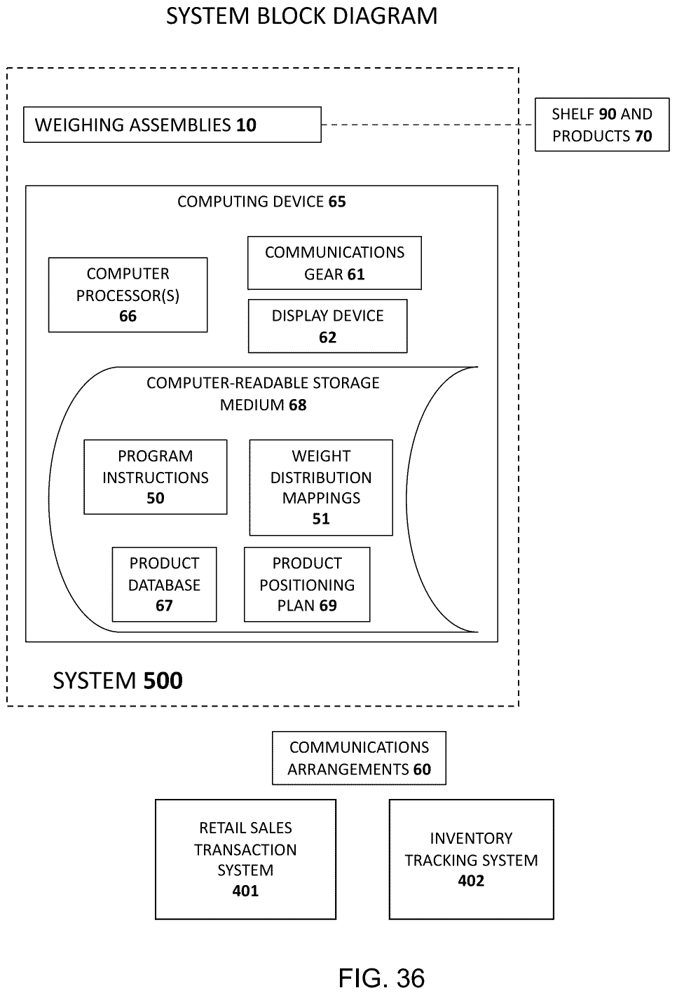

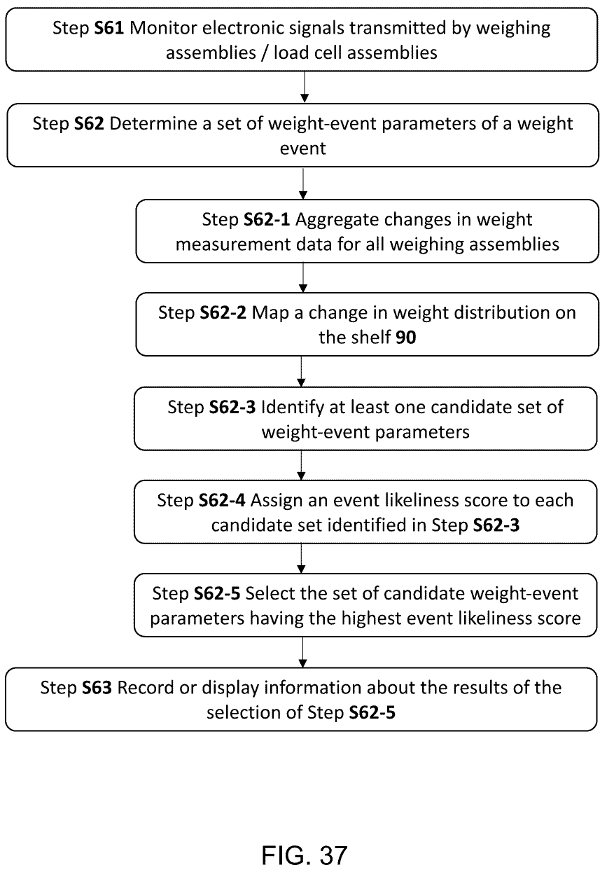

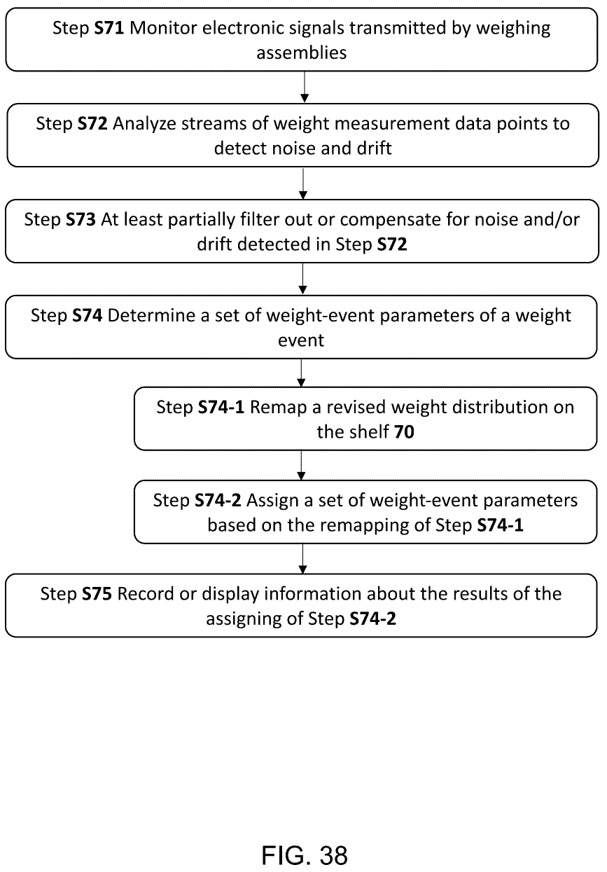

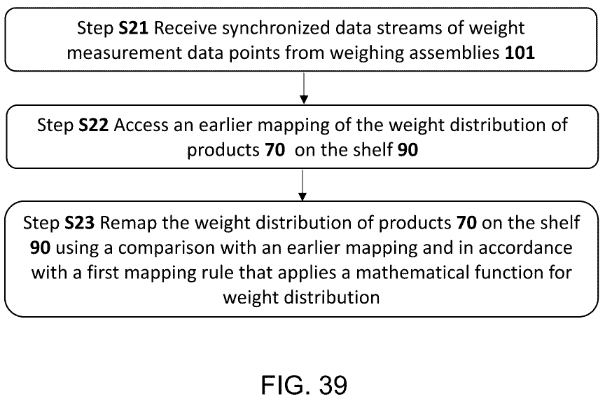

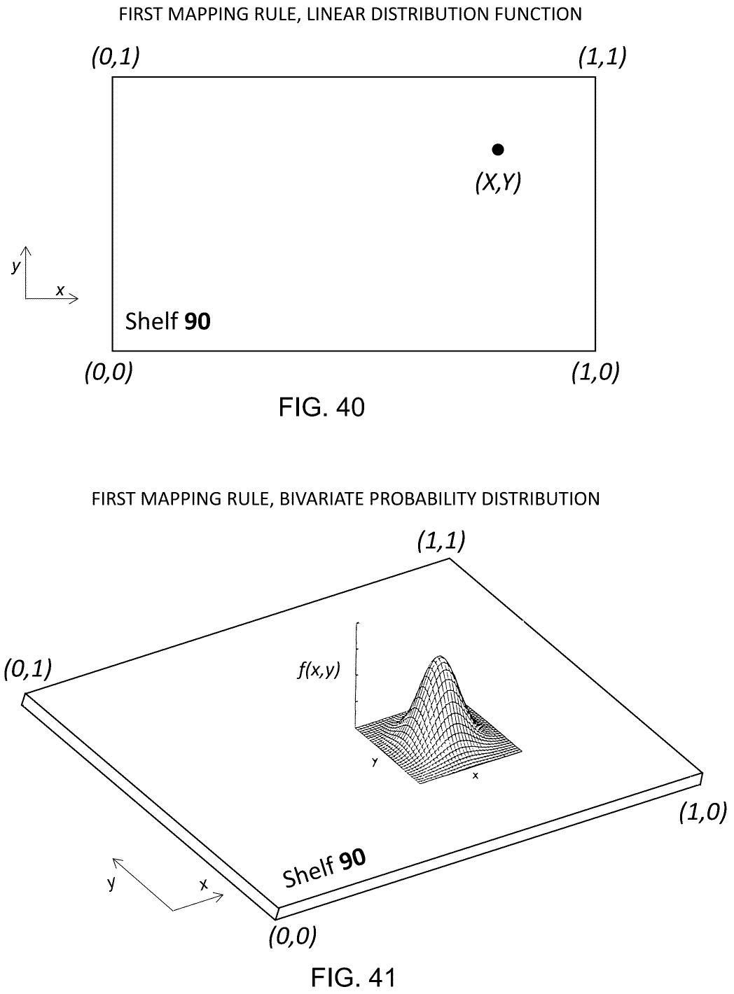

As shown in FIG. 31B, the shelf 90 can be in contact, at least indirectly, with load cell assemblies 101, so that the load cell assemblies 101 can measure the weight of the shelf 70 and of products 70 on the shelf 90. In the non-limiting example of FIG. 31B, the load cell assemblies 101 are provided as part of a shelf base 91 which supports the shelf 90 when installed. In another non-limiting example illustrated in FIG. 2, load cell assemblies 101 are provided in a bracket assembly 10 attached to an upright 85 of a shelving unit 300 of a connected retail-type shelving bay, and a shelf 90 can be supported by two such bracket assemblies 10 provided at opposite ends of the shelf 90. The load cell assemblies 101 are illustrated as planar load cell assemblies, but any suitable weight sensor can be used, although preferably one with fast response time and high levels of precision. Additional examples of load cell assemblies integrated into shelves and shelf assemblies will be discussed with reference to FIGS. 4A, 4B, 5A and 5B.

Load cell assemblies 101 can include internal processors (not shown), which can be configured, for example, to sample continuous or discrete weight measurements and transmit streams of weight measurement data points to an external processor, using internal communications arrangements (not shown). The sampling rate is preferably at least 50 Hz, or at least 100 Hz, or at least 200 Hz, or higher. A high sampling rate can be helpful, for example, if it is desired to filter out noise. An electronic signal transmitting a stream of weight measurement data points can be analyzed to detect noise, for example by decomposing the signal into component frequencies using a Fourier transform, as is known in the art. Noise in the signal can come from mechanical and/or environmental sources, for example from vibrations due to mechanical equipment in the area.

### Discussion of Load Cell Assembly Embodiments

Load cells with low profiles may have a characteristically low amplitude signal. Given limitations in the total weight to be measured, and the inherent sensitivity of load cells, the performance of such devices may be compromised by a high noise-to-signal ratio and by unacceptable settling times. Various embodiments of the present invention resolve, or at least appreciably reduce, parasitic noise issues associated with typical low-profile load cells and enable high accuracy weight measurements.

Loading of a spring arrangement is effected by placing a load on, or below, a loading beam, depending on whether the loading beam is anchored to the weighing platform, or to the weighing base. (Note: the term “weighing base” is used herein interchangeable with the term “load cell base” and no difference in meaning between the two terms should be inferred.) The loading beam may also be referred to as the “loading element” or as the “load-receiving element” or “load-supporting element” (depending on the configuration) of the load cell assembly. The spring arrangement has at least one flexure arrangement having at least two flexures or flexural elements operatively connected in series. The flexure arrangement is operatively connected, at a first end, to the loading beam, and at a second end, to the free or adaptive end of at least one measuring beam.

The flexure arrangement has n flexures (n being an integer) operatively connected in series, the first of these flexures being operatively connected to the loading beam, and the ultimate flexure of the n flexures being operatively connected in series to a second flexure, which in turn, is operatively connected to the first flexure in an assembly of m flexures (m being an integer), operatively connected in series. The ultimate flexure of the m flexures is operatively connected, in series, to a measuring beam of the spring arrangement. Associated with the measuring beam is at least one strain gage, which produces weighing information with respect to the load.

The inventor has discovered that at least two of such flexure arrangements, disposed generally in parallel, may be necessary for the loading element to be suitably disposed substantially in a horizontal position (i.e., perpendicular to the load).

In some embodiments, and particularly when extremely high accuracy is not necessary, a single flexure disposed between the loading beam and the measuring beam may be sufficient. This single flexure load cell arrangement may also exhibit increased crosstalk with other load cell arrangements (weighing-enabled systems may typically have 4 of such load cell arrangements for a single weighing platform). For a given nominal capacity, the overload capacity may also be compromised with respect to load cell arrangements having a plurality of flexures disposed in series between the load receiving beam and the measuring beam. This reduced overload capacity may be manifested as poorer durability and/or shorter product lifetime, with respect to load cell arrangements having a plurality of flexures disposed in series. Nonetheless, the overall performance of the single-flexure may compare favorably with conventional weighing apparatus and load cell arrangements. In any event, for this case, m+n=−1, which is the lowest value of m+n flexures for the present invention.

Moreover, there may be two or more spring arrangements for each loading element, disposed in parallel. Typically, and as described hereinbelow with respect to FIGS. 4A and 4B, the spring arrangement may include pairs of coupled flexures and coupled measuring beams.

Typically, there are 4 strain gages per loading beam. The strain gages may be configured in a Wheatstone bridge configuration, a configuration that is well known to those of skill in the art. The load cell system may further include a processing unit, such as a central processing unit (CPU). The processing unit may be configured to receive the load or strain signals (e.g., from 4 strain gages SG1-SG4) from each particular load cell and to produce a weight indication based on the load signals, as is known to those of ordinary skill in the art.

Referring collectively to FIGS. 3A and 3B, a load cell body 125 may be made from a block of load cell quality metal or alloy. Particularly advantageous embodiments employing particular magnesium alloys will be described hereinbelow.

Load cell body 125 may be fixed to a weighing assembly 10 via one or more mounting holes or elements 142. A 1^{st} contiguous cutout window 116 passes from a top face 110 through a bottom face 112, perpendicularly through the broad dimension (i.e., with respect to the other 2 dimensions of a three-dimensional Cartesian system) of load cell body 125. 1^{st} contiguous cutout window 116 may be generally C-shaped or U-shaped, and may have arms or a pair of cutout lines 118a, 118b running generally parallel to a central longitudinal axis 102 of load cell body 125, and connected or made contiguous by a cutout line or cutout base 118c. Both central longitudinal axis 102 and a transverse axis 104, disposed transversely thereto, run generally parallel to the broad dimension of load cell body 125. Both of these axes are oriented in perpendicular fashion with respect to a primary axis 114. The thickness (indicated by the arrow marked ‘t’ in FIG. 2B) of load cell body 125 perpendicular to primary axis 114 is typically within a range of 2 mm to 10 mm, and is designated W_{LCB}.

Long sides 105a and 105b of load cell body 125 run generally along, or parallel to, central longitudinal axis 102.

As shown, measuring beams or spring elements 107a and 107b are each disposed between respective cutout lines 118a and 118b, and respective long sides 105a and 105b of load cell body 125, distal to cutout lines 118a and 118b with respect to transverse axis 104. When planar load cell assembly 100 is disposed in a vertically loaded position, the free end of each of beams 107a and 107b may be held in a fixed relationship, substantially perpendicular to the vertical load, by an end block 124 disposed at a free end 123 of load cell body 125.

A 2^{nd} contiguous cutout window 126 also passes from top face 110 through bottom face 112, perpendicularly through the broad dimension of load cell body 125. 2^{nd} contiguous cutout window 126 may be generally C-shaped or U-shaped, and may have arms or a pair of cutout lines 128a, 128b running generally parallel to central longitudinal axis 102, and connected or made contiguous by a cutout line or cutout base 128c. 2^{nd} contiguous cutout window 126 may be enveloped on three sides by 1^{st} contiguous cutout window 116 (such that the 2^{nd} contiguous cutout window is transversely bounded by the 1^{st} contiguous cutout window). The orientation of 2^{nd} contiguous cutout window 126 may be 180° (i.e., generally opposite) with respect to 1^{st} contiguous cutout window 116.

A 3^{rd} contiguous cutout window 136 also passes from top face 110 through bottom face 112, perpendicularly through the broad dimension of load cell body 125. 3^{rd} contiguous cutout window 136 may be generally C-shaped or U-shaped, and may have arms or a pair of cutout lines 138a, 138b running generally parallel to central longitudinal axis 102, and connected or made contiguous by a cutout line or cutout base 138c. 3^{rd} contiguous cutout window 136 may be enveloped on three sides by 2^{nd} contiguous cutout window 126 (such that the 3^{rd} contiguous cutout window is transversely bounded by the 2^{nd} contiguous cutout window). The orientation of 3^{rd} contiguous cutout window 136 may be 180° (i.e., generally opposite) with respect to 2^{nd} contiguous cutout window 126 (and generally aligned with 1^{st} contiguous cutout window 116).

Load cell body 125 has a first flexure arrangement having a first pair of flexure beams 117a, 117b disposed along opposite sides of central longitudinal axis 102, and distal and generally parallel thereto. First pair of flexure beams 117a, 117b may be longitudinally disposed between the first pair of cutout lines and the second pair of cutout lines, and mechanically connected or coupled by a first flexure base 119.

Load cell body 125 has a second flexure arrangement having a second pair of flexure beams 127a, 127b disposed along opposite sides of central longitudinal axis 102, and distal and parallel thereto. Second pair of flexure beams 127a, 127b may be longitudinally disposed between the first pair of cutout lines and the second pair of cutout lines, and mechanically connected or coupled by a second flexure base 129.

Contiguous cutout window 136 defines a loading element 137 disposed therein. Loading element 137 is longitudinally defined by 3^{rd} pair of cutout lines 138a and 138b, and is connected to, and extends from, second flexure base 129.

The various cutout lines described above may typically have a width (W_{CO}) of 0.2 mm to 5 mm, and more typically, 0.2 mm to 2.5 mm, 0.2 mm to 2.0 mm, 0.2 mm to 1.5 mm, 0.2 mm to 1.0 mm, 0.2 mm to 0.7 mm, 0.2 mm to 0.5 mm, 0.3 mm to 5 mm, 0.3 mm to 2.5 mm, 0.3 mm to 2.0 mm, 0.3 mm to 1.5 mm, 0.3 mm to 1.0 mm, 0.3 mm to 0.7 mm, 0.3 mm to 0.6 mm, or 0.3 mm to 0.5 mm.

In some embodiments, the ratio of W_{CO} to W_{LCB} (W_{CO}/W_{LCB}) is at most 0.5, at most 0.4, at most 0.3, at most 0.25, at most 0.2, at most 0.15, at most 0.12, at most 0.10, at most 0.08, at most 0.06, or at most 0.05.

In some embodiments, the ratio of W_{CO} to W_{LCB} (W_{CO}/W_{LCB}) is within a range of 0.03 to 0.5, 0.03 to 0.4, 0.03 to 0.3, 0.03 to 0.2, 0.03 to 0.15, 0.03 to 0.10, 0.04 to 0.5, 0.04 to 0.4, 0.04 to 0.3, 0.04 to 0.2, 0.04 to 0.15, 0.04 to 0.10, 0.05 to 0.5, 0.05 to 0.4, 0.05 to 0.3, 0.05 to 0.2, 0.05 to 0.15, or 0.05 to 0.10. Loading element 137 may also include a hole 140, which may be a threaded hole, for receiving a load, e.g., for receiving or connecting to an upper, weighing platform, or for supporting a load, e.g., connecting to a base, leg, or support (disposed below load cell body 125) of a weighing system (described with respect to FIG. 7). Load-receiving hole 140 may be positioned at an intersection of central longitudinal axis 102 and transverse axis 104.

In the exemplary embodiment provided in FIGS. 4A and 4B, first and second flexure arrangements form a flexure arrangement 180, mechanically disposed between loading element 137 and measuring beams or spring elements 107a and 107b.

At least one strain gage, such as strain (or “strain-sensing”) gages 120, may be fixedly attached to a surface (typically a top or bottom surface) of each of measuring beams 107a and 107b. Strain gages 120 may be adapted and positioned to measure the strains caused by a force applied to the top of the “free” or “adaptive” side 123 of load cell body 125. When a vertical load acts on free end (i.e., an end unsupported by the base, as shown in FIG. 4) 123 of load cell body 125, load cell body 125 undergoes a slight deflection or distortion, with the bending beams assuming a double-bending configuration having an at least partial, and typically primarily or substantially, double-bending behavior. The distortion is measurably sensed by strain gages 120.

It may thus be seen that planar load cell assembly 100 is a particular case of a load cell assembly, having the load beam and spring arrangement of FIG. 3A. In this case, the number of intermediate flexures is 2, such that m and n both equal zero. In addition, the intermediate flexures are intermediate flexure beam pairs connected by a flexure base. Similarly, the measuring beams are connected at a first end by the fixed end of load cell body 125, and at the opposite end by adaptive end 124 of load cell body 125.

A load cell body 125 may be made from a block of load cell quality metal or alloy. For example, load cell quality aluminum is one conventional and suitable material. In some embodiments, the alloy may advantageously be a magnesium alloy, typically containing at least 85%, at least 90%, and in some cases, at least 92%, at least 95%, or at least 98% magnesium, by weight or by volume. The magnesium alloy should preferably be selected to have an elastic module (E) that is lower, and preferably, significantly lower, than that of aluminum.

Any planar load cell assembly disclosed herein or otherwise suitable for use in this invention is one with a ‘high’ ratio of width to thickness, where ‘width’ is the dimension across a plan view of the planar load cell assembly, for example the dimension indicated by the arrow marked with w in FIG. 3A, and thickness is the dimension across a side view, for example the dimension indicated by the arrow marked with t in FIG. 3B. Although the figures attached herewith are not necessarily drawn to scale, the exemplary load cell assembly of FIGS. 4A and 4B can be seen to have a width-to-thickness ratio of more than 10. In some embodiments, the ‘high’ width-to-thickness ratio can be more than 2, more than 3, more than 5, or more than 10.

It should be noted that with respect to embodiments disclosed herein in which it is indicated that a load cell assembly is anchored so as to be attached at least indirectly to a load cell base (which in an assembled configuration is below the load cell assembly), such an arrangement represents a non-limiting example cited for convenience, and in any such embodiment a load cell assembly can alternatively be anchored so as to be attached to a shelf or shelf tray (which in an assembly configuration is above the load cell assembly). These two structural options can provide the same functionality of providing shelf assemblies and shelving units with built-in weighing capabilities.

### Additional Weighing Assemblies Comprising Load Cell Assemblies

Additional non-limiting examples of weighing assemblies, comprising load cell assemblies and suitable for use in embodiments disclosed herein are now discussed.

Reference is now made to FIGS. 4A and 4B, which respectively, show an assembled weighing assembly 89 comprising two shelf brackets 12_{L} and 12_{R} according to embodiments of the present invention, and an exploded view of the weighing assembly. The weighing assembly 89 of FIGS. 4A and 4B is self-stabilizing, i.e., does not require the use of an additional stabilizing element or connection to a back wall of a shelving unit, and can be installed in a shelving unit (e.g., shelving unit 300) without any tools and by a single employee.

Substantially as shown, each of the two shelf brackets 12_{L} and 12_{R} may comprise a vertical member 21 which includes industry-standard bracket hooks 13 for engaging with uprights 85, and a horizontal member 22. Planar load cells 100 are fixed to the shelf bracket 12, in the same way as illustrated, e.g., in FIGS. 3A, 11A and 13, by anchoring them on a ‘base’ which, according to embodiments, can include the shelf bracket 12 and a shim (adapter plate) 130. As was discussed with reference to FIGS. 3B and 3C, mounting holes 142 are provided in load cell assembly 100, which line up with similarly-spaced shim holes 143. Thus, load cell assemblies 100A, 100B can be attached (by screw or rivet or any other appropriate attaching method) to a respective shim 130A, 130B and, in this way, complete the installation of the load cell assemblies on the ‘base’.

The two shelf brackets 12_{L} and 12_{R} are joined mechanically by a shelf frame 190 which, although illustrated as a simple frame, can include any member(s) that, when joined with the shelf brackets 12_{L} and 12_{R}, provide rigidity. The shelf frame 190 can be an ‘open structural member’ as shown in non-limiting example shown in FIG. 4B, as the ‘openness’ serves to reduce the weight and cost of the illustrated structural member, but this only is for purposes of illustration and the shelf frame need not be open if it is deemed desirable by a designer to use a solid, non-open member or assembly of members that provides structural rigidity at an acceptable weight and cost. Shelf frame 190 can be fabricated from any material such as a metal or a plastic deemed suitable in terms of rigidity, weight and cost.

As discussed earlier, protruding elements 51a, 51b, together with the joining elements 52a, 52b, can function to transfer the load (weight) of a shelf 90 and any products displayed thereupon to the load cell assemblies 100a, 100b. In embodiments, the protruding elements 51 can transfer the load directly by having a lower end positioned in a receptacle in the load cell assembly 100 and in other embodiments the protruding elements function to ensure the positioning of the joining elements 52 around the holes (140 in FIG. 4A) on the load cell assemblies 100 so as to transfer the load to the load cell assemblies 100 via the joining elements 52. In some embodiments, protruding elements 51 and joining elements 52 can be threaded (e.g., a threaded bolt and respective nut) and in other embodiments they can be unthreaded (e.g., a simple bolt and respective washer). In some embodiments both a threaded nut and a washer may be provided as shown in FIG. 4B. One of ordinary skill in the art will appreciate that various conventional arrangements can be employed for coupling the load (shelf 90) to the load cell assemblies 100a, 100b.

In the non-limiting example of FIG. 4B, a processor 161 is provided on-board the weighing assembly 89 in order to simplify communication with load cell assemblies. In the illustrated example, processor 161 is affixed to the shelf frame 190 with upper fasteners 165 and lower fasteners 163. A processor cover 162 can be provided, e.g., to protect the processor from dust, moisture or detritus, and spacers 164 may be used to isolate the processor from a metallic shelf frame 190.

Referring now to FIGS. 5A and 5B, an example of a shelf assembly 290 according to an embodiment is shown in both assembled and exploded views. A shelf assembly 290 is a type of weighing assembly that comprises a weighing base 299 and a shelf or shelf tray 291. The weighing base 299 can comprise a shelf base 295 and a plurality of load cell installation assemblies 101. In this example four load cell installation assemblies 101_{L1}, 101_{L2} (not shown, blocked by shelf tray 291), 101_{R1}, 101_{R2} are provided, but a higher or lower number of load cell installation assemblies can be provided while meeting the design goal of providing accurate weight indications of products 70 on a shelf assembly 290 or added thereto or removed therefrom. The shelf tray 291 can include a receiving bracket (not shown) for securing and stabilizing a shelf tray 291 on a weighing base 299. In some embodiments a shelf tray 291 can be attached in other ways to a weighing bracket 299. A plurality of prior-art protruding elements 251 and a plurality of joining elements 252 vertically aligned with respective protruding elements 251 for receiving the respective protruding elements 251 can be provided for transferring load to the load cell assemblies 100. It should be noted that the number of respective protruding elements 251 and joining elements 252 will be the same as the number of load cell assemblies 100 for any given shelf assembly 290. For, example, in the non-limiting example shown in FIG. 4B, the number of load cell assemblies 100 (of load cell installation assemblies 101) is four, and thus four respective protruding elements 251 and four joining elements 252 are used.

It should be noted that use of the term ‘shelf tray’ should not be taken to literally mean a tray, e.g., as illustrated in the non-limiting example of FIGS. 5A and 5B wherein shelf tray 291 includes tray rim 292. Front flange 294 of shelf tray 291 is optional and has both aesthetic and functional purposes, e.g., obscuring the shelf base 295, the load cell installation assemblies 101 and the miscellaneous elements that might be provided for attachments. In other embodiments, shelf tray 291 can be flat without a tray rim 292, and if additional structural support is necessary for the shelf tray 291, e.g., to resist twisting or bending, it is possible to apply other engineering solutions for strengthening the structure.

Still referring to FIGS. 5A and 5B, a shelf assembly 290 can comprise attachment arrangements or points 286 which mate with attachment elements 285 of side walls 281 and/or back wall 280 of shelving unit 200. If attachment elements 285 comprise holes or recesses, then attachment points 286 can comprise protruding members such as hooks or knobs or similar, and vice versa—if attachment elements 285 comprise protruding members such as hooks or knobs, then attachment points 286 can comprise corresponding recesses or holes. Shelf assembly 290 preferably extends from left wall 281_{L} to right wall 281_{R} such that attachment points on the two sides can mate with attachment elements 285 or attachment components 289 that are joined to the attachment elements 285. In some embodiments, shelf assembly 290 has a width that is at least 80% or at least 90% or at least 95% of the distance between left wall 281_{L} and right wall 281_{R}. According to embodiments, there is only a single shelf assembly 290 at any given height in shelving unit 220.

We now refer to FIGS. 5C-E.

A shelf assembly 390 for a refrigerator includes a weighing base 195 and a shelf 391. The shelf 391 can include a peripheral rim 292 to reduce the likelihood that a product leans against the internal wall of the refrigerator 200, which would reduce the force measurable on the shelf 391. Weighing base 195 includes opposing load-cell bases 191_{L}, 191_{R} detachedly attachable to respective left and right internal walls of the refrigerator. As shown in FIG. 5E, the bottom of the weighing base 195 (and therefore the bottom of the shelf assembly 390) includes attachment arrangements 286. Each of the load-cell bases 191 includes a plurality of load cells 101 (of any type, not necessarily planar load cells). Thus, there are at least two load cells 101 on each side, or at least 4 load cells for each weighing base 195. The two load-cell bases 191 are joined to form a rigid, e.g., stable, resistant to twisting, and/or not flexible, frame. A single-member beam 190 is shown as joining the two load-cell bases 191 but any appropriate design and number of left-to-right beams can be used. The beam can be used to support electronic communication arrangements 60, for example transmitted via a communications channel 61, as shown in FIG. 5D. In some embodiments, the load-cell bases 191 and/or the beam are covered with covers 192. It can be desirable for the weighing base 195 to allow at least a minimum amount of vertical airflow to flow freely within the interior of the refrigerator/shelving unit 200, and for this purpose a portion of the horizontal surface of the weighing base 195 can be ‘open’ to a vertical airflow, the term ‘vertical’ meaning any airflow within the refrigerator, which in many implementations is vertical or predominantly vertical, e.g., within ±100 of vertical, or within ±200 of vertical, or within ±300 of vertical, or within ±400 of vertical, or within ±450 of vertical. Preferably, at least 25% of the horizontal surface area of the weighing base 195 to vertical airflow, or at least 30%, or at least 35%, or at least 40%, or at least 45%, or at least 50%. In some embodiments, as much as 80% or as much as 70% or as much as 60% of the horizontal surface area of the weighing base 195 can be open to vertical airflow.

The horizontal area of the shelf 391 is also at least partly open to vertical airflow. In embodiments, the horizontal surface area of the shelf 391 can be at least 40% open or at least 50% open or at least 60% open or at least 70% open or at least 80% open or at least 90% open. In embodiments, the shelf 391 can utilize a wire grid design. A wire grid design is mostly open, and airflow passing through the open horizontal areas of the weighing base 195 is not be substantially blocked by the wires of the grid, which generally create minor turbulence as the air passes therethrough without a substantial pressure drop. In some embodiments, a wire-grid shelf can include both thinner wires, e.g., front-to-back wires deployed across the shelf 391 for supporting products, and thicker wires, e.g., left-to-right wires for structural support. As shown in FIG. 5C, left-to-right wires 395 are spaced so as to transmit force, e.g., the weight of the shelf and of products displayed thereupon, to the load cells assemblies 101 in the load-cell bases 191. Thus, the load cell assemblies 101 mediate between the weighing base 195 and the shelf 391, and the shelf 391 does not sit directly on the weighing base 195 or on the cover 192. The left-to-right wires 395 are illustrated in FIG. 5D as being thicker than the front-to-back wires, but in other examples they can all be the same thickness and weight. The skilled artisan will understand that a selection criterion for the left-to-right wires is sufficient rigidity, e.g., resistance to twisting, sagging, etc.

Referring now to FIG. 6, a block diagram is shown of a system for tracking a non-homogeneous assortment of products 70 on a shelf 90. The system 500 can include a plurality of load cell assemblies 101 that are in contact with a shelf 90, which as explained above can support a variety of products 70. The system can also include one or more computer processors 66 and at least one non-transient computer-readable storage medium 68, e.g., a mechanical, optical and/or solid-state storage device or a storage device using whatever data storage technology is suitable for the purpose. The one or more computer processors 66 can optionally be included in a computing device 65 that can be a component of the system 500 and which can optionally include other computer hardware such as communications gear 61, a display device 62, and user input accessories (not shown), such as a keyboard and a mouse. The storage medium 68 can include program instructions 50, as well as weight distribution mappings repository 51, a product database 67 and product positioning plan 69, all of which are discussed elsewhere in this disclosure.

Transmissions of electronic signals from load cell assemblies 101 can be received by the one or more computer processors 66, for example by way of communications gear 61 and used for the purpose of tracking the weights of products 70 on the shelf 90, and especially of actions taken to products. Communications gear 61 can include any kind of wired or wireless communications arrangements, including, without limitation, direct connections, networked connections and internet connections. Actions include adding a product to a shelf, removing a product from a shelf, and moving a product from one place on a shelf to another. If the moving the product includes lifting the product and putting it back down on the same shelf, it may be interpreted as a removal followed by an adding depending on the speed of the actions and the sampling rate of the weight measurement data, e.g., the number of weight measurement data points per second. On the other hand, sliding a product from one place to another on the shelf might not change, at any given moment, the total weight measured by all of the load cell assemblies associated with a single shelf, but can change the weights measured by each of the individual load cell assemblies.

Electronic signals transmitted by the load cell assemblies, containing streams of weight measurement data points, can be monitored in order to track the weights of the products and the actions taken with respect thereto. Weight measurement data points from all of the load cell assemblies associated with a single shelf can be aggregated so as to track the total combined weight of the shelf and any products thereupon. This means synchronizing the streams of data points, i.e., aggregating the weight measurement data points means aggregating, for all load cell assemblies (for a single shelf) for each point in time. In some embodiments, there are four weighing assembly provided for each shelf, with each load cell assembly being proximate to one of the four respective corners of the shelf.

An individual load cell assembly 101 according to the various embodiments, returns and transmits a value that is less than the total combined weight of a shelf 90 and products arranged thereupon. The skilled artisan will appreciate that the combined weight is distributed amongst the various load cell assemblies 101 of the shelf 90, and the weight measurement data points across all load cell assemblies 101 for a single shelf 90 add up to the actual combined weight. The distribution of weight to the plurality of load cell assemblies 101 can be related to (i) the relative position of the center of weight of each product 70, (ii) any non-uniformities in the make-up or structure of the shelf 90, and (iii) any angle of displacement that may exist between the shelf 90 and a horizontal plane. For the purposes of the various embodiments and examples described in this disclosure, the relative position on the shelf is the factor generally discussed so as to simplify the discussion, but in each case, other factors such as non-uniformities and/or angle of displacement can also be considered as being important, even if not explicitly mentioned.

In embodiments, at least four load cell assemblies are employed per shelf, with appropriate spacing. The inventors have discovered that four load cell assemblies provide an optimal point that trades off accuracy of mapping with cost and complexity. Obviously, it is possible to deploy a load cell every few inches on an x-y grid, and thus achieve mapping at very high resolution, but at very high cost of both components and necessary processing power (including processing time which may exceed the time reasonably available for performing updated mapping for each product-weight event). The deployment of exactly four load cell assemblies has been found to yield mapping and determination of product-weight events with sufficient resolution and accuracy to satisfy the demands of real-time retail transactions, in a cost-effective manner that allows efficient processing of weight signals and other data sources in real-time. The four load cell assemblies can be suitably deployed at or close to the respective four corners of a shelf. In embodiments, ‘close to’ can mean within 2 cm, or within 5 cm, or within 10 cm, or within 15 cm, or within 20 cm of a corner. The placement of four load cells at the corners of a shelf is embodied in FIGS. 10 and 11, as will be discussed hereinbelow.

### Discussion of a First Method

A first method for tracking non-homogeneous products on a shelf, according to embodiments of the present invention, is disclosed herein. According to the method, the tracking is done using weight data, and the method does not require, and does not incorporate, the use of any non-weight sensors such as optical scanners or cameras. A flow chart of the method is shown in FIG. 7. According to the method, a plurality of load cell assemblies 101 is jointly operable to measure the combined weights of the shelf 90 and any and all products 70 arranged thereupon.

The method, as shown in FIG. 7, comprises:

Step S61: monitoring electronic signals transmitted by weighing assemblies. Each electronic signal is from a different load cell assembly 101, and includes a respective stream of weight measurement data points. The weight measurement data points correspond to the weight of the shelf and the products arranged thereupon and, as mentioned earlier, each point reflects a portion of the total weight that is distributed among all of the load cell assemblies 101. The monitoring of the signals includes assessing the values, for example to detect changes in the weights over time, e.g., a difference between a first weight measurement data point at a first time and a second weight measurement data point at a second time, that can be indicative of an action taken with respect to a product.

Step S62: determining a set of weight-event parameters of a weight event. The determining is carried out in response to a change in values, over time, i.e., from one time point to another (not necessarily a consecutive time point) in weight measurement data. The determining can be carried out in response to such a change in values being greater than a given threshold, or that the absolute value of the change is greater than a given threshold. A weight event is an event in which an action is taken with respect to a product so as to change the weight or weight distribution of products on a shelf. Weight-event parameters include a product identification (or identification of more than one product involved in a single weight event, if appropriate) and an action taken with respect to the identified product (or products). A set of weight-event parameters can include a single product and a single action, or one or more products each associated with one or more actions. The determining can be probabilistic. Uncertainties in carrying out the method can mean that the determining selects the most likely set of weight-event parameters for a weight event. For example, the result of a determining can that that product #1 70₁ being added to a shelf 90 is the ‘most likely’ explanation for a detected change in weight measurement data, as opposed to product #2 70₂ being added or product #3 being added, both of which can be alternative but ultimately less likely candidates for the determining. The uncertainties can stem from any number of sources, including, for example, inaccuracy of the weighing assemblies or unresolved noise and/or drift in the stream of data points. An additional source of uncertainty can include the time it takes for a measurement made by weighing assembly to stabilize (e.g., as a function of the elasticity of a load cell component or of the shelf itself), combined with a system requirement to resolve the weight-event parameters within a limited amount of time, such that an actual total change in weight might not be captured because of a time constraint or other limitation. Other sources of uncertainty will be enumerated later in this discussion where relevant.

As shown in the flowchart of the method in FIG. 7, Step S62 includes five sub-steps, as follows:

Step S62-1: aggregating changes in weight measurement data for all weight assemblies 10. As used herein, ‘aggregating’ has the meaning of ‘summing’. As discussed earlier, changes in weight measurement data are aggregated for each specific point in time; the aggregation can be for every point in time in a specific time interval or for all points in time as long as the monitoring of Step S61 continues, or for each determining; or for points in time selected according to a given periodicity or selected randomly; the only requirement is that aggregated data all correspond to a given point in time and therefore the streams are preferably synchronized.

Step S62-2: mapping a change in weight distribution on the shelf 90. A weight of a product placed on the shelf (for example) is distributed to all of the weighing assemblies of a shelf so that the aggregate of the increment in measurements made by all of the weighing assemblies equals the total incremental weight of the product; this step solves for the magnitude and location of the weight of the product placed on the shelf (i.e., or removed from the shelf or moved along the shelf) given the individual weight measurement data of the various weighing assemblies. In some embodiments the mapping can be deterministic, producing a single answer for the magnitude of the weight added/removed/moved and the coordinates of the center of weight of that weight. In other embodiments, the mapping can be probabilistic. For example, instead of mapping to a single weight center (X, Y), the mapping of product weight to x,y coordinates can be considered to have a probabilistic distribution (e.g., a density function). The probabilistic function can take into account, for example, unknowns with regards to the uniformity of the make-up or structure of the shelf, or with regards to possible angular displacement of the shelf from horizontal. It can also take into account inaccuracies in one or more of the weighing assemblies. Using a non-deterministic result out of the mapping sub-step can be another source in uncertainty in the overall determining step. In some embodiments the result of this mapping step can be stored in a repository of weight distribution mappings 51 in computer-readable storage medium 68.

Step S62-3: identifying at least one candidate set of weight-event parameters for the weight event. In this step, product data for reference can be accessed or retrieved from a product database 67 which can include, inter alia, baseline weights for products as well as ranges and distributions of possible and/or historical weights for products. Data for reference can be accessed or retrieved from a product positioning plan 69 (a planogram). The identifying includes matching a weight added/removed/moved (‘the event weight’) in Step S63-2 with the weight of a product according to data in the product database 67 and/or appearing in the planogram. The matching can return a single deterministic answer or can return an answer consisting of one or more products that may match the event weight, or come close with varying levels of probability. Probability may be assigned according to a wide variety of factors, some of which are illustrated in the following examples:

In an example, two products in the product database both have a weight matching the event weight, but only one of them is in the planogram for the shelf in question. While both products are identified in candidate sets of weight-event parameters, the one appearing in the planogram is assigned a higher probability.

In another example, two products in the product database both have a weight matching the event weight, but they appear in the planogram as belonging on other shelves. One belongs, according to the planogram, on a nearby shelf, while the other appears on a far-away shelf. While both products are identified in candidate sets of weight-event parameters, the one appearing in the planogram on a closer shelf is assigned a higher probability.

In another example, two products appearing in the product database and in the planogram have a weight matching the event weight, and the weight event is an addition to the shelf. The first product was identified with a ‘removal’ weight-event from the same shelf ten minutes earlier, and the second product was identified with a ‘removal’ event five minutes earlier. While both products are identified in candidate sets of weight-event parameters, the one identified in a removal weight event five minutes earlier is assigned a higher probability.

In another example, the aggregated change in weight on the shelf was 500 grams. A first product appearing in the planogram for that shelf weighs 50 grams more, according to the product database, and a second product weighs 30 grams less. While both products are identified in candidate sets of weight-event parameters, the product weighing 30 grams less is assigned a higher probability. In another example, the second product weighing 30 grams less ‘belongs’ on the left side of the shelf according to the planogram and the first product weighing 50 grams more belongs on the right side; according to the mapping of weight distribution in Step S72-02, the weight-center of the weight added or removed was closer to the right side, and the product weighing 50 grams more is assigned a higher probability.

In another example, two products appearing in the product database and in the planogram have a weight matching the event weight, and the weight event is a removal from the shelf. The first product has a sales rate of one can per week, and the second product has a sales rate of five cans per week. While both products are identified in candidate sets of weight-event parameters, the product with the higher sales rate is assigned a higher probability.

In yet another example, two products appearing in the product database and in the planogram have a weight matching the event weight, and the weight event is a removal from the shelf. The first product is ‘on sale’ this week at a 20% discount, and while both products are identified in candidate sets of weight-event parameters, the product with discount is assigned a higher probability.

In some embodiments, an assigned probability can be calculated using a probability distribution function. A probability distribution function can be pre-programmed based on hypothetical data and/or empirical data. A probability distribution function can be derived using a machine learning algorithm applied to historical weight data for a product.

In an illustrative example, two products appearing in the product database and in the planogram have a weight within three grams on either side of the event weight, and the weight event is a removal from the shelf. Associated with the first of the two product is a history of being 10 grams heavy 20 percent of the time and 5 grams heavy 30 percent of the time. The rest of the time, the product weight is within 2 grams either way of the baseline weight (e.g., the nominal, mean or median weight, or the ‘listed’ weight in the product database). Associated with the second of the two products is a history of being 10 grams heavy 5 percent of the time and within 3 grams either way of the baseline weight the remainder of the time. A probability distribution function derived using a machine learning algorithm applied to the respective historical weight data (a simplified version of which is presented in the foregoing example) for each of the two products assigns a higher probability to the second product. Nonetheless, both products are identified in candidate sets of weight-event parameters. The skilled artisan will appreciate that the machine learning algorithm selected for deriving probability distribution functions for product weights and calculating probabilities therefrom can be any of those known in the art and suited to the historical product-weight data, such as, for example and non-exhaustively: Linear Regression, Logistic Regression, Decision Tree, SVM, Naive Bayes, kNN, K-Means and Random Forest.

The skilled artisan will appreciate that any of the factors involved in the foregoing examples of assigning probabilities can be combined in any way, along with other intrinsic and extrinsic factors that can affect the assigning of probabilities.

Step S62-4: assigning an event likeliness score to each candidate set identified in Step S62-3. The foregoing discussion with respect to Step S62-3 included assigning probabilities to candidate sets of weight-event parameters, the assigning of an event likeliness score takes other factors into account as well, in addition to the probabilities assigned in Step S62-3. The ‘other factors’ can include the uncertainties discussed earlier including factors related to the weight measurement data, to noise and drift, to the uncertainty in mapping the weight distribution on the shelf, and so on. Thus, a final event likeliness score is assigned to each candidate set of weight-event parameters, so as to account for all of the uncertainty introduced in the various steps of the method.

Step S62-5: selecting the set of candidate weight-event parameters having the highest event likeliness score assigned in Step S62-4. The result of the ‘selecting’ in the last sub-step of Step S62 is therefore the result of the ‘determining’.

Step S63: recording or displaying information about the results of the selection of Step S62-5. The results of the selecting (i.e., of the determining) can be recorded, for example in the non-transient computer-readable storage medium 68, or in a similar storage medium in another location, for example in the ‘cloud’, where the results are transmitted via an internet connection. The results, alternatively or additionally, can be displayed on a display device, such as display device 62 or on another display device, which, for purposes of illustration, can be one intended to convey information to a customer of an unattended retail arrangement, or the screen of an inventory clerk in a storage warehouse.

Any of the steps of the method can be carried out by the one or more computer processors 66. In some embodiments, not all of the steps of the method are necessarily carried out. In some embodiments, a system, e.g., the system 500 shown in FIG. 6, can be for tracking non-homogeneous products on a shelf and can comprise a plurality of load cell assemblies 101, one or more computer processors 66, and a computer-readable storage medium 68 containing program instructions 50 which, when executed by the one or more processors 66, can cause the one or more processors 66 to carry out the steps of the foregoing method.

### Discussion of a Second Method

A second method for tracking non-homogeneous products on a shelf, according to embodiments of the present invention, is disclosed herein. According to the method, the tracking is done using weight data, and the method does not require, and does not incorporate, the use of any non-weight sensors such as optical scanners or cameras. A flow chart of the method is shown in FIG. 8. According to the method, a plurality of load cell assemblies 101 is jointly operable to measure the combined weights of the shelf 90 and any and all products 70 arranged thereupon.

The method, as shown in FIG. 8, comprises:

Step S71: monitoring electronic signals transmitted by weighing assemblies 10; this is the same method step as Step S61 in the ‘first method’ discussed above.

Step S72: analyzing streams of weight measurement data points to detect noise and drift. The analyzing is carried in response to finding, during the monitoring of Step S71, changes in values of the weight measurement data points. Specifically, the data points and the changes in value are analyzed for the presence either or both of the two anomalous phenomena of noise and drift. Noise for the purposes of this disclosure comprises high-frequency, i.e., short-lived, changes in values of weight measurement data points in a stream of such data points transmitted by the weighing assemblies. For example, noise can include spikes in value, which can be either ‘plus’ or ‘minus’ with respect to the baseline values, and which are substantially reversed (meaning at least 80% reversed, at least 90% reversed, at least 95% reversed, or at least 99% reversed) within less than 10 seconds after the spike begins, or within less than 5 seconds or within 1 second after the spike begins. In some embodiments, the source of noise can be mechanical and/or environmental. For example, noise can be caused by the vibration of an air conditioning condenser. Noise can be caused by simple mechanical events, such as a customer or employee touching a shelf or a product on the shelf. Drift for the purposes of this disclosure is a low-frequency, i.e., long-lived, change in weight measurement values, usually changes that are relatively minor in magnitude. Examples of causes of drift are daily cycles of indoor temperatures, environmental conditions such as humidity and atmospheric pressure, and artifacts of a power supply. Unlike what is termed herein noise, drift is not quickly reversed, because it is generally caused by a persistent and/or repeating condition. In some embodiments, drift is periodic; for example, the same pattern or trend can repeat itself every day at a certain time, or at the start of every work shift, or even in on an annual cycle in line with seasonal changes in the environment.

Step S73 at least partially filtering out or compensating for the noise and/or drift detected in Step S72. Noise and/or drift can mask true changes in weight embodied in the values of the weight measurement data points. Noise and/or drift can also affect the resolution and disambiguation of products and actions (weight-event parameters) by adding uncertainty and skewing probabilities. Therefore, it can be advantageous to filter out, or compensate for, noise and/or drift, at least partially. As is known in the art, a signal can commonly be decomposed into its component frequencies using a Fourier transform. Carrying out this step results in revised weight measurement data that can be generated as a result of the filtering out and/or compensating for noise and drift.

Step S74 determining a set of weight-event parameters of a weight event. As with the Step S62 determining step, the determining is carried out in response to a change in values, over time, i.e., from one time point to another (not necessarily a consecutive time point) in weight measurement data. The determining can be carried out in response to such a change in values being greater than a given threshold, or that the absolute value of the change is greater than a given threshold. A weight event is an event in which an action is taken with respect to a product. The weight-event parameters include a product identification (or identification of more than product involved in a single weight event, if appropriate) and an action taken with respect to the identified product (or products). A set of weight-event parameters can include a single product and a single action, or one or more products each associated with one or more actions.

As shown in the flowchart of the method in FIG. 8, Step S74 includes two sub-steps, as follows:

Step S74-1 remapping a revised weight distribution on the shelf 70. The remapping is somewhat similar to the mapping of S62-2 in that it involves solving for the magnitude and location of the weight of the product placed on the shelf or removed from the shelf or moved along the shelf, given the individual weight measurement data of the various weighing assemblies. However, in this case, the remapping is based on the change in values in the revised weight measurement data that was generated in Step S73, and not in the original weight measurement data transmitted by the load cell assemblies 101. The remapping is also based on an earlier mapping of weight distribution on the shelf, which can be accessed and retrieved from a repository of weight distribution mappings 51 in computer-readable storage medium 68. The earlier mapping can be the most recent mapping made in the case of a weight event, or it can be a mapping from a previous weight event. For example, to avoid processor overhead, a mapping can be stored only every third mapping or every fifth mapping, and so on. The remapping is also based on product-weight data accessed or retrieved from the product database 67.

Step S14-2 assigning a set of weight-event parameters based on the remapping of Step S14-1. This step is carried out using the results of the remapping of Step S14-1 to determine the weight-event parameters of a weight-event.

Step S15 recording or display information about the results of the assigning of Step S14-2. Other than the use of the term ‘assigning’ instead of ‘selecting’, this step is identical to Step S63 of the first method.

Any of the steps of the method can be carried out by the one or more computer processors 66. In some embodiments, not all of the steps of the method are necessarily carried out. In some embodiments, a system, e.g., the system 500 shown in FIG. 6, can be for tracking non-homogeneous products on a shelf and can comprise a plurality of load cell assemblies 101, one or more computer processors 66, and a computer-readable storage medium 68 containing program instructions 50 which, when executed by the one or more processors 66, can cause the one or more processors 66 to carry out the steps of the foregoing method.

In some embodiments, the entire determining step S14 can be replaced with determining step S62 so as to combine, inter alia, the noise and drift filtering and compensation features of the second method with, inter alia, the probability-calculation and machine learning features of the first method. In some embodiments, the program instructions 50 of system 500 can be modified so as to combine the steps of the two foregoing methods in the same way.

### Discussion of a Third Method

A method of mapping the weight distribution of a non-homogeneous plurality of products on a shelf, according to embodiments of the present invention, is disclosed herein. According to the method, the mapping is done using weight data, and the method does not require, and does not incorporate, the use of any non-weight sensors such as optical scanners or cameras. A flow chart of the method is shown in FIG. 9.

The method, as shown in FIG. 9, comprises:

Step S71 receiving synchronized data streams of weight measurement data points from load cell assemblies 101. Each of the weight measurement data points represents a proper fraction (i.e., between 0 and 1) of the total combined weight of the shelf and of any products arranged thereupon, and the sum of the proper fractions represented by the weight measurement data points from all of the load cell assemblies 101 for any given time is equal to one.

Step S72 accessing an earlier mapping of the weight distribution of products 70 on the shelf 90, which can be accessed and retrieved from a repository of weight distribution mappings 51 in computer-readable storage medium 68. The earlier mapping can be the most recent mapping made in the case of a weight event, or it can be a mapping from a previous weight event. For example, to avoid processor overhead, a mapping can be stored only every third mapping or every fifth mapping, and so on. The remapping is also based on product-weight data accessed or retrieved from the product database 67.

Step S73 remapping the weight distribution of products 70 on the shelf 90 using a comparison with an earlier mapping accessed in Step S72, and in accordance with a first mapping rule that applies a mathematical function for weight distribution.

An example of a first mapping rule is a mapping rule that distribution of weight to weighing assemblies includes application of a linear function. An example of such a linear function is illustrated in FIG. 10, where the linear function is such that on a shelf 90 defining an x-y plane and having an origin at (0,0) and the diagonally opposite corner at (1,1), addition of a product on the shelf with weight of W and weight-center coordinates of (X,Y) causes weighing assemblies at (0,0), (0,1), (1,1), (1,0) to transmit respective weight measurement data points incremented by (1−X)*(1−Y)*W, (1−X)*Y*W, X*Y*W, X*(1−Y)*W. Obviously, removal of the same product from the same coordinate would cause the same weighing assemblies to transmit respective weight measurement data points decremented by the same respective values.

Another example of a first mapping rule that the weight distribution of a product on a shelf is mapped from the weight measurement data points using a probability density function. An example of such a function is illustrated in FIG. 11, where the distribution function is such that on a shelf defining an x-y plane each product is represented in the remapped weight distribution at multiple (x,y) points. The probability density function can be, as in the example shown in FIG. 11, is a bivariate normal distribution such that the multiple (x,y) points are distributed according to a first normal distribution on the x-axis and according to a second normal distribution on the y-axis.

The remapping of Step S73 can also be in accordance with a second mapping rule. An example of a second mapping rule is that the remapping uses weight measurement data points corresponding to a time interval that is constrained. For example, the time interval can be constrained with respect to the ‘stabilization time’ of a shelf 90 and load cell assemblies 101 following a weight event. Stabilization time can be a function of a mechanical parameter, such as elasticity, of the shelf 90 and/or the load cell assemblies 101 or of a component thereof. The time interval can be constrained, for example, to end when differences between successive periodically accessed values (i.e., consecutive values or every nth value for any integer n) of weight measurement data points in a data stream fall below a predetermined threshold, meaning that the measurements are stabilizing. In some embodiments, the time interval is constrained to a pre-determined length of time. The pre-determined length of time can be calculated in advance from empirical or theoretical valuation of stabilization time based on a mechanical parameter of the shelf 90 or of the load cell assemblies 101 (or of a component thereof). Alternatively, the pre-determined length of the time interval can be based on a typical time between weight events caused by a shelf stocker or other employee, or by a customer.

In some embodiments, the remapping of Step S23 is additionally carried out on the basis of information accessed from a product positioning plan 69.

Any of the steps of the method can be carried out by the one or more computer processors 66. In some embodiments, not all of the steps of the method are necessarily carried out. In some embodiments, a system, e.g., the system 500 shown in FIG. 6, can be for mapping the weight distribution of a non-homogeneous plurality of products on a shelf and can comprise a plurality of load cell assemblies 101, one or more computer processors 66, and a computer-readable storage medium 68 containing program instructions 50 which, when executed by the one or more processors 66, can cause the one or more processors 66 to carry out the steps of the foregoing method.

In some embodiments, the method can be combined with either of the first two method, for example by replacing Step S62-2 of the first method with Steps S22 and S23 so as to combine, inter alia, the rule-based mapping features of the third method with the features of the first method. As another example, Step S74-1 of the second method can be replaced with Steps S22 and S23 so as to combine, inter alia, the rule-based mapping features of the third method with the features of the second method.

In some embodiments, the program instructions 50 of system 500 can be modified so as to combine the steps of the methods in the same way.

Referring again to FIG. 6, the results of carrying out any of the methods or program instruction steps disclosed herein by a system 500 can be communicated, using communications arrangements 60, to either or both of a retail sales transaction system 401 and an inventory tracking system 402 for further processing. Communications arrangements 60 can include wired or wireless communications, through any kind of dedicated connection or network connection or internet-based connection, as are known in the art.

### Inventive Concepts

The present disclosure includes, inter alia, the following Inventive Concepts, numbered 1-50 for convenient reference.

Inventive Concept 1. A weighing assembly for weighing a shelf, the weighing assembly comprising: (a) a shelf bracket comprising a horizontal member configured to support the shelf in an x-z plane that is parallel to a floor, and a first vertical member in a y-z plane orthogonal to the x-z plane, and (b) a load cell assembly fixedly attached to the horizontal member so as to mediate between the horizontal member and the shelf, the load cell assembly comprising: (i) a load cell body having a free end and an anchored portion, the load cell body including a spring element and at least one receiving element, and (ii) a strain-sensing gage, bonded to the spring element, the strain-sensing gage adapted to measure a strain in the spring element, wherein, in an assembled configuration, (i) the load cell body is attached to the horizontal member at the anchored portion of the load cell body, and (ii) the at least one receiving element is adapted to receive a vertical load from the shelf, the receiving element has (A) an unloaded disposition, and (B) a loaded disposition in which the at least one receiving element receives the vertical load, wherein in the loaded disposition, the free end attains a depressed position with respect to the free end in the unloaded disposition.

Inventive Concept 2. The weighing assembly of Inventive Concept 1, wherein: (i) the load cell body has a primary axis, a central longitudinal axis, and a transverse axis disposed transversely with respect to the primary and central longitudinal axes, a broad dimension of the load cell body being disposed perpendicular to the primary axis, and (ii) the load cell body includes: (A). a first contiguous cutout window passing through the broad dimension and formed by a first pair of cutout lines disposed generally parallel to the central longitudinal axis, and connected by a first cutout base, (B). a second contiguous cutout window passing through the broad dimension and formed by a second pair of cutout lines disposed generally parallel to the central longitudinal axis, and connected by a second cutout base, the second contiguous cutout window being transversely bounded by the first contiguous cutout window, (C). a pair of measuring beams disposed along opposite edges of the load cell body and generally parallel to the central longitudinal axis, each of the measuring beams longitudinally defined by a respective cutout line of the first pair of cutout lines, (D) a first flexure arrangement having a first pair of flexure beams, disposed along opposite sides of the central longitudinal axis, and generally parallel thereto, the first pair of flexure beams longitudinally disposed between the first pair of cutout lines and the second pair of cutout lines, and mechanically connected by a first flexure base, and (E) a loading element, longitudinally defined by an innermost pair of cutout lines, comprising a receiving element and extending from an innermost flexure base, the transverse axis passing through the loading element.

Inventive Concept 3. The weighing assembly of Inventive Concept 2, wherein the load cell body additionally includes: (F) a third contiguous cutout window passing through the broad dimension and formed by a third pair of cutout lines disposed parallel to the central longitudinal axis, and connected by a third cutout base, and (G) a second flexure arrangement having a second pair of flexure beams, disposed along opposite sides of the central longitudinal axis, and parallel thereto, the second pair of flexure beams longitudinally disposed between the second pair of cutout lines and the third pair of cutout lines, and mechanically connected by a second flexure base, wherein the loading element is longitudinally defined by the third pair of cutout lines, and extending from the second flexure base.

Inventive Concept 4. The weighing assembly of Inventive Concept 1, wherein the load cell assembly comprises a double ended load cell.

Inventive Concept 5. The weighing assembly of Inventive Concept 1, wherein the at least one strain-sensing gage is associated with a processing unit configured to receive strain signals therefrom, and to produce a weight indication based on the strain signals.

Inventive Concept 6. A shelving arrangement comprising: (a) a back panel; (b) first and second uprights associated with the back panel; (c) first and second weighing assemblies according to Inventive Concept 1, adapted for being removably mounted to respective the first and second uprights, wherein (i) each of the weighing assemblies comprises a respective second vertical member in an x-y plane that is parallel to the back panel and orthogonal to both the x-z plane and the y-z plane, and (ii) the first and second weighing assemblies are mirror images of each other relative to respective the first vertical members; and (d) a shelf disposed to be in at least indirect contact with both respective load cell assemblies of the first and second weighing assemblies.

Inventive Concept 7. The shelving arrangement of Inventive Concept 6, additionally comprising first and second connecting elements passing through the back panel so as to join respective the vertical members to corresponding bracket-stabilization elements disposed on a reverse side of the back panel.

Inventive Concept 8. The shelving arrangement of Inventive Concept 7, wherein the bracket-stabilization element disposed on the opposite side of the back panel is a respective stabilization member of another shelf bracket.

Inventive Concept 9. The shelving arrangement of Inventive Concept 6, comprising a communications arrangement for sending information about the weight indication to a computing device.

Inventive Concept 10. The shelving arrangement of Inventive Concept 9, additionally comprising the computing device, wherein the computing device includes a software module for determining, based on the information, that a product has been added to or removed from a shelf.

Inventive Concept 11. The shelving arrangement of Inventive Concept 10, wherein the product is a member of a group of non-homogeneous products, and the determining by the software module additionally includes identifying the product that has been added or removed from the shelf.

Inventive Concept 12. The shelving arrangement of Inventive Concept 11, wherein the group of non-homogeneous products is characterized by a plurality of SKU-identifiers, and the identifying includes identifying a SKU-identifier.

Inventive Concept 13. The shelving arrangement of Inventive Concept 11, wherein the result of the determining by the software module is further used to perform at least one of a retail sales transaction and an inventory adjustment in a computerized inventory system.

Inventive Concept 14. A weighing-assembly unit, comprising: (a) first and second weighing assemblies according to Inventive Concept 1; and (b) a shelf frame or at least one beam member joining respective the shelf brackets of the first and second weighing assemblies so as to form, in combination therewith, a rigid shelf frame.

Inventive Concept 15. The weighing-assembly unit of Inventive Concept 14, additionally comprising a shelf installed upon an upward-facing surface of the rigid shelf frame, the shelf disposed to be in at least indirect contact with the respective load cell assemblies of the first and second weighing assemblies.

Inventive Concept 16. A shelving arrangement comprising: (a) a back panel; (b) first and second uprights associated with the back panel; and (c) the weighing-assembly unit of Inventive Concept 14.

Inventive Concept 17. A method of tracking inventory of products on a shelf, the method comprising: (a) tracking weight of non-homogeneous products stored on the shelf, the shelf comprising a plurality of weighing assemblies, each weighing assembly comprising (i) a respective shelf bracket, and (ii) a respective load cell assembly fixedly attached to a horizontal member of the respective shelf bracket so as to mediate between the horizontal member and the shelf, the respective load cell assembly comprising: (A) a load cell body having a free end and an anchored portion, the load cell body including a spring element and at least one receiving element, and (B) a strain-sensing gage, bonded to the spring element, the strain-sensing gage adapted to measure a strain in the spring element, wherein the load cell base is attached to the load cell body at the anchored portion thereof; (b) in response to a change in weight of the products on the shelf, sending information about the weight of the products from at least one weighing assembly of the plurality of weighing assemblies to a computing device; and (c) in response to receiving the information about the weight of the products: (i) determining, by the computing device, that a product has been added to or removed from the shelf, and (ii) in response to the determining that a product has been added to or removed from the shelf, identifying the product added or removed.

Inventive Concept 18. The method of Inventive Concept 17, wherein the products are characterized by a plurality of SKU-identifiers, and the identifying includes determining an SKU-identifier.

Inventive Concept 19. The method of Inventive Concept 17, additionally comprising the step of recording a change in an inventory management system.

Inventive Concept 20. The method of Inventive Concept 17, additionally comprising the step of completing a retail sales transaction, using the result of the determining and of the further determining.

Inventive Concept 21. A shelf assembly for tracking the weight of products stored thereupon in a refrigerator, the shelf assembly comprising: (a) a weighing base comprising: (i) opposing load-cell bases detachedly attachable to respective left and right internal walls of the refrigerator, and (ii) a shelf frame or at least one beam member joining respective the opposing load-cell bases so as to form, in combination therewith, a rigid shelf frame, the rigid shelf frame being open to a vertical airflow over at least 25% of its horizontal surface area; (b) a shelf open to a vertical airflow over at least 50% of its horizontal surface area; and (c) a plurality of load cell assemblies fixedly attached to each of respective the opposing load-cell bases so as to mediate between the load-cell bases and the wire-grid shelf, each load cell assembly comprising: (i) a load cell body having a free end and an anchored portion, the load cell body including a spring element and at least one receiving element, and (ii) a strain-sensing gage, bonded to the spring element, the strain-sensing gage adapted to measure a strain in the spring element, wherein, in an assembled configuration, (i) the load cell body is attached to the horizontal member at the anchored portion of the load cell body, and (ii) the at least one receiving element is adapted to receive a vertical load from the shelf, the receiving element has (A) an unloaded disposition, and (B) a loaded disposition in which the at least one receiving element receives the vertical load, wherein in the loaded disposition, the free end attains a depressed position with respect to the free end in the unloaded disposition.

Inventive Concept 22. The shelf assembly of Inventive Concept 21, wherein: (i) the load cell body has a primary axis, a central longitudinal axis, and a transverse axis disposed transversely with respect to the primary and central longitudinal axes, a broad dimension of the load cell body being disposed perpendicular to the primary axis, and (ii) the load cell body includes: (A) a first contiguous cutout window passing through the broad dimension and formed by a first pair of cutout lines disposed generally parallel to the central longitudinal axis, and connected by a first cutout base, (B) a second contiguous cutout window passing through the broad dimension and formed by a second pair of cutout lines disposed generally parallel to the central longitudinal axis, and connected by a second cutout base, the second contiguous cutout window being transversely bounded by the first contiguous cutout window, (C) a pair of measuring beams disposed along opposite edges of the load cell body and generally parallel to the central longitudinal axis, each of the measuring beams longitudinally defined by a respective cutout line of the first pair of cutout lines, (D) a first flexure arrangement having a first pair of flexure beams, disposed along opposite sides of the central longitudinal axis, and generally parallel thereto, the first pair of flexure beams longitudinally disposed between the first pair of cutout lines and the second pair of cutout lines, and mechanically connected by a first flexure base, and (E) a loading element, longitudinally defined by an innermost pair of cutout lines, comprising a receiving element and extending from an innermost flexure base, the transverse axis passing through the loading element.

Inventive Concept 23. The shelf assembly of Inventive Concept 22, wherein the load cell body additionally includes: (F) a third contiguous cutout window passing through the broad dimension and formed by a third pair of cutout lines disposed parallel to the central longitudinal axis, and connected by a third cutout base, and (G) a second flexure arrangement having a second pair of flexure beams, disposed along opposite sides of the central longitudinal axis, and parallel thereto, the second pair of flexure beams longitudinally disposed between the second pair of cutout lines and the third pair of cutout lines, and mechanically connected by a second flexure base, wherein the loading element is longitudinally defined by the third pair of cutout lines, and extending from the second flexure base.

Inventive Concept 24. The shelf assembly of Inventive Concept 21, wherein the at least one strain-sensing gage is associated with a processing unit configured to receive strain signals therefrom, and to produce a weight indication based on the strain signals.

Inventive Concept 25. The shelf assembly of Inventive Concept 24, comprising a communications arrangement for sending information about the weight indication to a computing device, wherein the computing device includes a software module for determining, based on the information, that a product has been added to or removed from a shelf.

Inventive Concept 26. The shelf assembly of Inventive Concept 25, wherein the product is a member of a group of non-homogeneous products, and the determining by the software module additionally includes identifying the product that has been added or removed from the shelf.

Inventive Concept 27. The shelf assembly of Inventive Concept 26, wherein the group of non-homogeneous products is characterized by a plurality of SKU-identifiers, and the identifying includes identifying a SKU-identifier.

Inventive Concept 28. The shelf assembly of Inventive Concept 26, wherein computing device includes a software module for performing, based on the result of the determining, at least one of a retail sales transaction and an inventory adjustment in a computerized inventory system.

Inventive Concept 29. The shelf assembly of Inventive Concept 21, wherein (i) the shelf comprises a wire-grid shelf, (ii) the pluralities of load-cell assemblies are arranged to form opposing pairs of load-cell assemblies, and (iii) the wire-grid shelf includes a plurality of left-to-right wires disposed such that each opposing pair of the opposing pairs of load-cell assemblies is in contact with at least one respective left-to-right wire.

Inventive Concept 30. The shelf assembly of Inventive Concept 21, wherein the shelf comprises an upwardly extending rim member on at least one of the four sides of the shelf, the rim member being sized and/or disposed so as to prevent a product borne by the shelf to transfer any of its weight load directly to a wall or door of the shelving unit by leaning thereupon.

Inventive Concept 31. A method for tracking non-homogeneous products on a shelf by using a plurality of weighing assemblies that are jointly operable to measure the combined weight of the shelf and of the products arranged thereupon, the method comprising: (a) monitoring weight measurement data corresponding to the weight of the shelf and the products arranged thereupon, the weight measurement data measured by the plurality of weighing assemblies and transmitted therefrom as respective streams of weight measurement data points; (b) responsively to a change over time in the values of the weight measurement data, determining a set of weight-event parameters of a weight event, the set of weight-event parameters comprising a product identification and an action taken with respect to the product, the determining comprising: (i) aggregating, across all of the streams, changes in the weight measurement data corresponding to a specific time, (ii) mapping a change in weight distribution on the shelf, using the aggregated changes in weight measurement data, and (iii) assigning a set of weight-event parameters for resolving the mapped change in weight distribution, using product-weight data retrieved from a product database; and (c) performing at least one of: (i) recording information about the results of the selecting in a non-transient, computer-readable medium, and (ii) displaying information about the results of the selecting on a display device.

Inventive Concept 32. The method of Inventive Concept 21, wherein the assigning comprises: (i) identifying at least one candidate set of weight-event parameters for resolving the mapped change in weight distribution, using product-weight data retrieved from a product database, (ii) assigning an event likeliness score to each candidate set of weight-event parameters, and (iii) selecting the set of candidate weight-event parameters having the highest event likeliness score.

Inventive Concept 33. The method of Inventive Concept 21, wherein the determining includes calculating a probability, using a probability distribution function, in at least the assigning.

Inventive Concept 34. The method of Inventive Concept 21, wherein the assigned set of weight-event parameters includes exactly one product and one action.

Inventive Concept 35. The method of Inventive Concept 21, wherein the assigned set of weight-event parameters includes at least one of (i) two or more products and (ii) two or more actions.

Inventive Concept 36. The method of Inventive Concept 23, wherein a parameter of the probability distribution function is derived using a machine learning algorithm applied to historical weight data for a product.

Inventive Concept 37. The method of Inventive Concept 21, wherein the determining is carried out responsively to an absolute value of the change over time in the values of the weight measurement data exceeding a pre-determined threshold.

Inventive Concept 38. The method of Inventive Concept 21, wherein each stream of weight measurement data includes at least 50 data points per second.

Inventive Concept 39. The method of Inventive Concept 21, additionally comprising, before the determining: (i) responsively to a change over time in the values of transmitted weight measurement data, analyzing each of the streams of weight measurement data points to detect noise and drift; and (ii) in response to the detection of the noise and drift, performing at least one of (A) at least partially filtering out the noise and drift and (B) at least partially compensating for the noise and drift in the weight measurement data points, such that the performing generates revised weight measurement data, wherein (i) the aggregating includes aggregating the revised weight measurement data across all of the streams, and (ii) the mapping is based on the change in values in the revised weight measurement data.

Inventive Concept 40. The method of Inventive Concept 29, wherein the noise includes changes in weight measurement data that subsequently are substantially reversed within less than 5 seconds.

Inventive Concept 41. The method of Inventive Concept 21, wherein each of the weighing assemblies comprises: (a) at least one load cell arrangement disposed on a single metal load cell body, the load cell body having a primary axis, a central longitudinal axis, and a transverse axis disposed transversely with respect to the primary and central longitudinal axes, a broad dimension of the load cell body being disposed perpendicular to the primary axis, the load cell arrangement including: (i) a first contiguous cutout window passing through the broad dimension and formed by a first pair of cutout lines disposed generally parallel to the central longitudinal axis, and connected by a first cutout base; (ii) a second contiguous cutout window passing through the broad dimension and formed by a second pair of cutout lines disposed generally parallel to the central longitudinal axis, and connected by a second cutout base, wherein the second contiguous cutout window is transversely bounded by the first contiguous cutout window; (iii) a pair of measuring beams disposed along opposite edges of the load cell body and generally parallel to the central longitudinal axis, each of the measuring beams longitudinally defined by a respective cutout line of the first pair of cutout lines; (iv) a first flexure arrangement having a first pair of flexure beams, disposed along opposite sides of the central longitudinal axis, and generally parallel thereto, the first pair of flexure beams longitudinally disposed between the first pair of cutout lines and the second pair of cutout lines, and mechanically connected by a first flexure base; (v) a loading element, longitudinally defined by an innermost pair of cutout lines, comprising a receiving element and extending from an innermost flexure base, the transverse axis passing through the loading element; and (vi) at least one strain gage, fixedly attached to a surface of a measuring beam of the measuring beams.

Inventive Concept 42. A method for mapping a change in weight distribution of a non-homogeneous plurality of products on a shelf, the method comprising: (a) receiving, from each of a plurality of weighing assemblies in contact with the shelf and jointly operable to measure the combined weight of the shelf and of products arranged thereupon, respective synchronized data streams of weight measurement data points, each of the weight measurement data points representing a proper fraction of the total weight of the shelf and of any products arranged thereupon, wherein the sum of the proper fractions represented by the received weight measurement data points for any given time is equal to one, the receiving including receiving, in response to an action taken with respect to a product, a weight measurement data point with a changed value, wherein the action taken with the respect to the product is one of: (i) removing the product from the shelf, (ii) adding the product to the shelf, and (iii) moving the product from one position on the shelf to another; (b) accessing an earlier mapping of the weight distribution of products on the shelf; and (c) in response to receiving the weight measurement data point with the changed value, remapping the weight distribution of products on the shelf, wherein the remapping includes (i) mapping a current weight distribution of the products on the shelf from the received synchronized data streams of weight measurement data points in accordance with a first mapping rule that applies a mathematical function for weight distribution, and (ii) comparing the current mapped weight distribution with the earlier mapping.

Inventive Concept 43. The method of Inventive Concept 42, wherein the first mapping rule is that distribution of weight to weighing assemblies includes application of a linear function, such that on a shelf defining an x-y plane and having an origin at (0,0) and a diagonally opposite corner at (1,1), addition of a product on the shelf with weight of W and weight-center coordinates of (X,Y) causes weighing assemblies at (0,0), (0,1), (1,1), (1,0) to transmit respective weight measurement data points incremented by (1−X)*(1−Y)*W, (1−X)*Y*W, X*Y*W, X*(1−Y)*W.

Inventive Concept 44. The method of Inventive Concept 42, wherein the first mapping rule is that the weight distribution of a product on a shelf is mapped from the weight measurement data points using a probability density function, such that on a shelf defining an x-y plane each product is represented in the remapped weight distribution at multiple (x,y) points.

Inventive Concept 45. The method of Inventive Concept 44, wherein the probability density function is a bivariate normal distribution such that the multiple (x,y) points are distributed according to a first normal distribution on the x-axis and according to a second normal distribution on the y-axis.

Inventive Concept 46. The method of Inventive Concept 42, wherein the remapping is additionally carried out in accordance with a second mapping rule, wherein the second mapping rule is that the remapping uses weight measurement data points corresponding to a time interval that is constrained.

Inventive Concept 47. The method of Inventive Concept 46, wherein the time interval is constrained to end when differences between successive periodically accessed values of weight measurement data points in a data stream fall below a predetermined threshold.

Inventive Concept 48. The method of Inventive Concept 46, wherein the length of the time interval is pre-determined and is based on a mechanical parameter of at least one of the shelf and a weighing assembly.

Inventive Concept 49. A system for tracking non-homogeneous products on a shelf, comprising: (a) a plurality of weighing assemblies in contact with the shelf and jointly operable to measure the combined weight of the shelf and of products arranged thereupon; (b) one or more computer processors; and (c) a non-transient computer-readable storage medium comprising program instructions, which when executed by the one or more computer processors, cause the one or more computer processors to carry out the following steps: (i) monitoring weight measurement data corresponding to the weight of the shelf and the products arranged thereupon, the weight measurement data measured by the plurality of weighing assemblies and transmitted therefrom as respective streams of weight measurement data points; (ii) responsively to a change over time in the values of the weight measurement data, determining a set of weight-event parameters of a weight event, the set of weight-event parameters comprising a product identification and an action taken with respect to the product, the determining comprising: (A) aggregating, across all of the streams, changes in weight measurement data corresponding to a specific time, (B) mapping a change in weight distribution on the shelf, using the aggregated changes in weight measurement data, and (C) assigning a set of weight-event parameters for resolving the mapped change in weight distribution, using product-weight data retrieved from a product database; and (iii) performing at least one of: (A) recording information about the results of the selecting in a non-transient, computer-readable medium, and (B) displaying information about the results of the selecting on a display device.

Inventive Concept 50. The system of Inventive Concept 49, wherein the assigning comprises: identifying at least one candidate set of weight-event parameters for resolving the mapped change in weight distribution, using product-weight data retrieved from a product database, (ii) assigning an event likeliness score to each candidate set of weight-event parameters, and (iii) selecting the set of candidate weight-event parameters having the highest event likeliness score.

As used herein in the specification and in the claims section that follows, the term “generally”, with respect to orientations and measurements such as “parallel” and “central”, is meant to limit the deviation to within ±10%. More typically, this deviation is within ±5%, ±3%, ±2%, ±1%, ±0.5%, ±0.2%, or less.

Unless otherwise defined herein, words and phrases used herein are to be understood in accordance with their usual meaning in normal usage. Some terms used herein are terms of art in the industries that supply and use shelving assemblies, for example (and not exhaustively): an “upright” is a post or rod fixed vertically as a structural support for other components in a shelving unit and to bear the load of the shelves and any goods displayed thereupon, generally including holes or other arrangements along at least two faces for the attachment of shelf brackets. An upright, unless it is at the end of continuous run of shelving, is shared by two adjacent shelving units and therefore a standard “shelving unit” is considered to include only one upright. A “shelf bracket” is a support adapted to be secured to an upright so as to support a shelf; generally, at least two shelf brackets are required to support a shelf—one at each end, although there are designs with only one bracket per shelf. “Double-sided” shelving units or “shelving bays” are those which have shelving on both sides of the “back panel,” while “single-sided” shelving units are those which have shelving only on one side. In the description and claims of the present disclosure, each of the verbs, “comprise”, “include” and “have”, and conjugates thereof, are used to indicate that the object or objects of the verb are not necessarily a complete listing of members, components, elements or parts of the subject or subjects of the verb. As used herein, the singular form “a”, “an” and “the” include plural references unless the context clearly dictates otherwise. For example, the term “a shelf” or “at least one shelf” may include a plurality of markings.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. A method for tracking non-homogeneous products on a shelf by using a plurality of weighing assemblies that are jointly operable to measure the combined weight of the shelf and of the products arranged thereupon, the method comprising:
a. monitoring weight measurement data corresponding to the weight of the shelf and the products arranged thereupon, said weight measurement data measured by the plurality of weighing assemblies and transmitted therefrom as respective streams of weight measurement data points; and
b. responsively to a change over time in the values of said weight measurement data, determining a set of weight-event parameters of a weight event, the set of weight-event parameters comprising a product identification and an action taken with respect to the product, the action comprising one of adding to the shelf, removing from the shelf, and moving within the shelf, the determining comprising:
i. aggregating, across all of the streams, changes in said weight measurement data corresponding to a specific time,
ii. mapping a change in weight distribution on the shelf, using the aggregated changes in weight measurement data, and
iii. assigning a set of weight-event parameters for resolving the mapped change in weight distribution, the product identification based at least in part on per-product weight data retrieved from a product database.

2. The method of claim, additionally comprising: performing at least one of: (i) recording information based on the results of the selecting in a non-transient, computer-readable medium, and (ii) displaying information based on the results of the selecting on a display device.

3. The method of claim 1, wherein said assigning comprises:
i. identifying at least one candidate set of weight-event parameters for resolving the mapped change in weight distribution, using per-product weight data retrieved from a product database,
ii. assigning an event likeliness score to each candidate set of weight-event parameters, and
iii. selecting the set of candidate weight-event parameters having the highest event likeliness score.

4. The method of claim 1, wherein the determining includes calculating a probability, using a probability distribution function, in at least the assigning.

5. The method of claim 1, wherein the assigned set of weight-event parameters includes exactly one product and one action.

6. The method of claim 1, wherein the assigned set of weight-event parameters includes at least one of (i) two or more products and (ii) two or more actions.

7. The method of claim 3, wherein a parameter of the probability distribution function is derived using a machine learning algorithm applied to historical weight data for a product.

8. The method of claim 1, wherein the determining is carried out responsively to an absolute value of the change over time in the values of said weight measurement data exceeding a pre-determined threshold.

9. The method of claim 1, wherein each stream of weight measurement data includes at least 50 data points per second.

10. The method of claim 1, additionally comprising, before said determining:
responsively to a change over time in the values of transmitted weight measurement data, analyzing each of the streams of weight measurement data points to detect noise and drift; and
in response to the detection of said noise and drift, performing at least one of (A) at filtering out at least a portion of said noise and drift and (B) compensating for at least a portion of said noise and drift in the weight measurement data points, such that the performing generates revised weight measurement data.
wherein (i) said aggregating includes aggregating said revised weight measurement data across all of the streams, and (ii) said mapping is based on the change in values in said revised weight measurement data,

11. The method of claim 9, wherein the noise includes changes in weight measurement data that subsequently are at least 80% reversed within less than 5 seconds.

12. A system for tracking non-homogeneous products on a shelf, comprising:
a. a plurality of weighing assemblies in contact with the shelf and jointly operable to measure the combined weight of the shelf and of products arranged thereupon;
b. one or more computer processors; and
c. a non-transient computer-readable storage medium comprising program instructions, which when executed by the one or more computer processors, cause the one or more computer processors to carry out the following steps:
i. monitoring weight measurement data corresponding to the weight of the shelf and the products arranged thereupon, said weight measurement data measured by the plurality of weighing assemblies and transmitted therefrom as respective streams of weight measurement data points;
ii. responsively to a change over time in the values of said weight measurement data, determining a set of weight-event parameters of a weight event, the set of weight-event parameters comprising a product identification and an action taken with respect to the product, the action comprising one of adding to the shelf, removing from the shelf, and moving within the shelf, the determining comprising:
A. aggregating, across all of the streams, changes in weight measurement data corresponding to a specific time,
B. mapping a change in weight distribution on the shelf, using the aggregated changes in weight measurement data, and
C. assigning a set of weight-event parameters for resolving the mapped change in weight distribution, the product identification based at least in part on per-product weight data retrieved from a product database.

13. The system of claim 12, wherein said program instructions, when executed by the one or more computer processors, cause the one or more computer processors to carry at least one of: (i) recording information based on the results of the selecting in a non-transient, computer-readable medium, and (ii) displaying information based on the results of the selecting on a display device.

14. The system of claim 12, wherein said assigning comprises:
i. identifying at least one candidate set of weight-event parameters for resolving the mapped change in weight distribution, using product-weight data retrieved from a product database,
ii. assigning an event likeliness score to each candidate set of weight-event parameters, and
iii. selecting the set of candidate weight-event parameters having the highest event likeliness score.
